(19) United States
(12) Patent Application Publication
(10) Pub. No.: US 2004/0129244 A1
(43) Pub. Date: Jul. 8, 2004

(54) Poly inductive machines and differential turbines

(76) Inventor: Normand Beaudoin, St-Hippolyte (CA)

Correspondence Address: CONNOLLY BOVE LODGE & HUTZ LLP, SUITE 800, 1990 M STREET NW, WASHINGTON, DC, 20036-3425, US

(21) Appl. No.: 10/471,427

(22) PCT Filed: Mar. 11, 2002
(86) PCT No.: PCT/CA02/00340

(30) Foreign Application Priority Data
Mar. 15, 2001 (CA) 2340950
Mar. 16, 2001 (CA) 2340954

(51) Int. Cl. F02B 53/00; F02B 75/22

(52) U.S. Cl. 123/242; 123/45 R; 123/55.5

(57) ABSTRACT

In previous Canadian patent applications of the present inventor, with number 2,302,870 filed on Mar. 15, 2001 in relation to “Poly-induction energetic engine”, and 2,310,488 filed on May 23, 2001 in relation to “Energetic and anti-discharge poly-turbine”, it has been shown how to advantageously build driving machines that were referred to as poly-inductive. The present patent application is a follow-up of the work initiated in the above-mentioned applications, especially with regard to the following aspects, which will allow generalisations of the work initiated, and also customisations. For a better understanding, the present application comprises a plurality of sections, each dealing with one aspect of the present invention. The first section, entitled “bridges for poly-induction engines”, shows how to achieve more balanced poly-inductive supports, more precisely by making use of induction cams. The second section, entitled “retro-active poly-induction semi-transmittive assemblies”, shows how to obtain exactly the same shapes of the cylinders than original machines, this time by resorting to a semi-transmittive, instead of poly-induction, support of the pieces. A third section, entitled “synthesis of poly-inductive engines”, goes further by introducing a third way for supporting the pieces, using hoop gears, this third method once again allowing to achieve the same shapes of the cylinders than poly-inductive machines, and presenting a synthesis of such means for supporting the pieces. The fourth section, entitled “generalisation of poly-inductive engines” shows that whatever the supporting means sued as described before, either poly-inductive, semi-transmittive, or hoop-like, it is always possible to build to main infinite classes of poly-inductive machines, namely retro-rotative machines and post-rotative machines. The fifth section, entitled “new methods for poly-inductive support of poly-turbines” provides, based on the teachings of the previous sections, new poly-inductive supporting means for poly-turbines. Lastly, the sixth section, entitled “semi-differential poly-inductive machines” ends with the final objective of the present invention, and shows how to use poly-inductive set-ups in order to achieve a differential effect, and describes specific embodiments of what is called differential turbines.

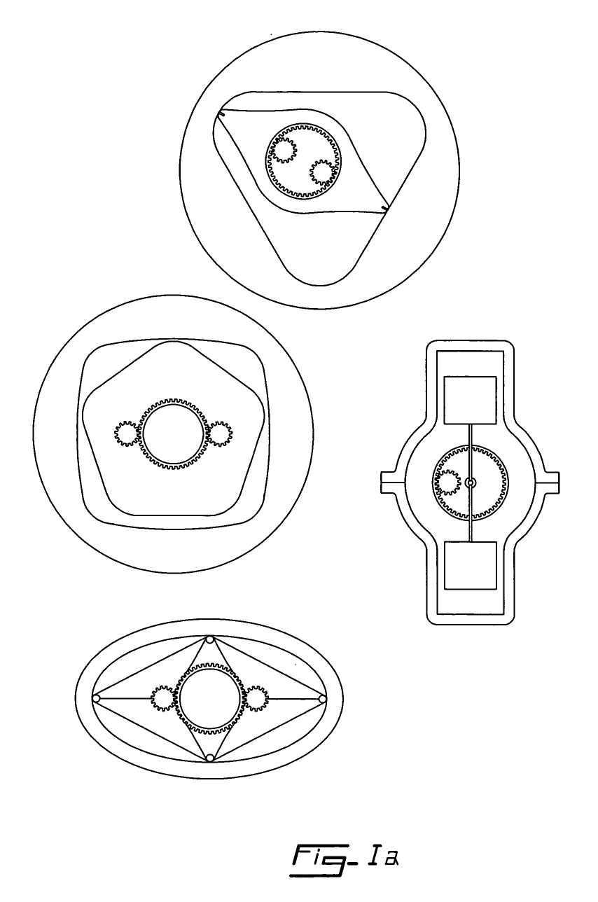

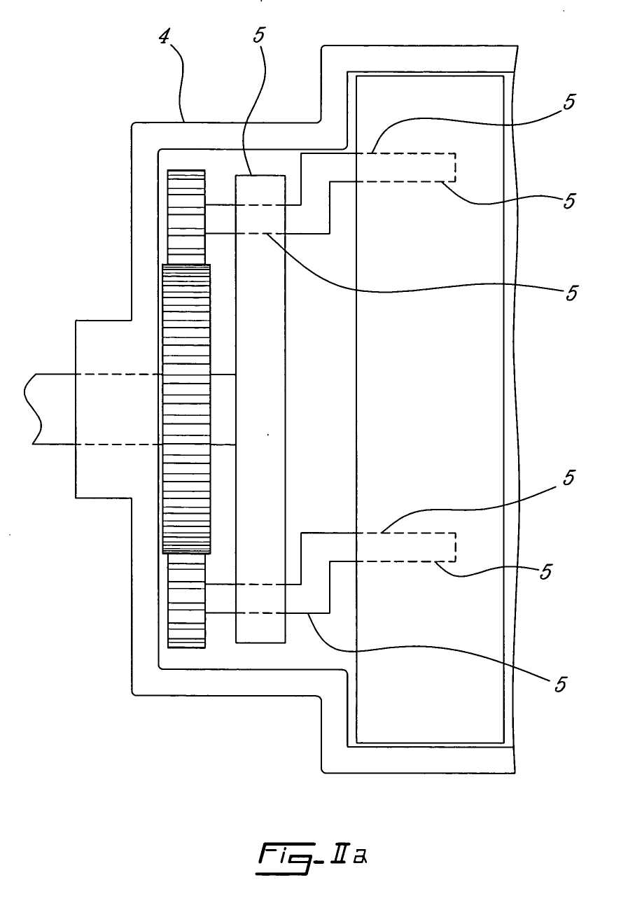

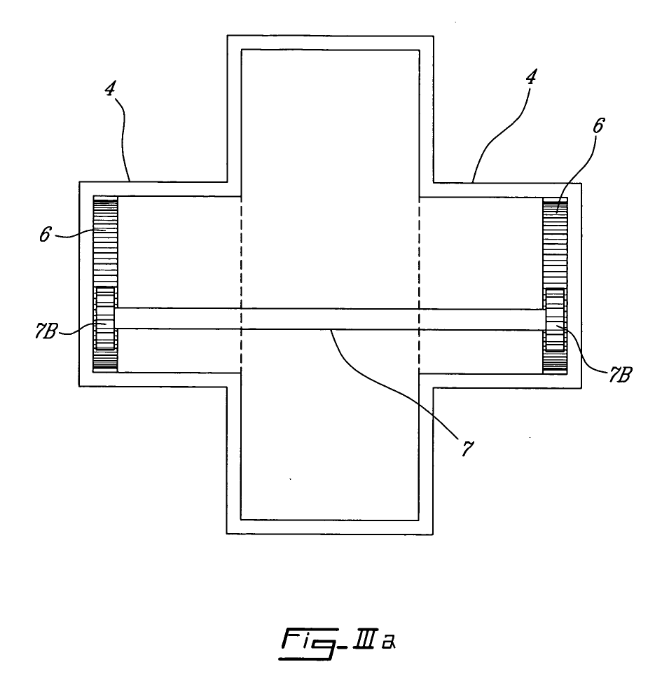

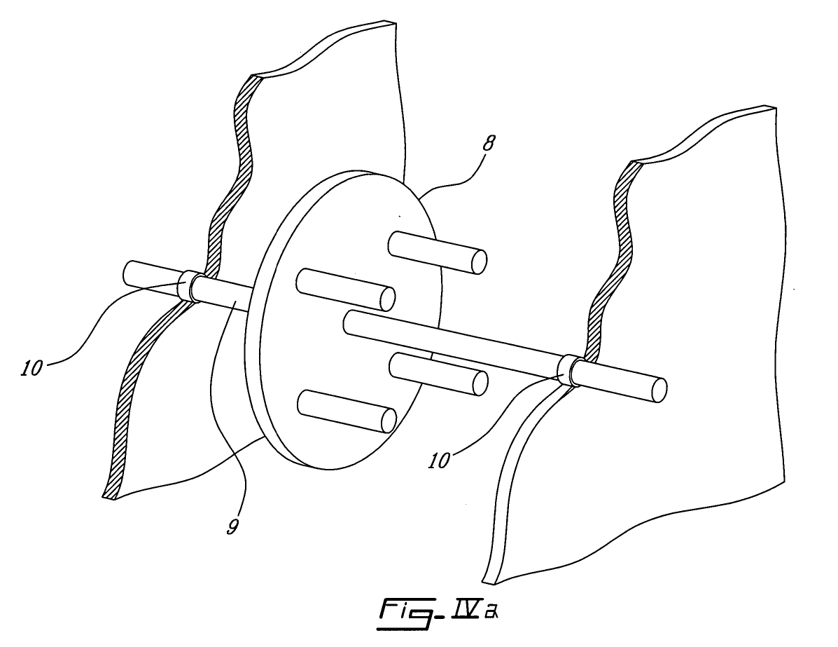

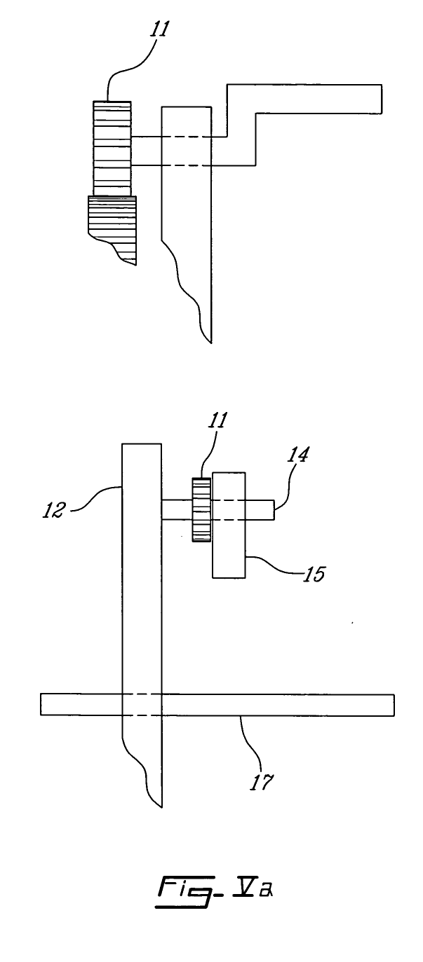

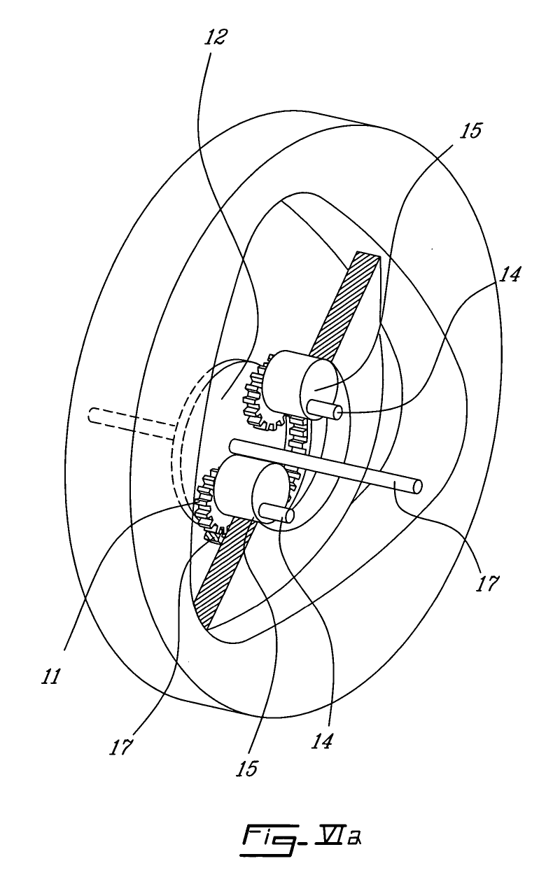

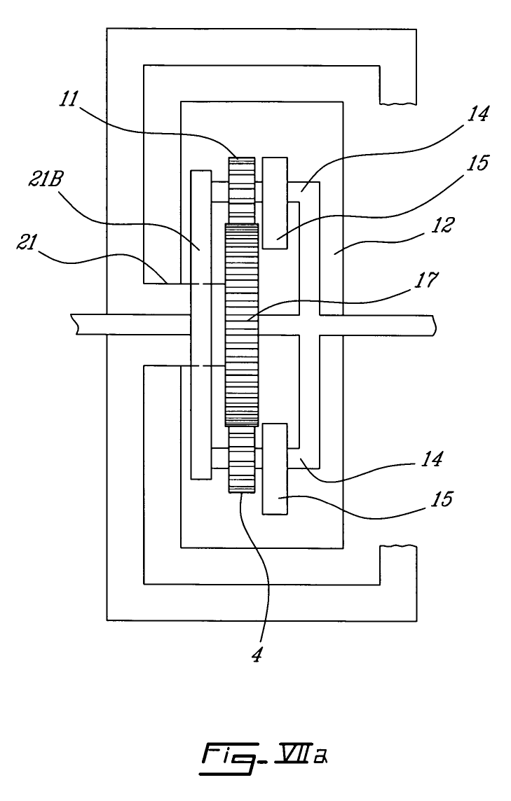

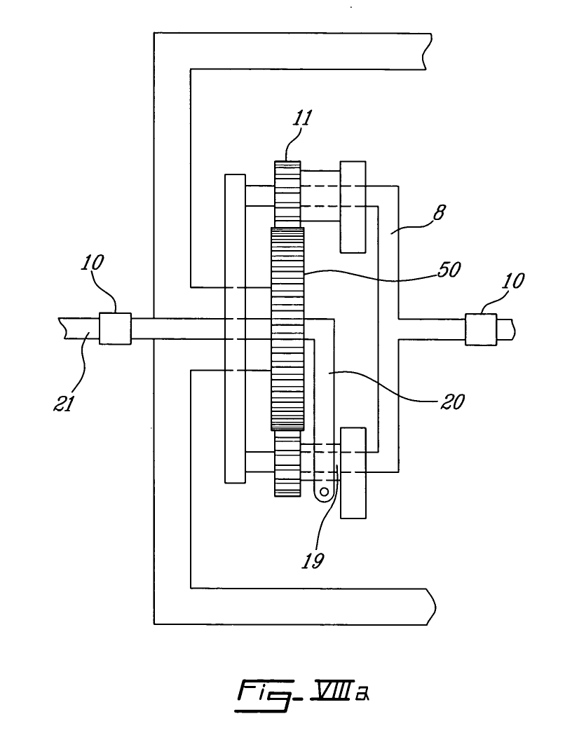

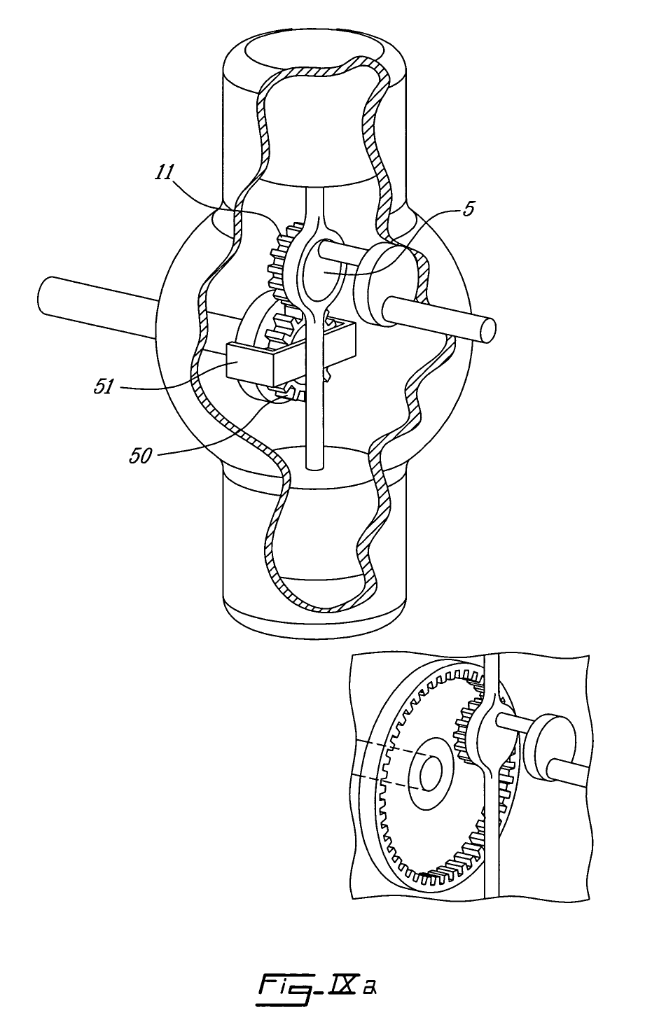

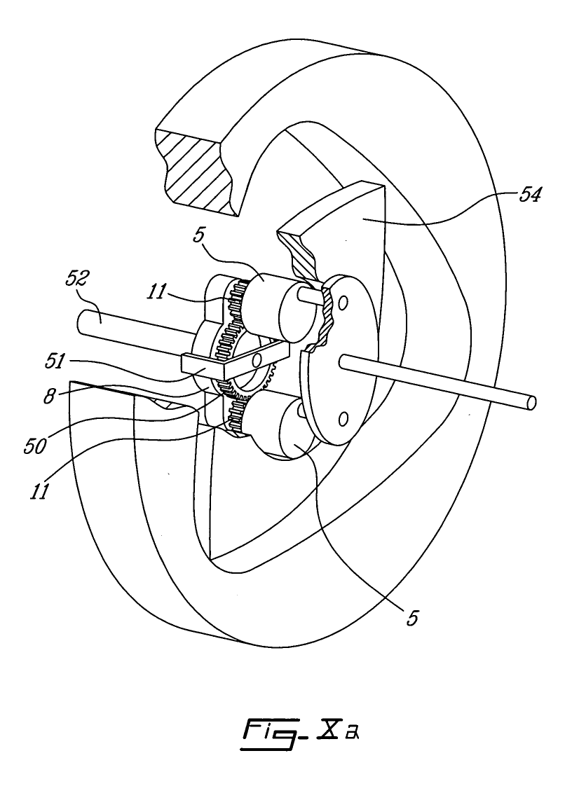

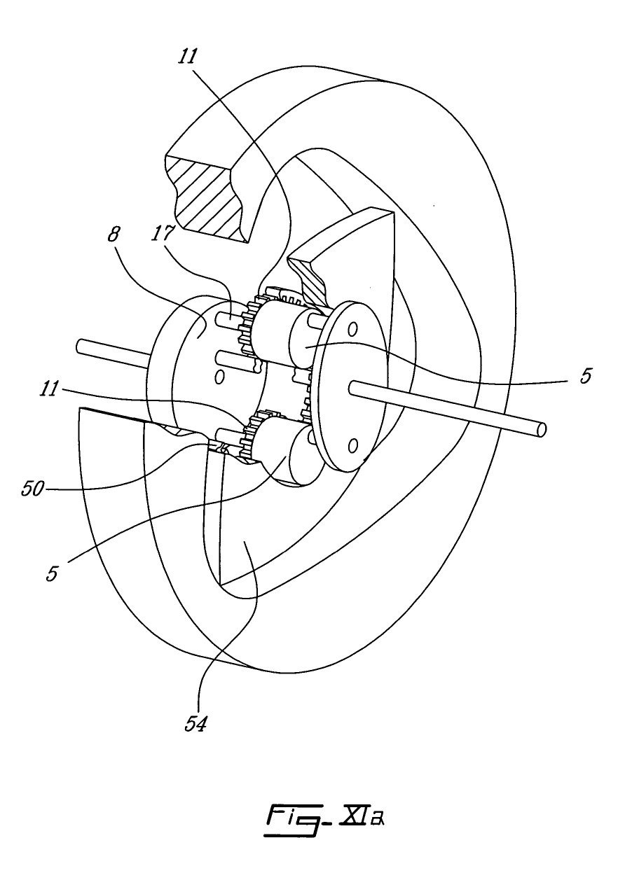

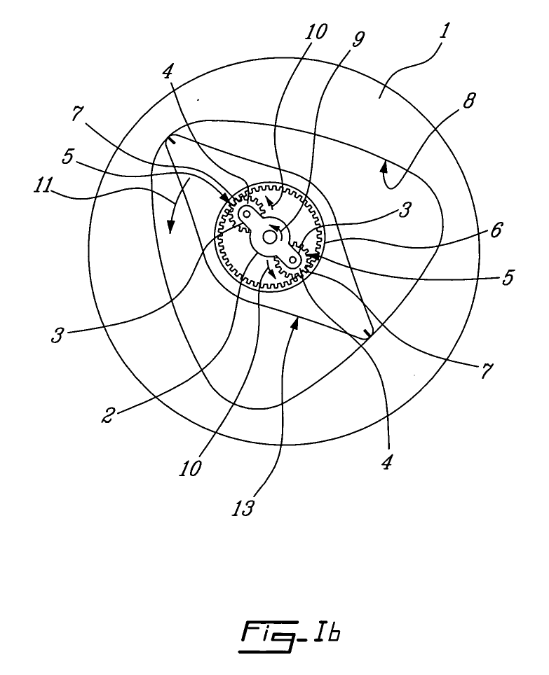

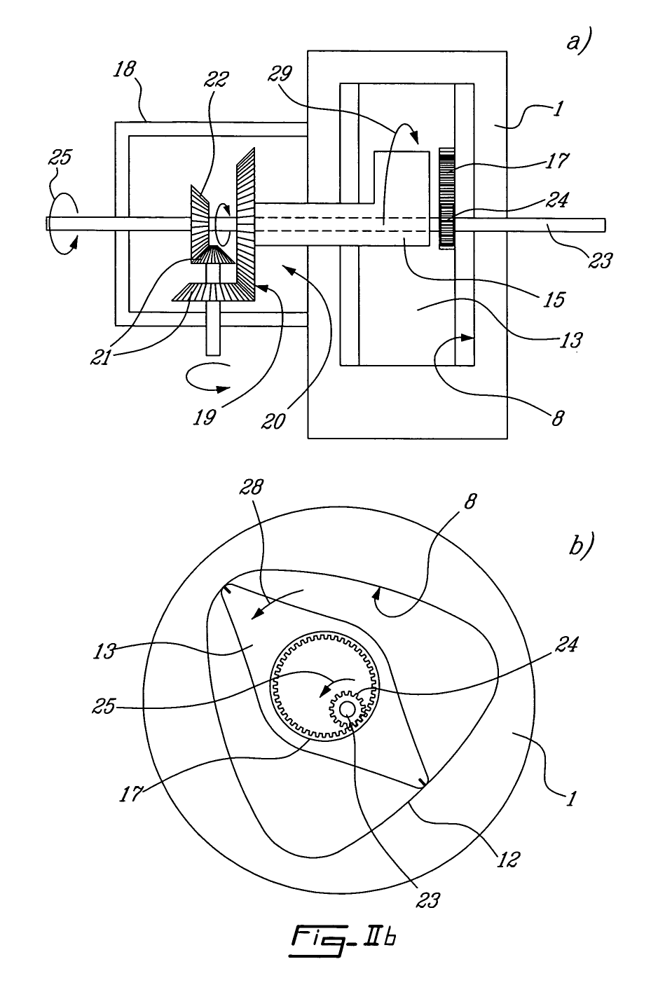

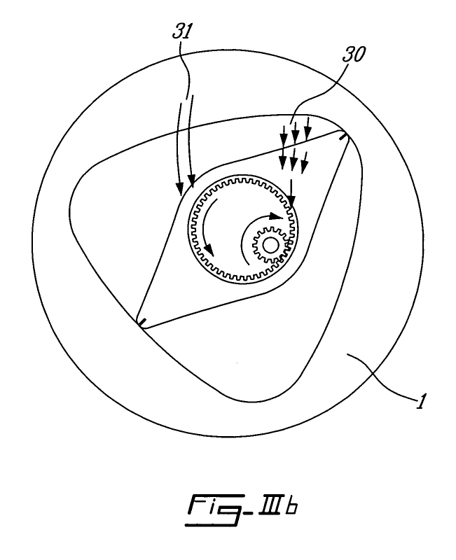

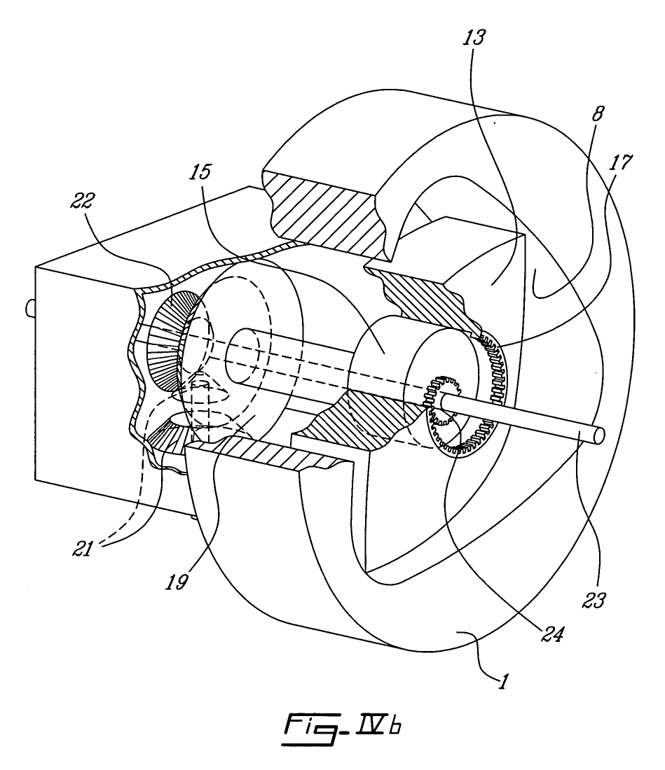

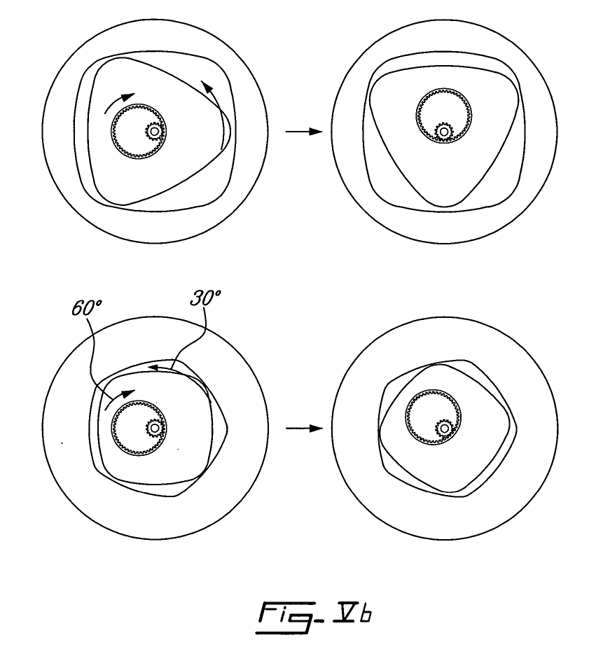

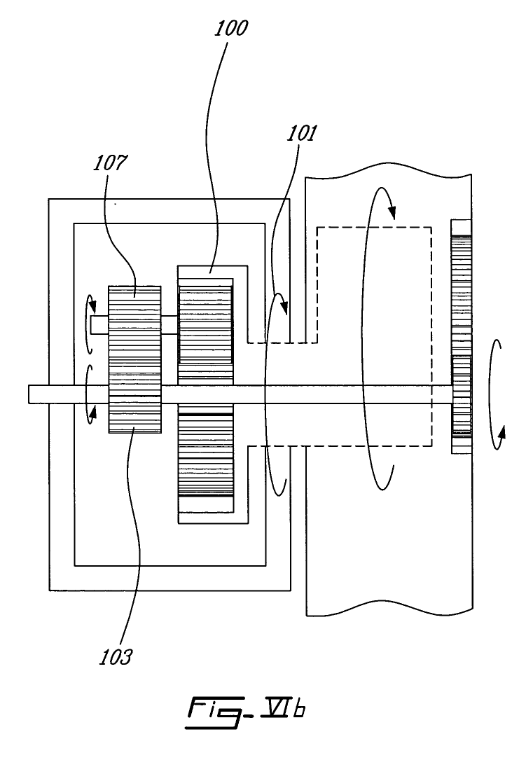

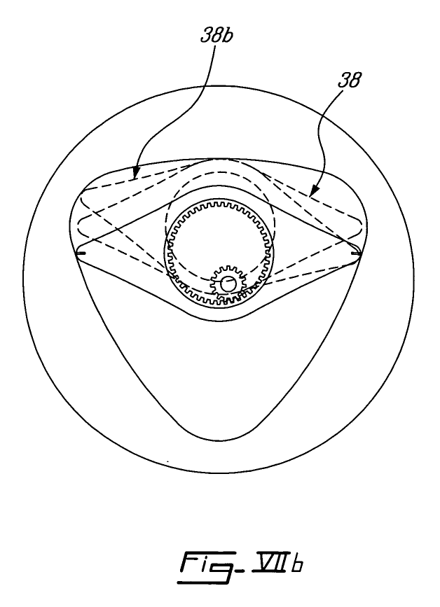

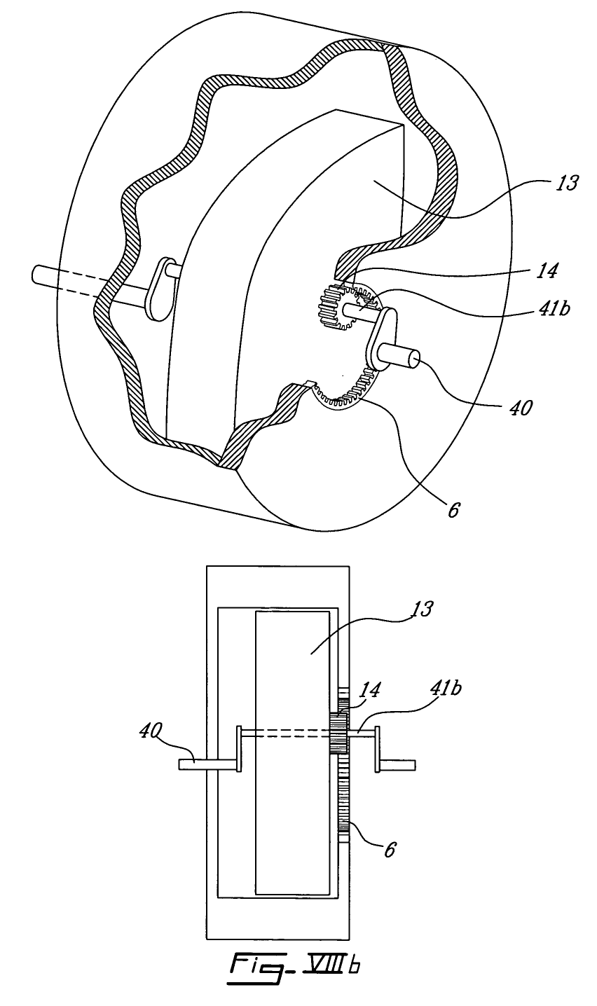

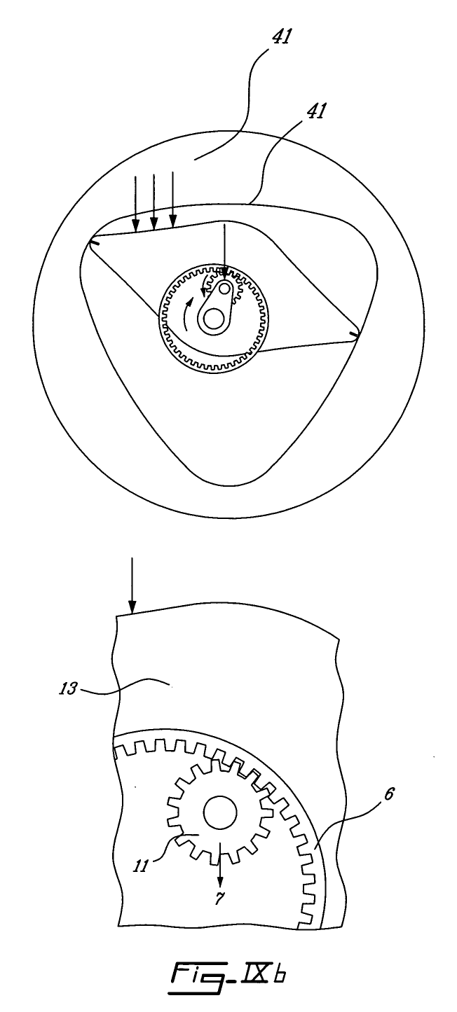

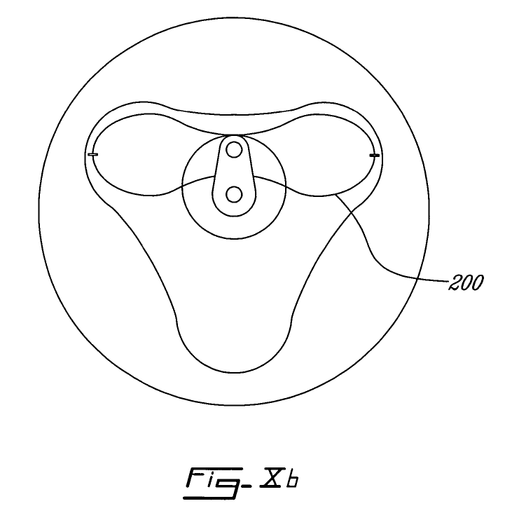

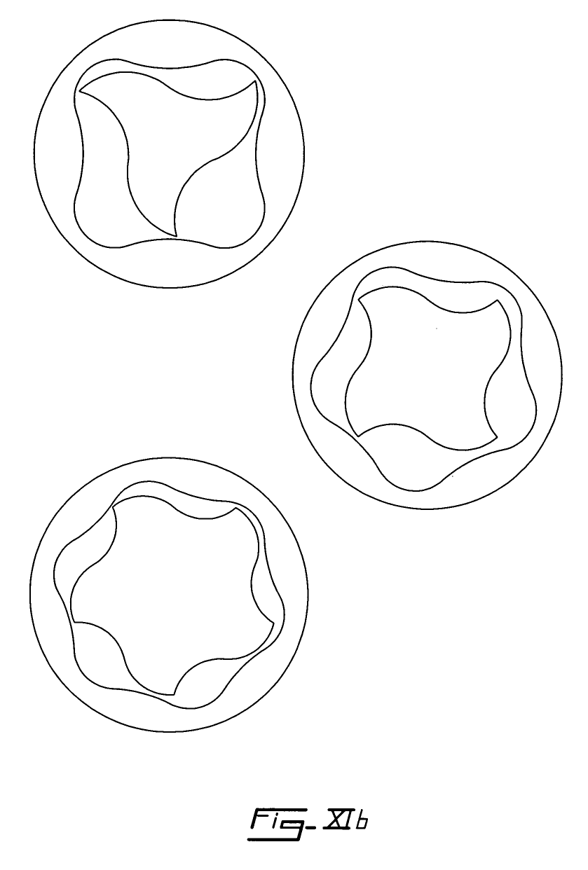

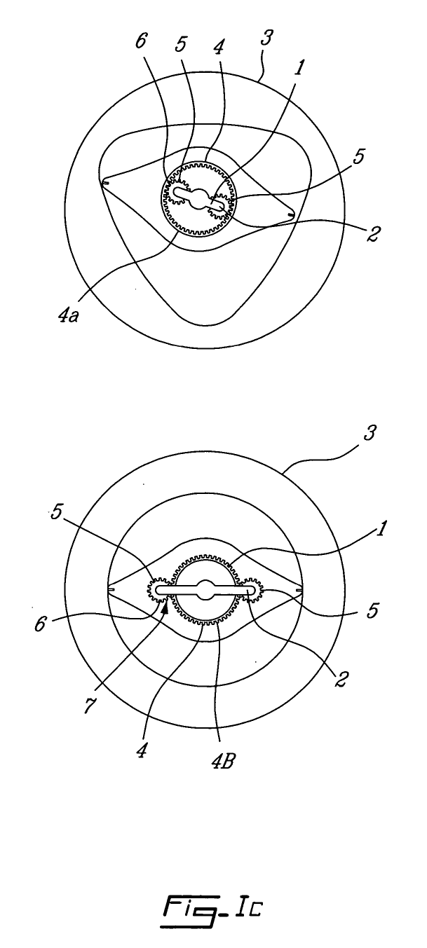

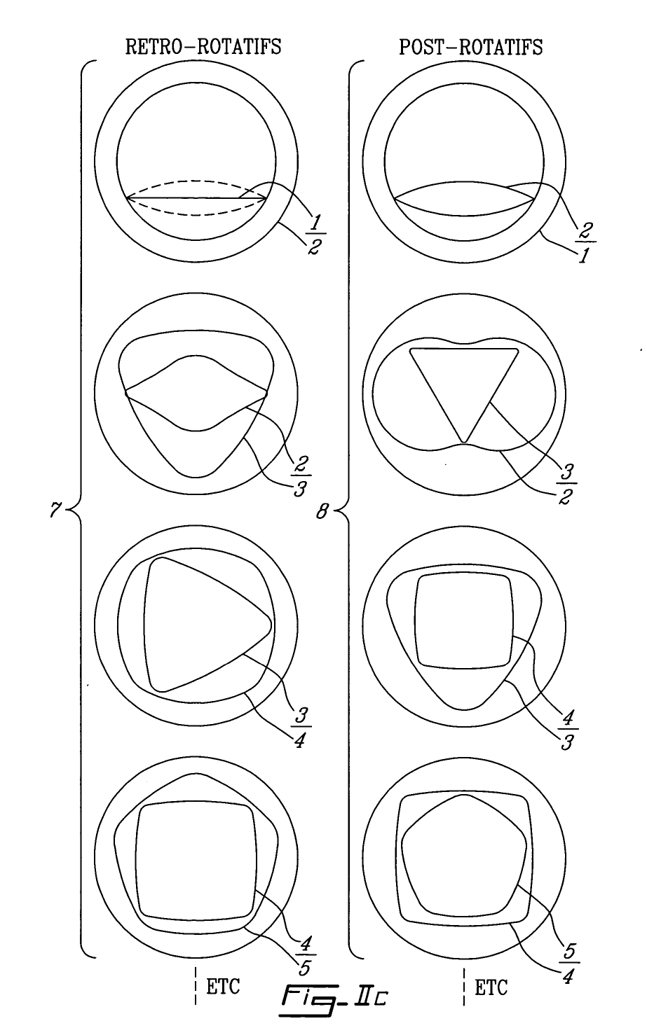

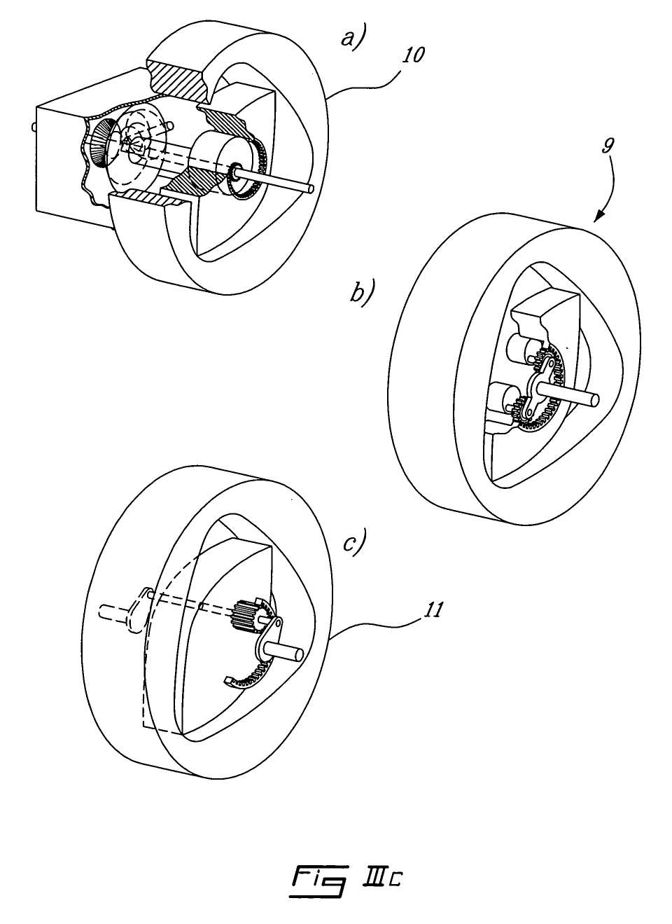

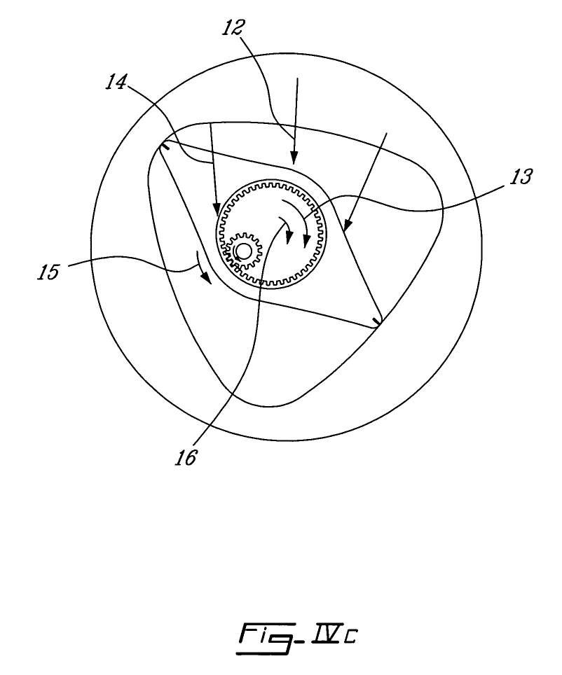

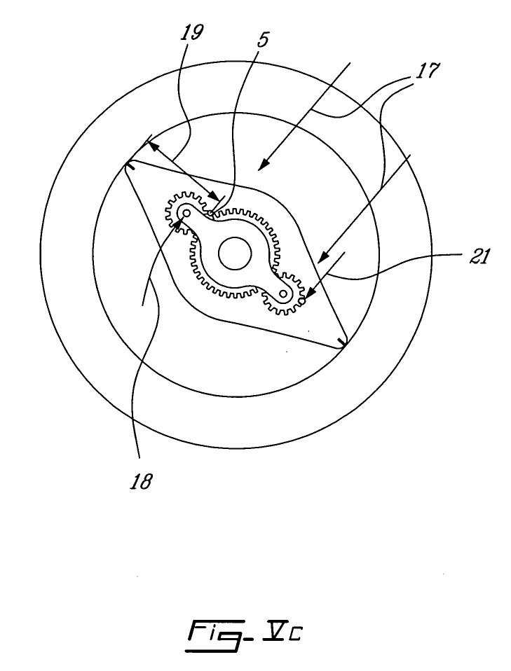

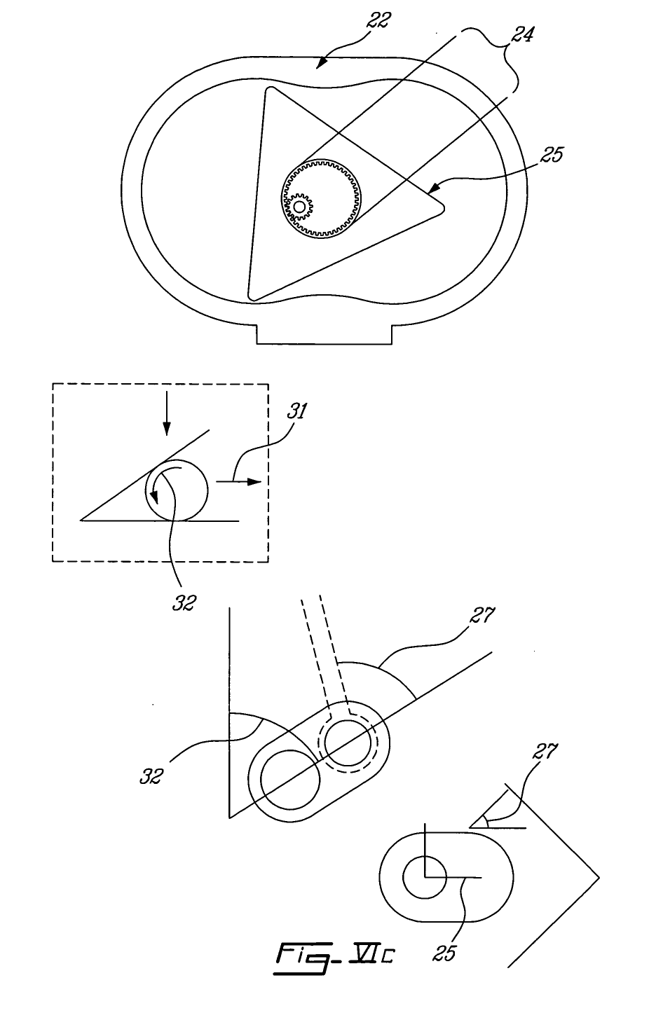

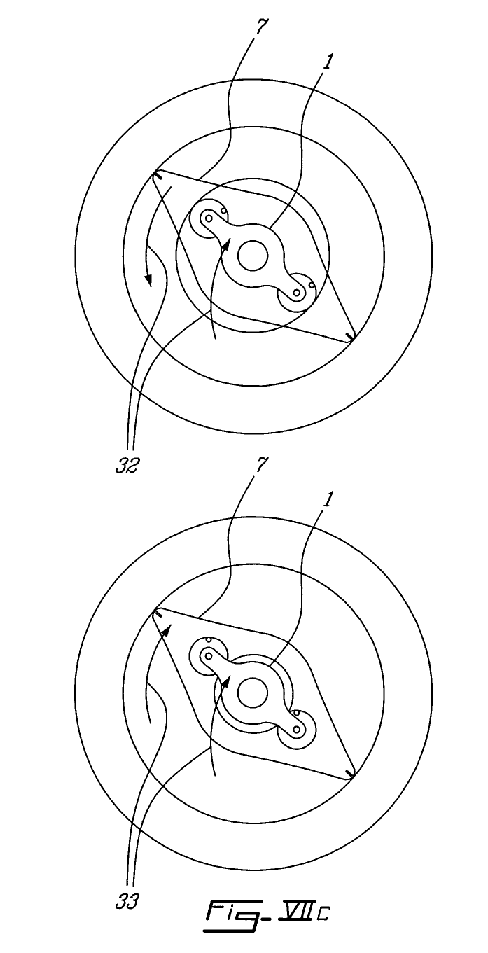

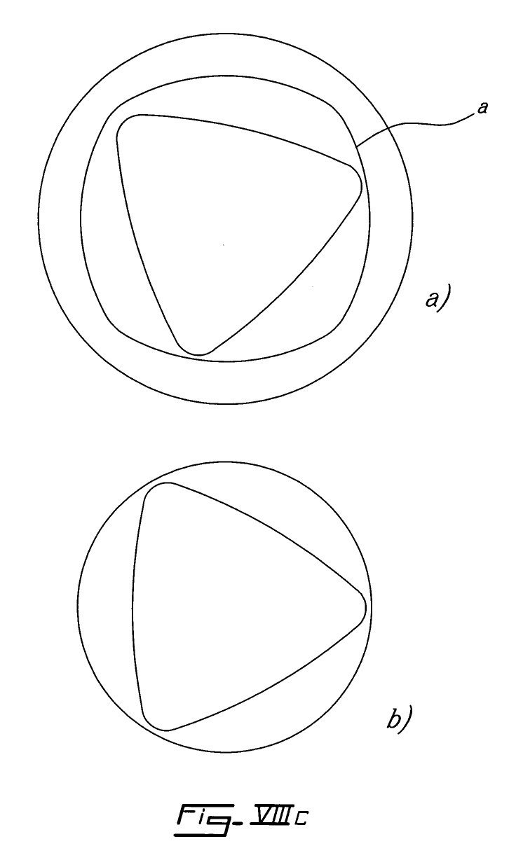

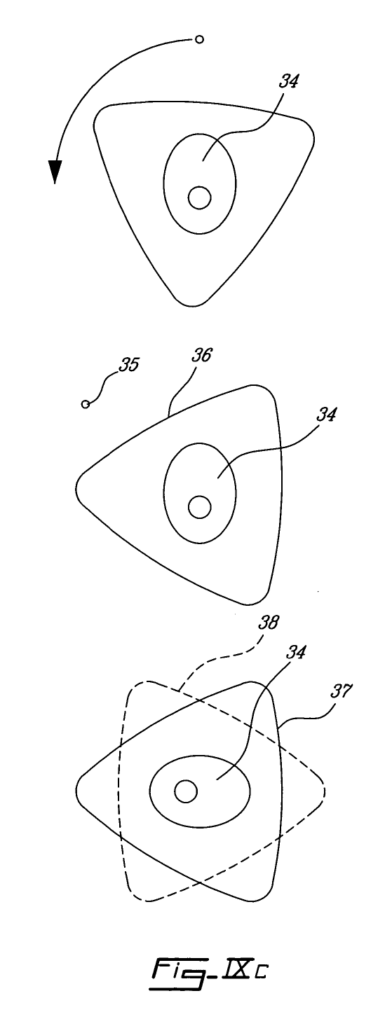

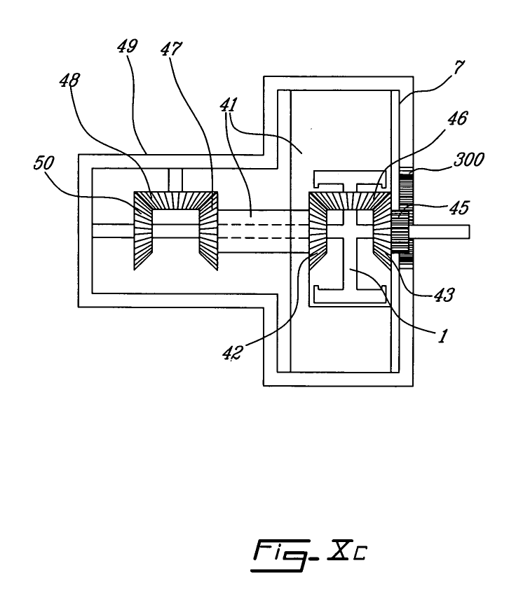

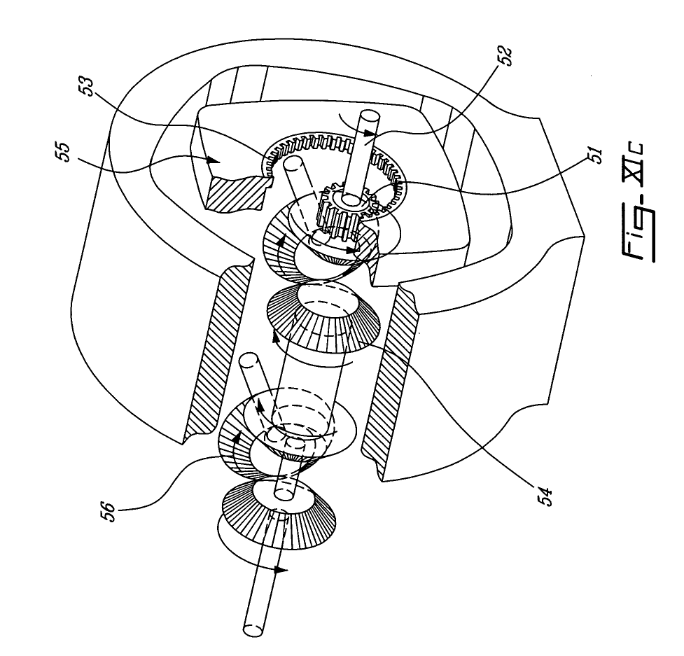

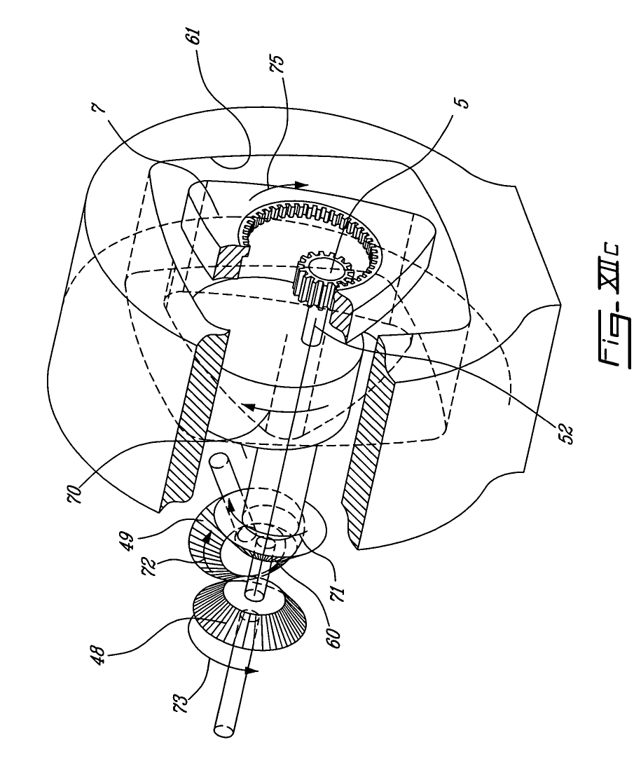

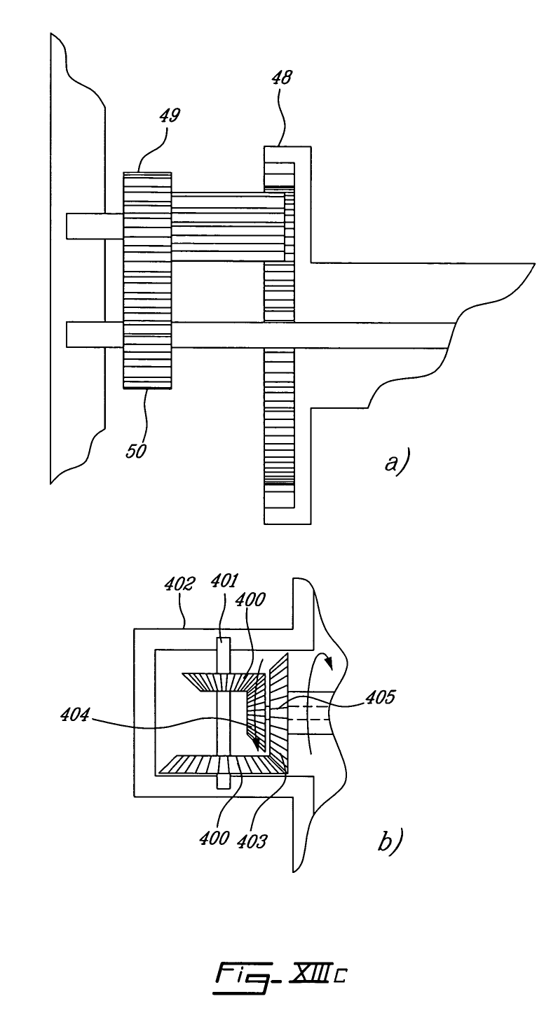

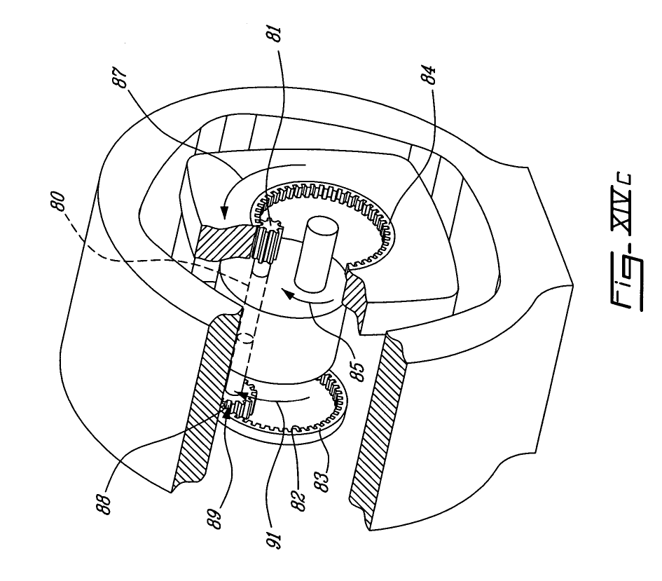

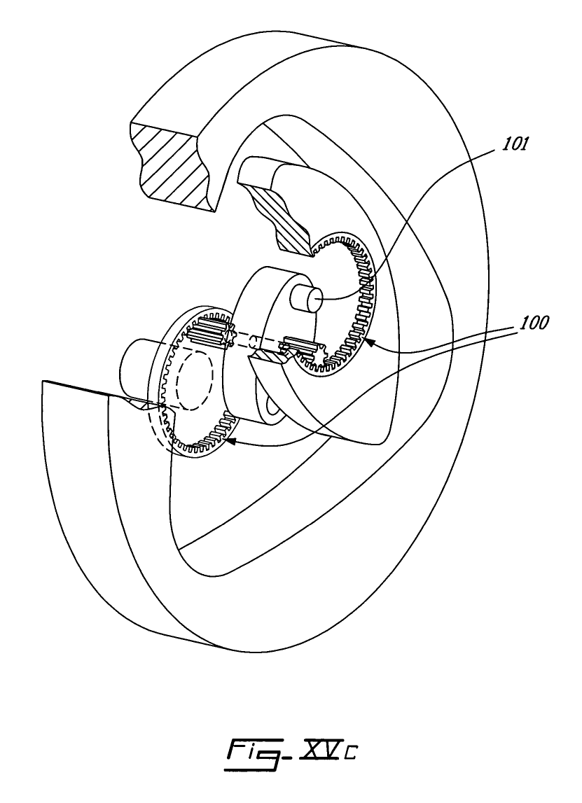

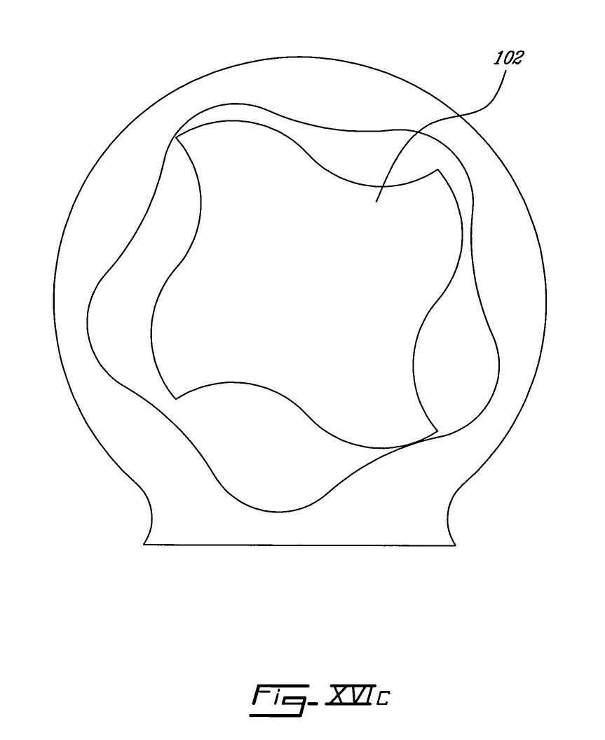

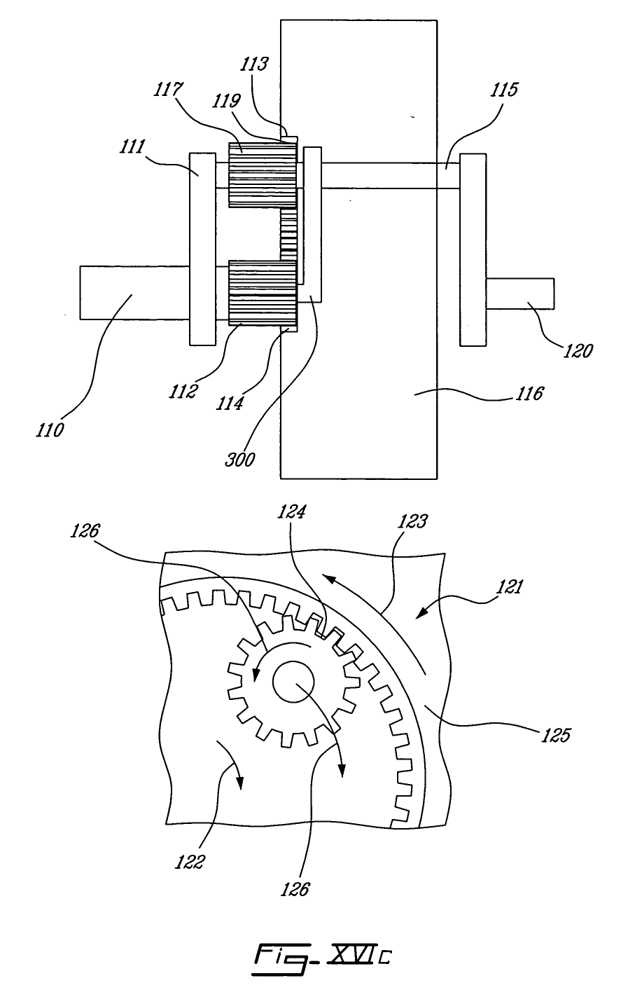

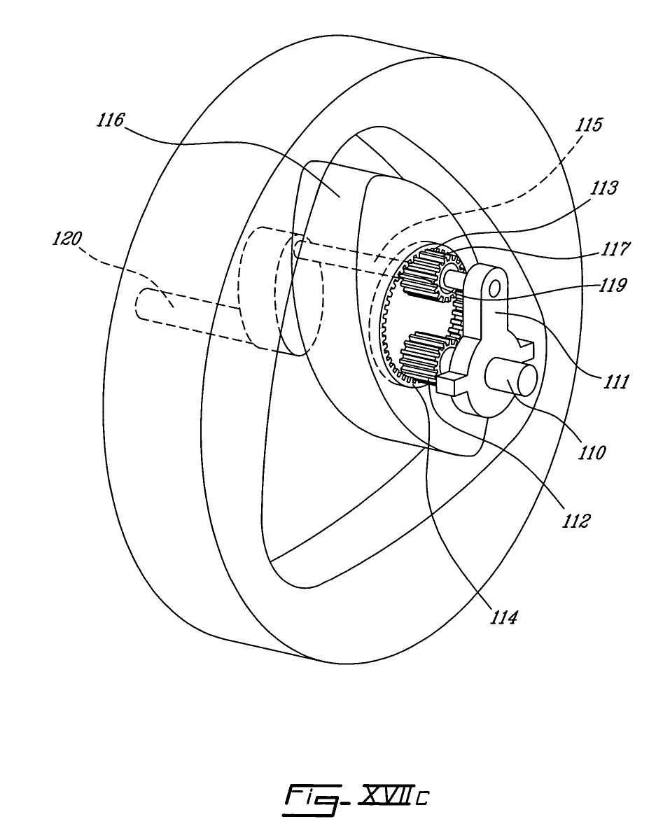

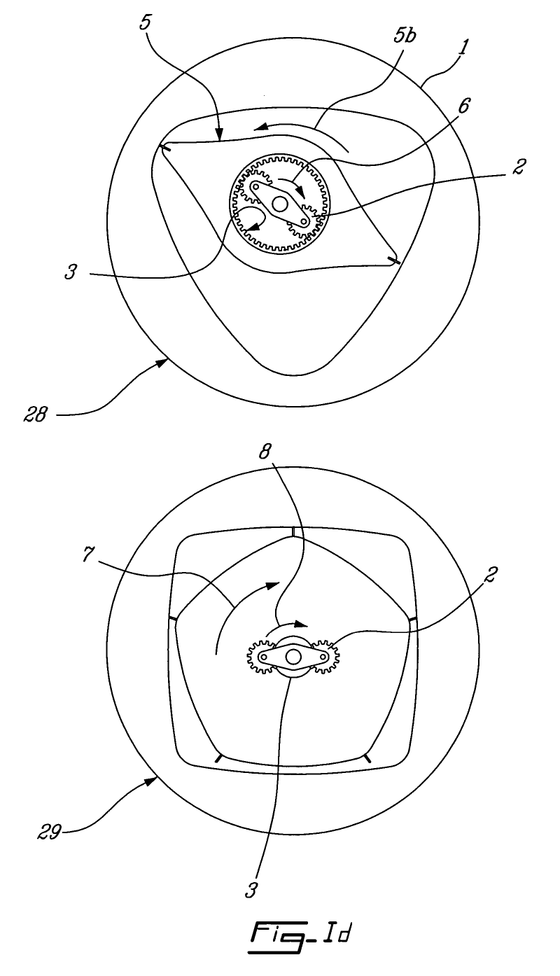

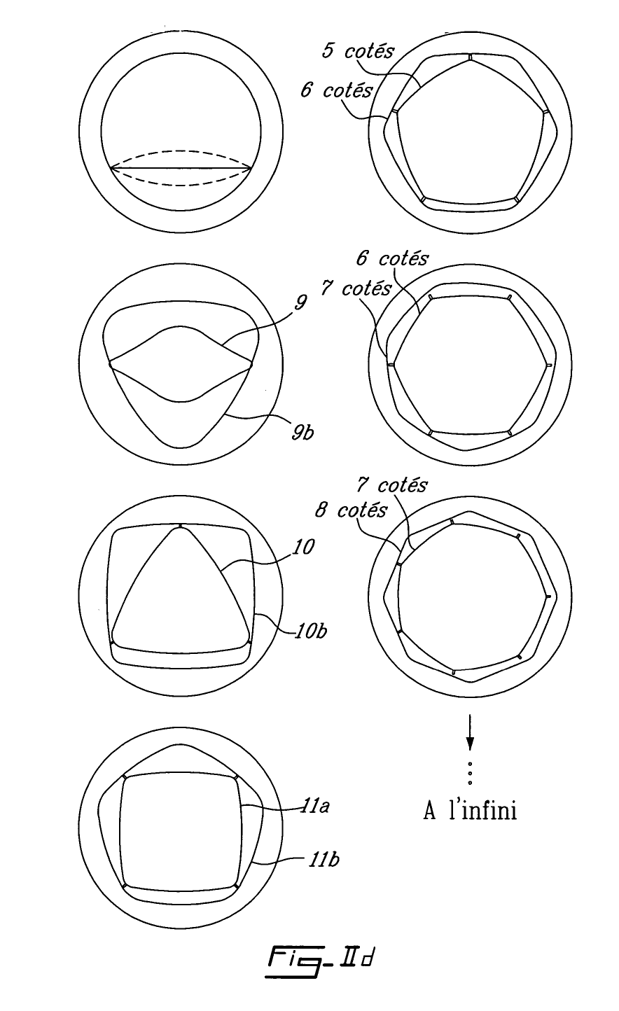

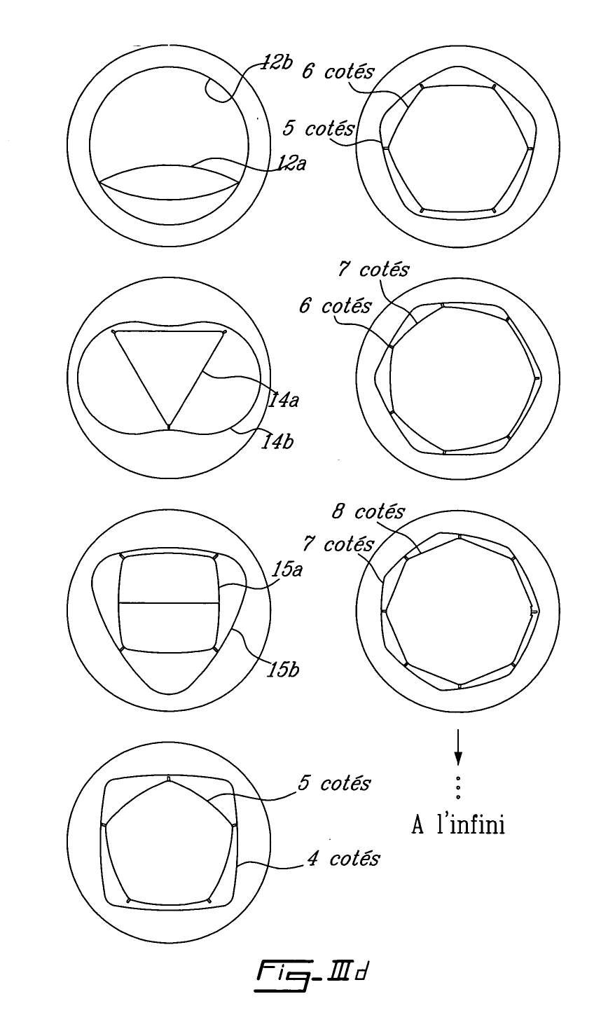

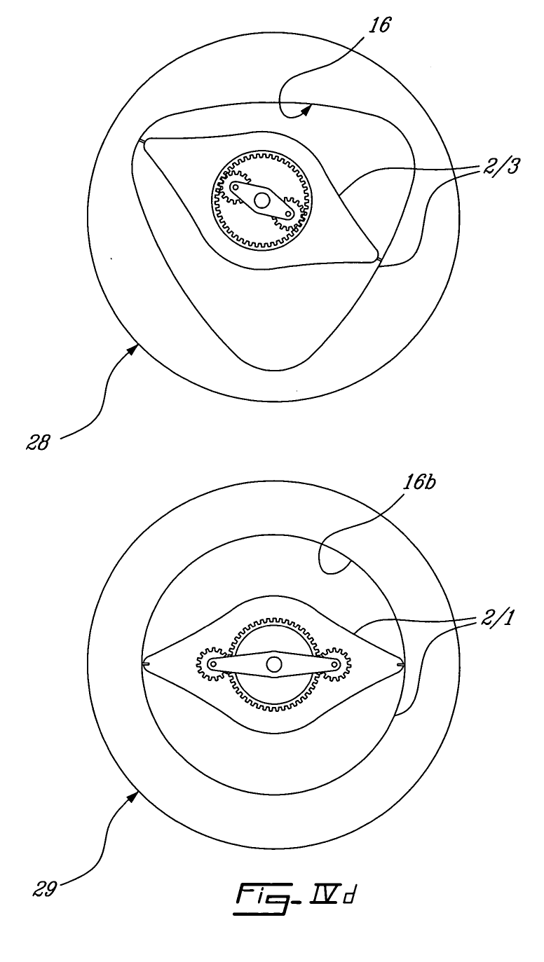

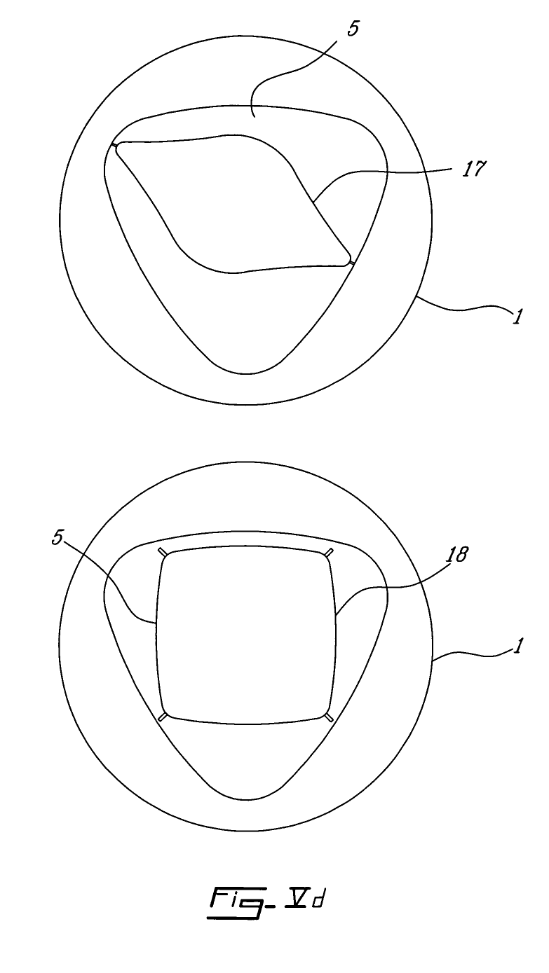

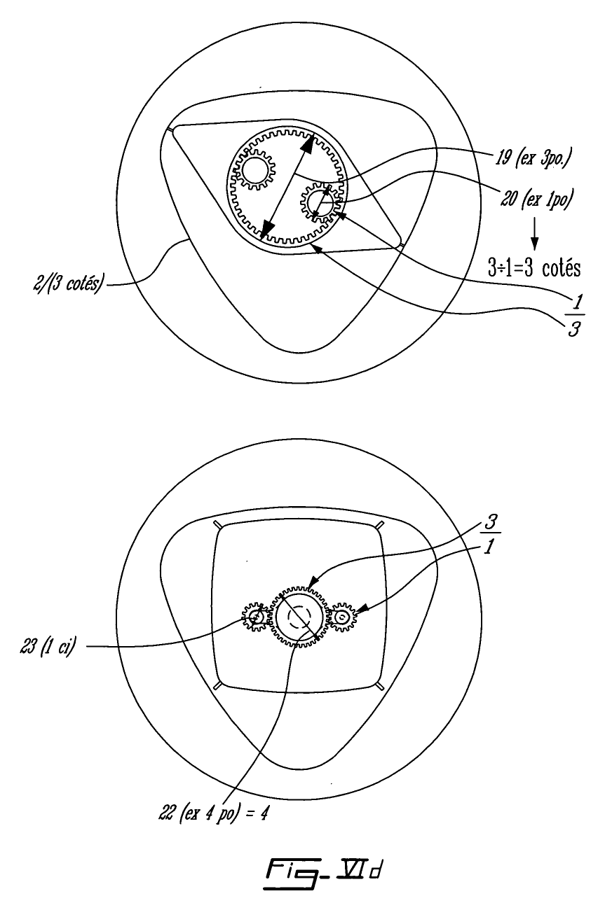

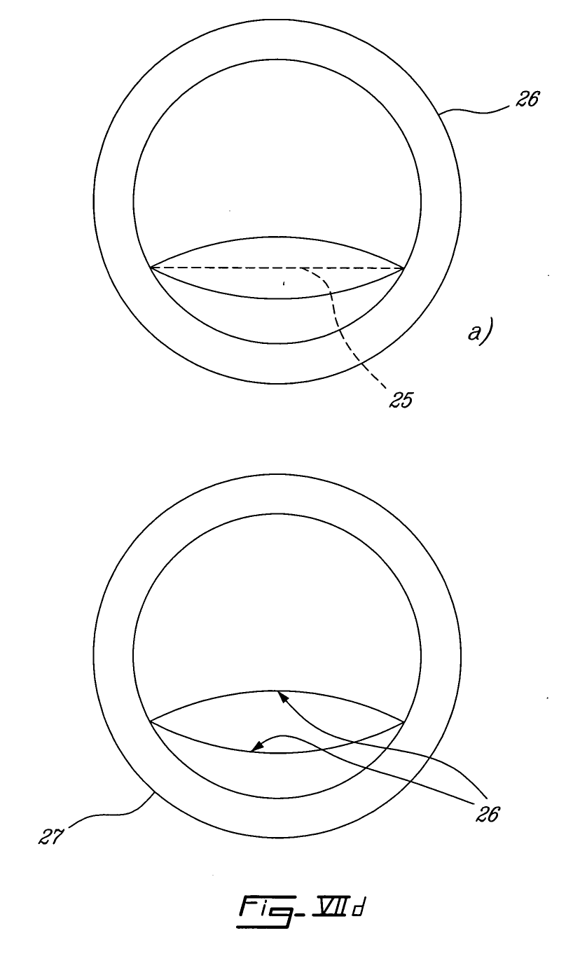

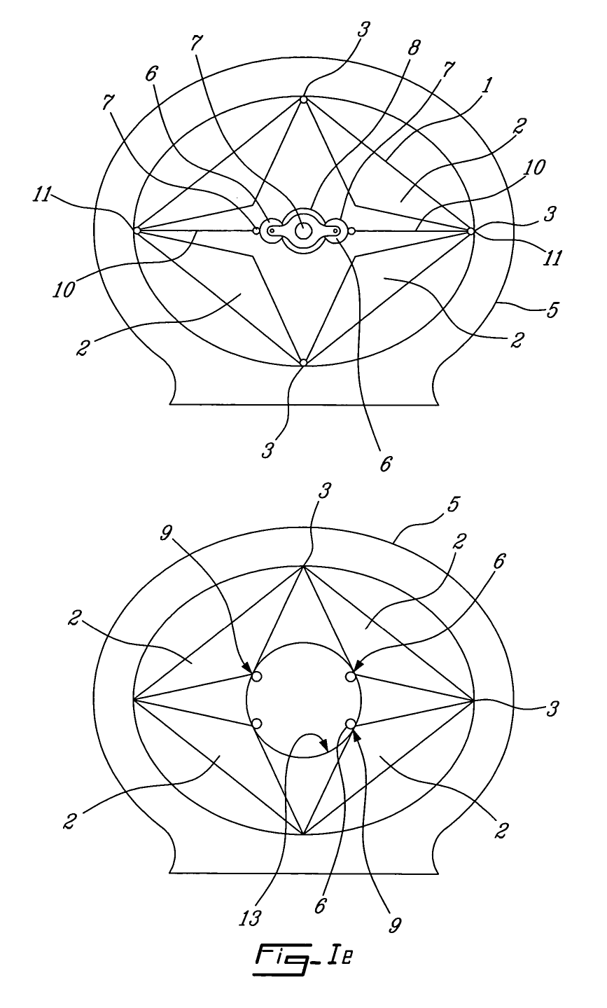

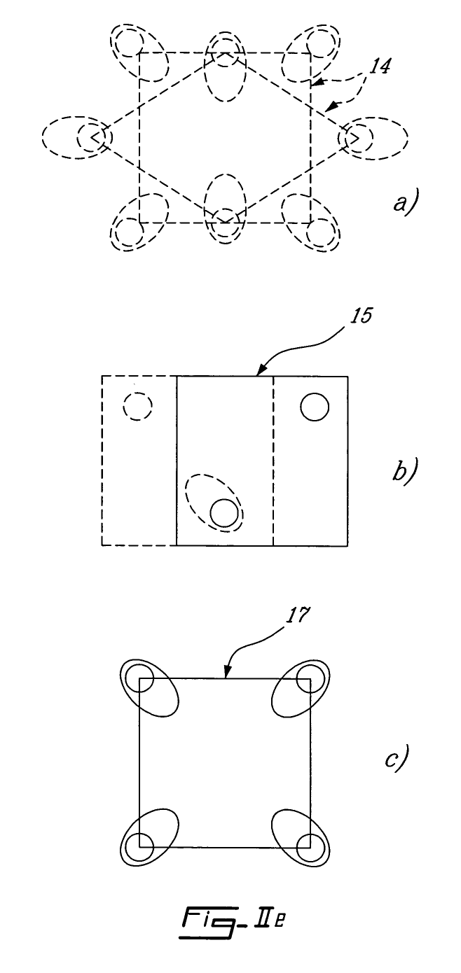

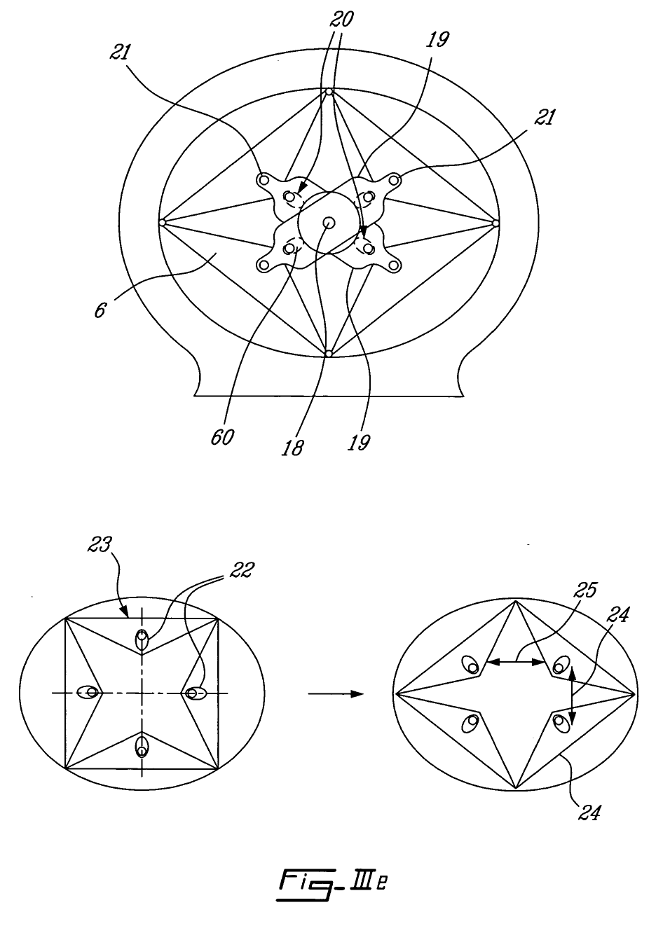

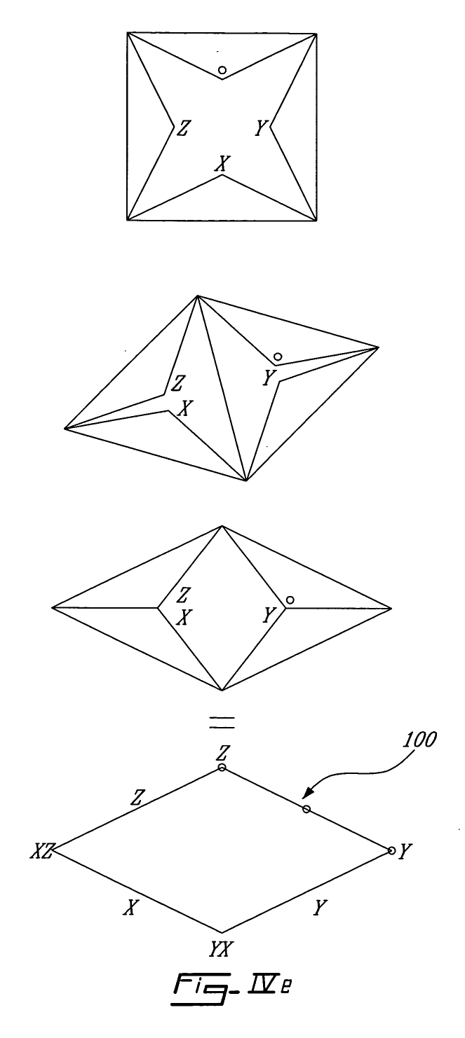

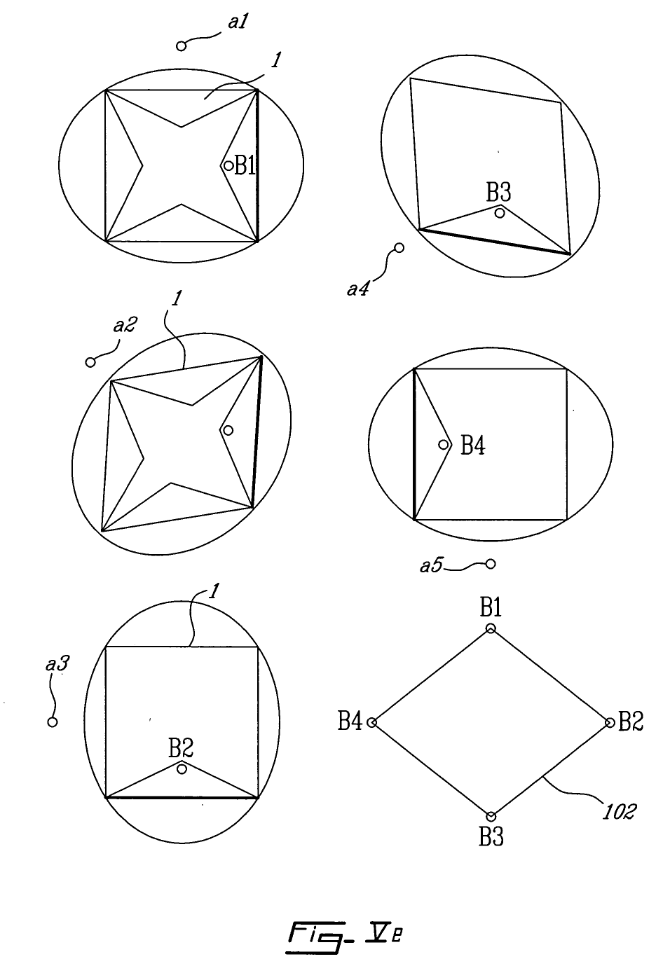

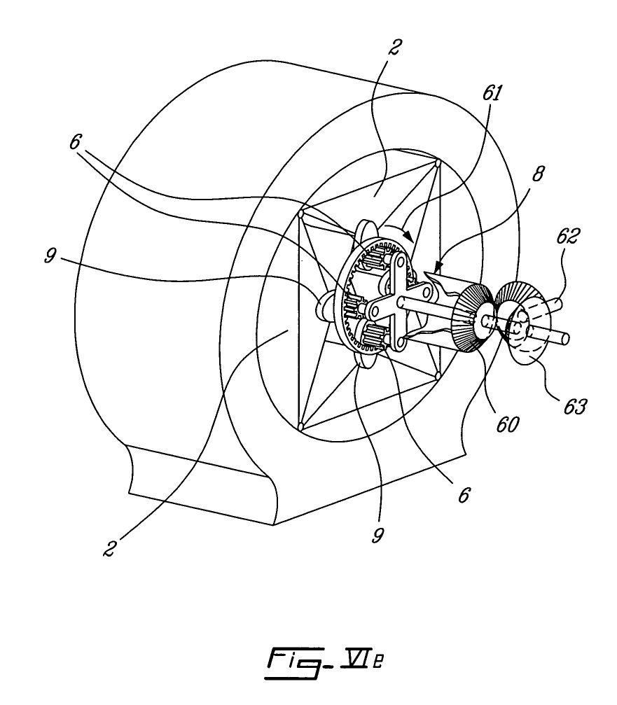

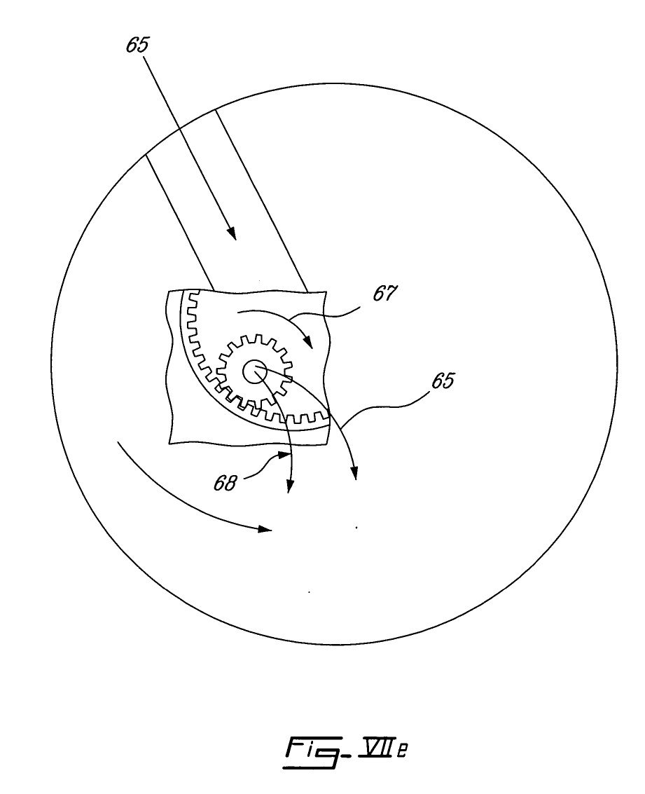

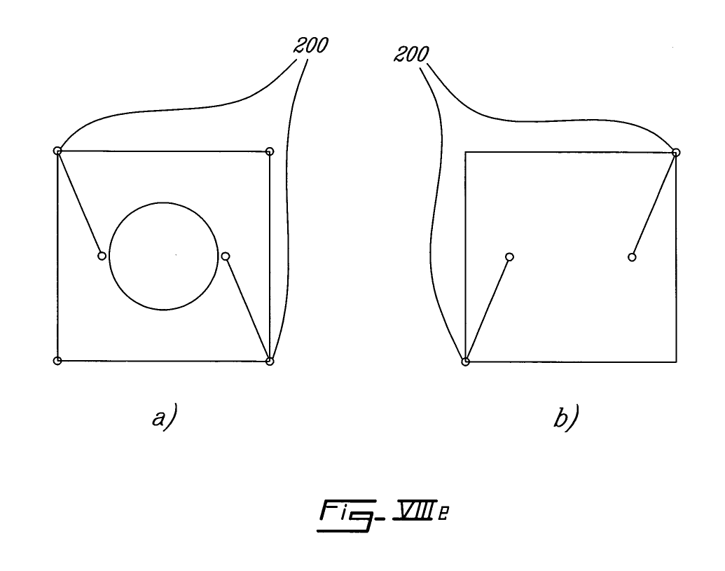

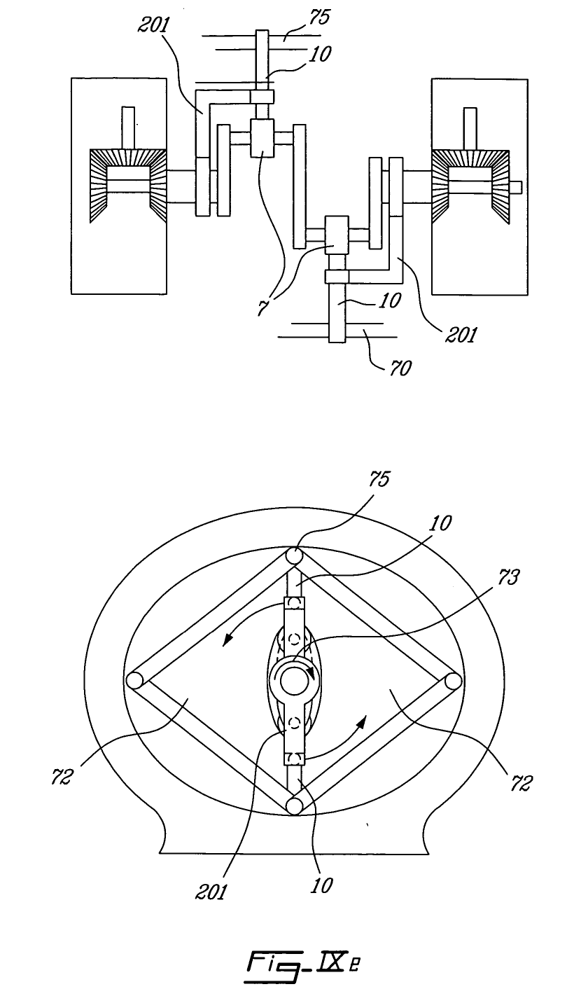

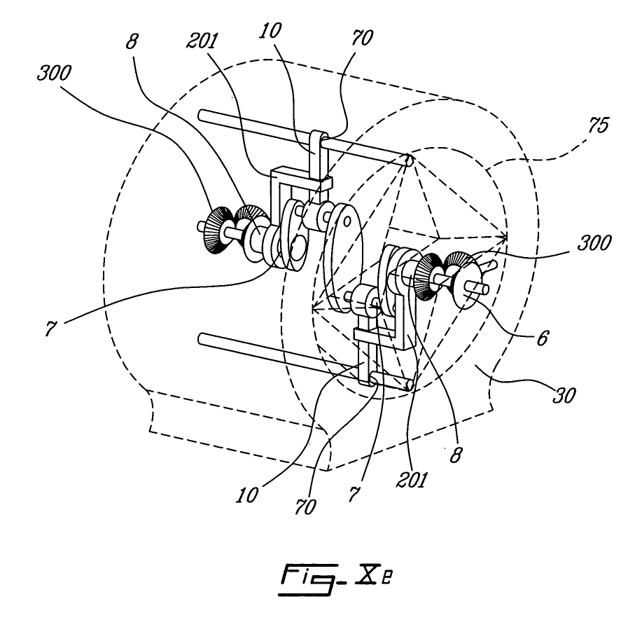

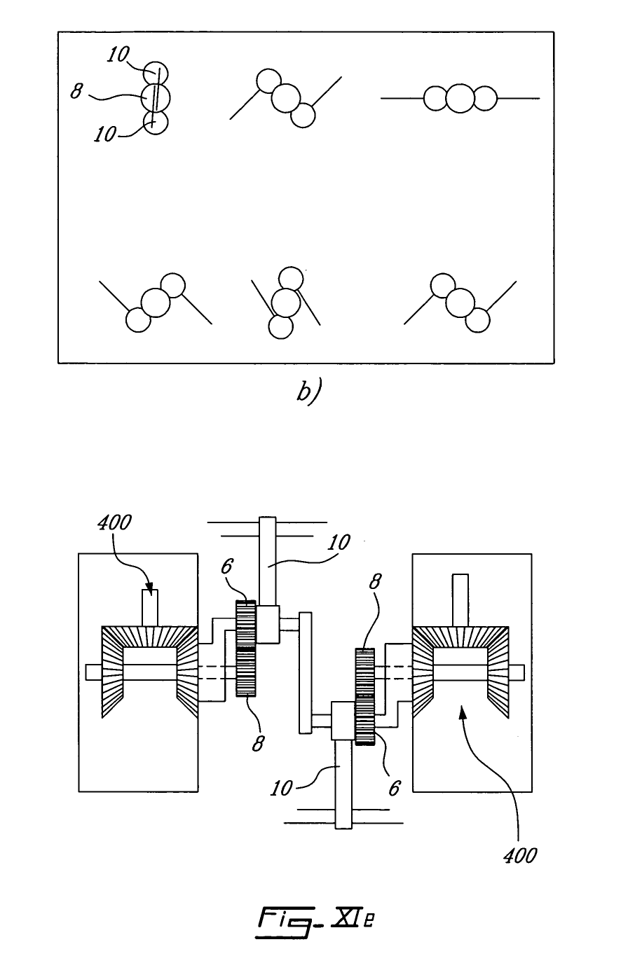

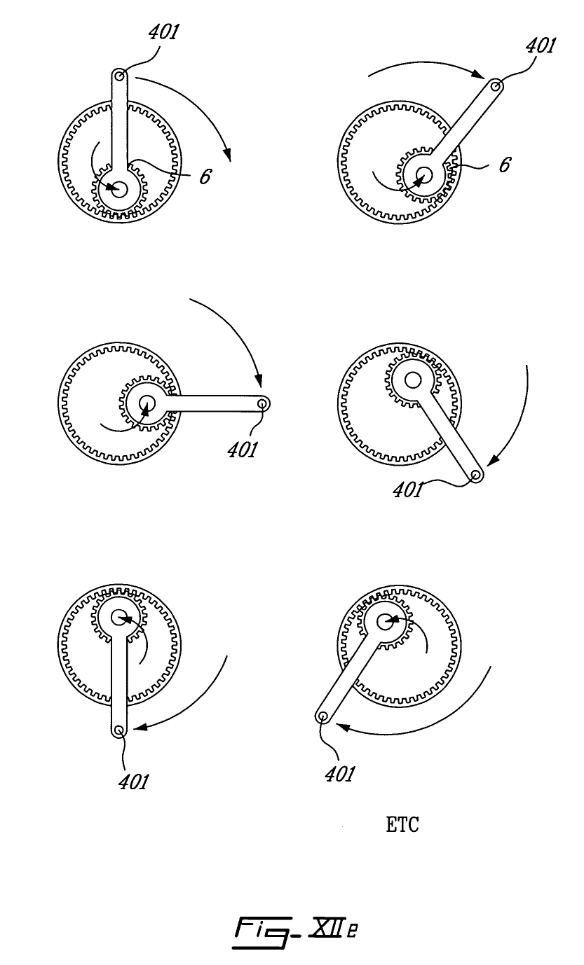

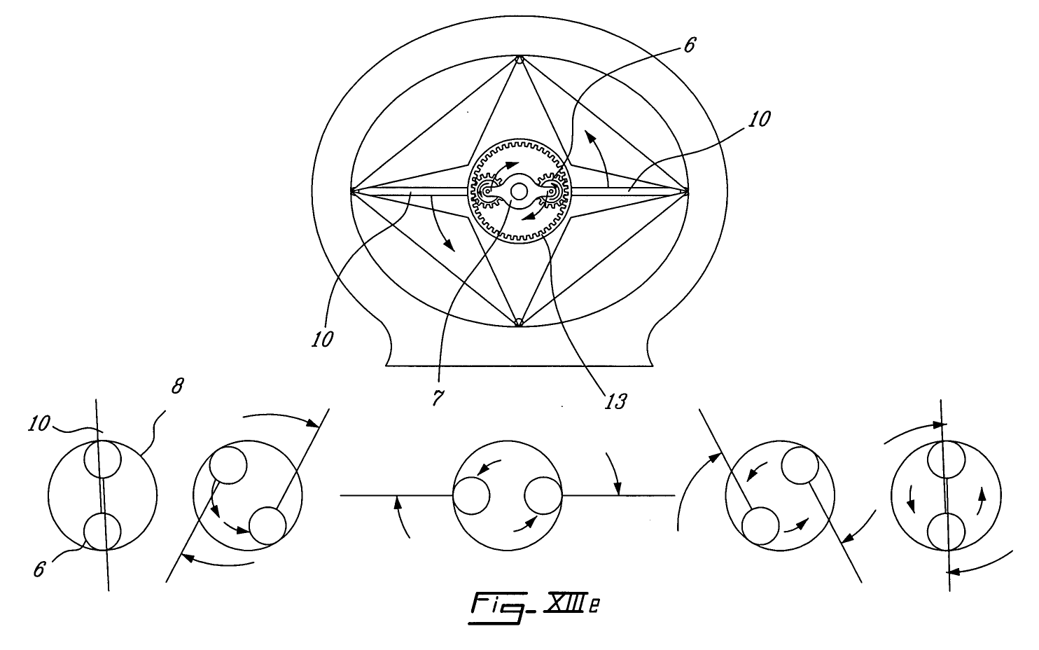

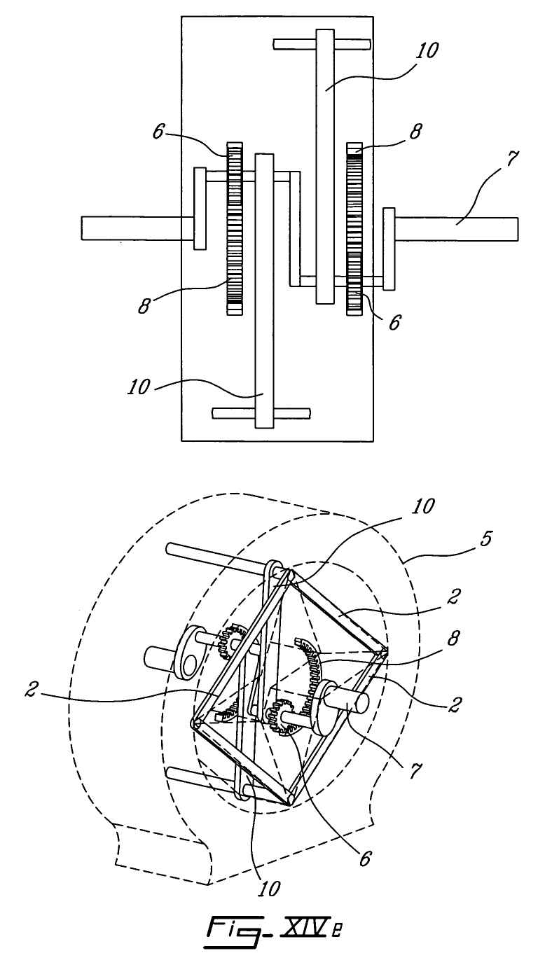

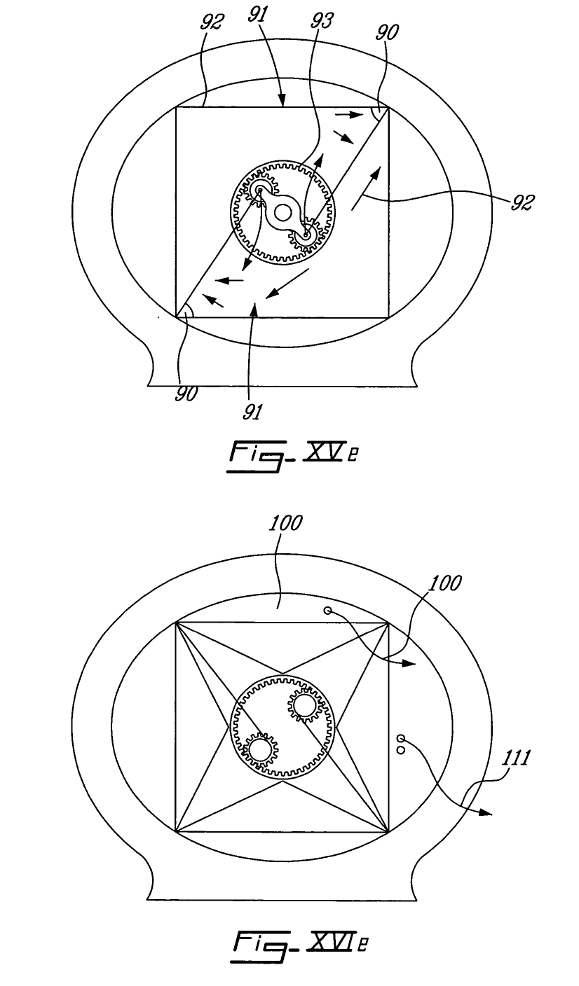

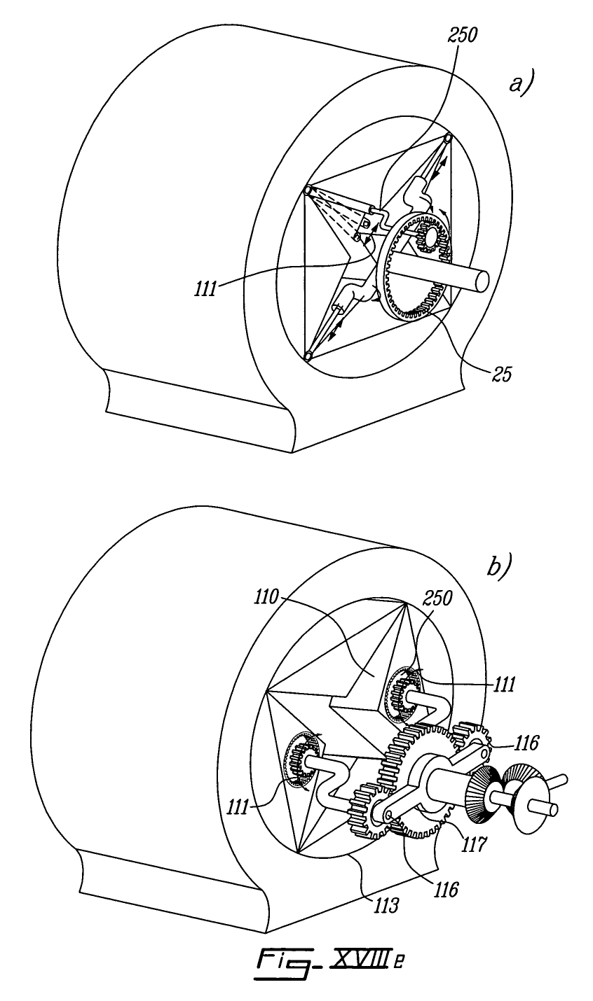

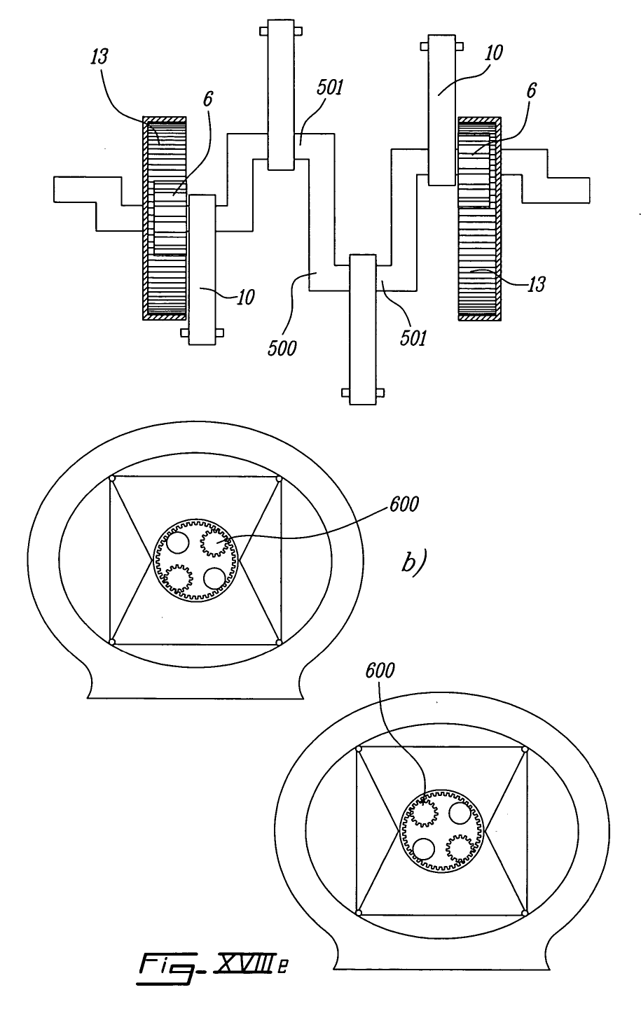

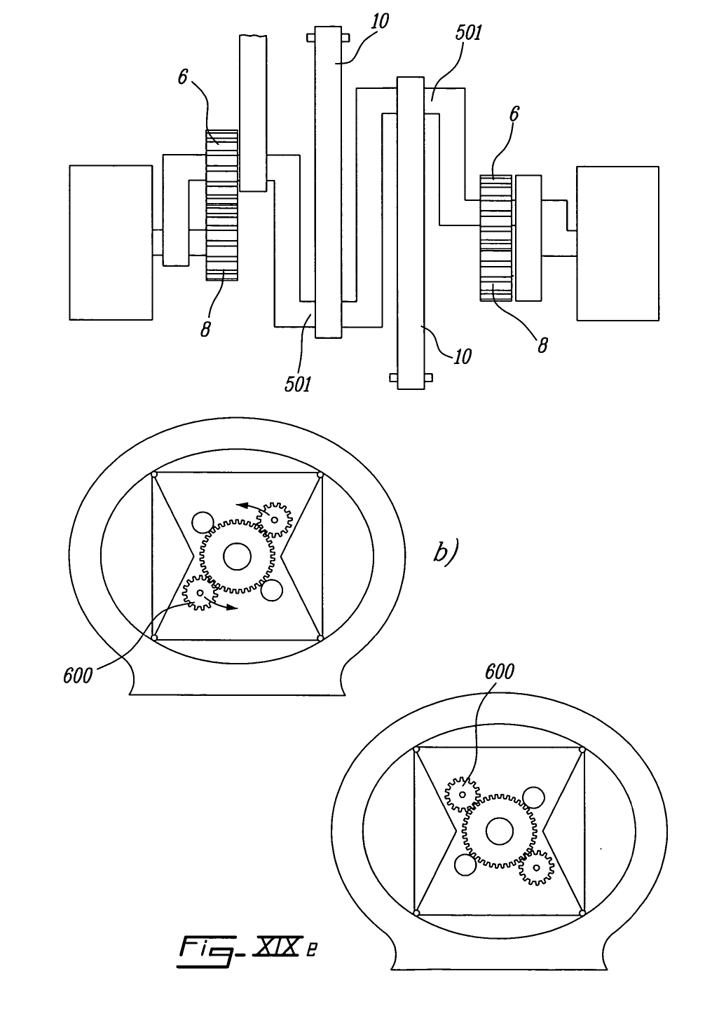

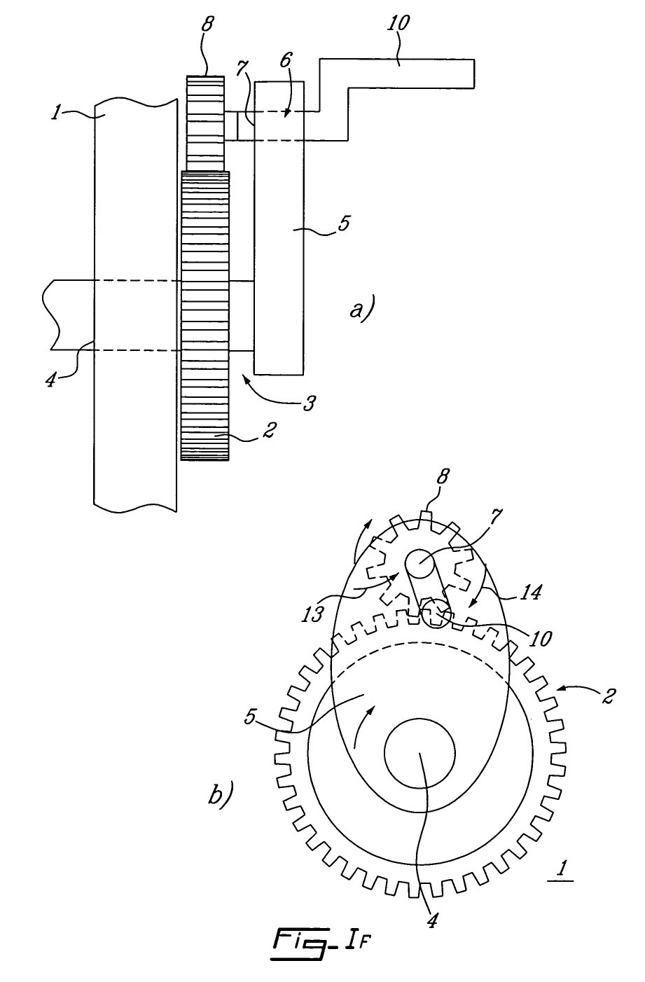

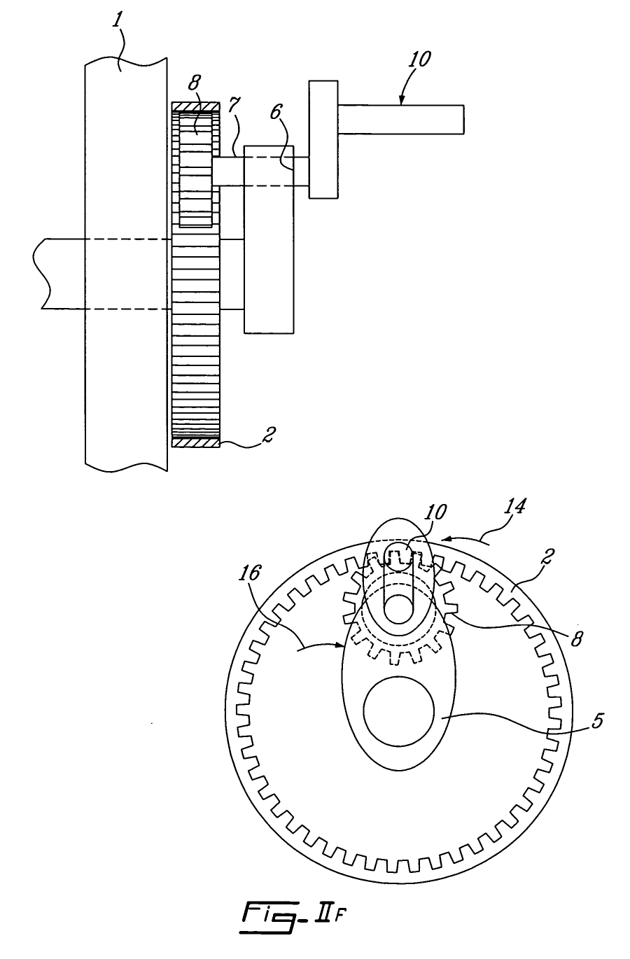

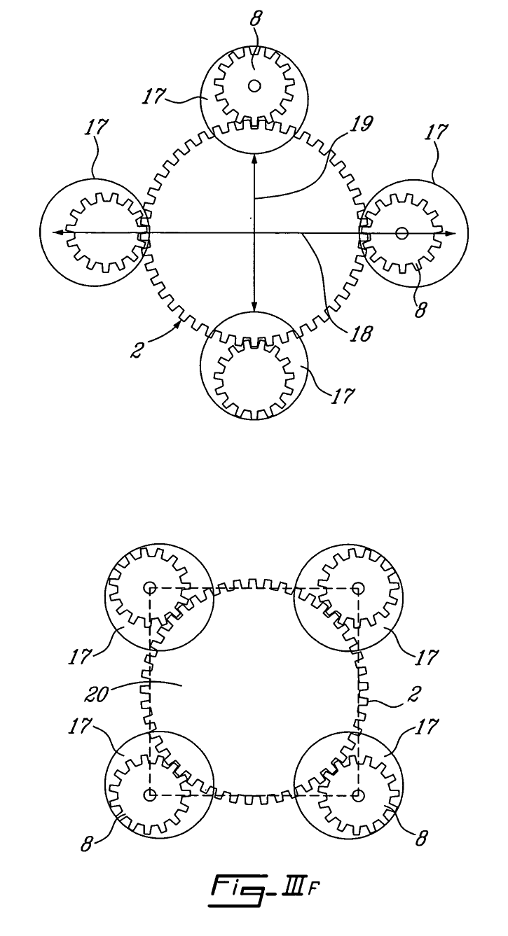

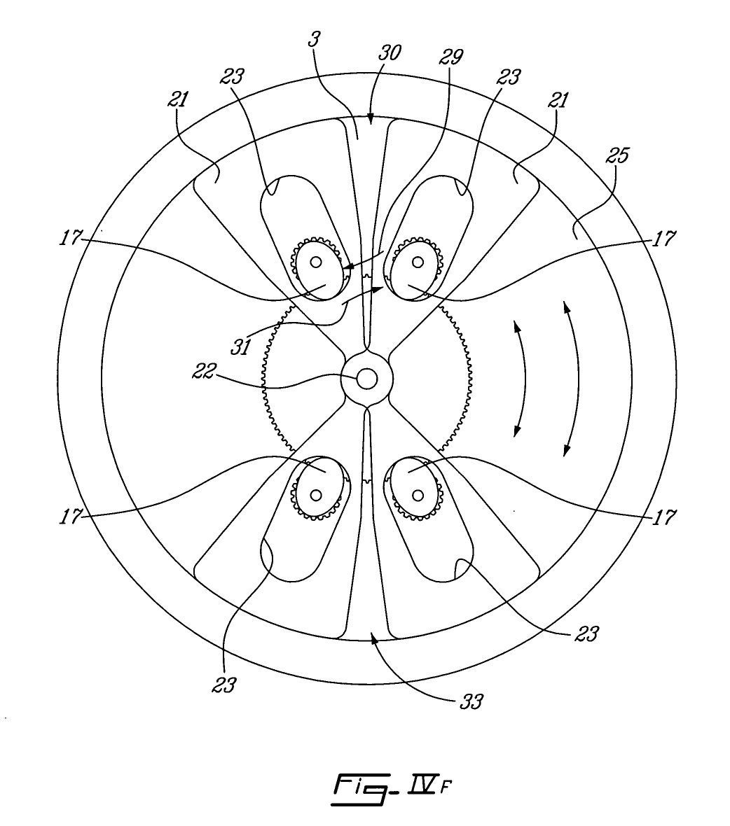

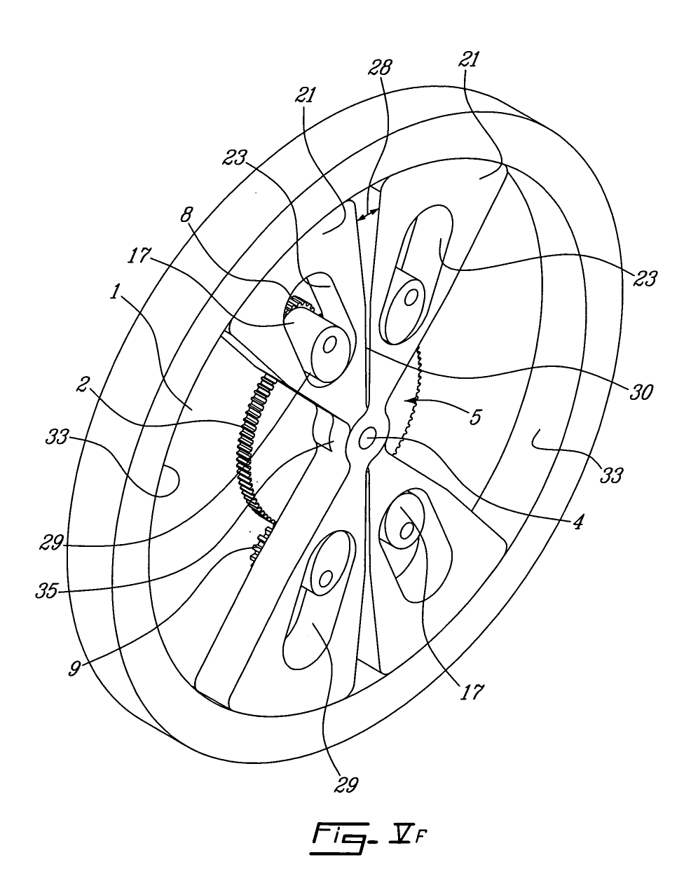

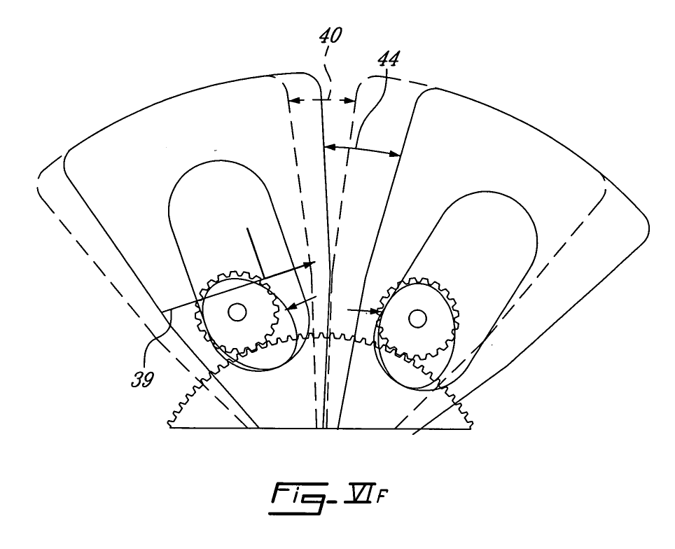

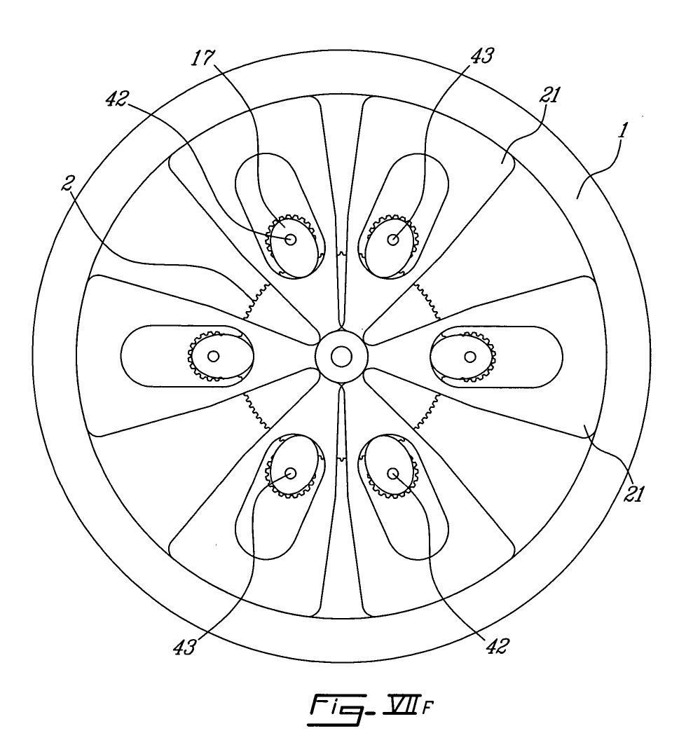

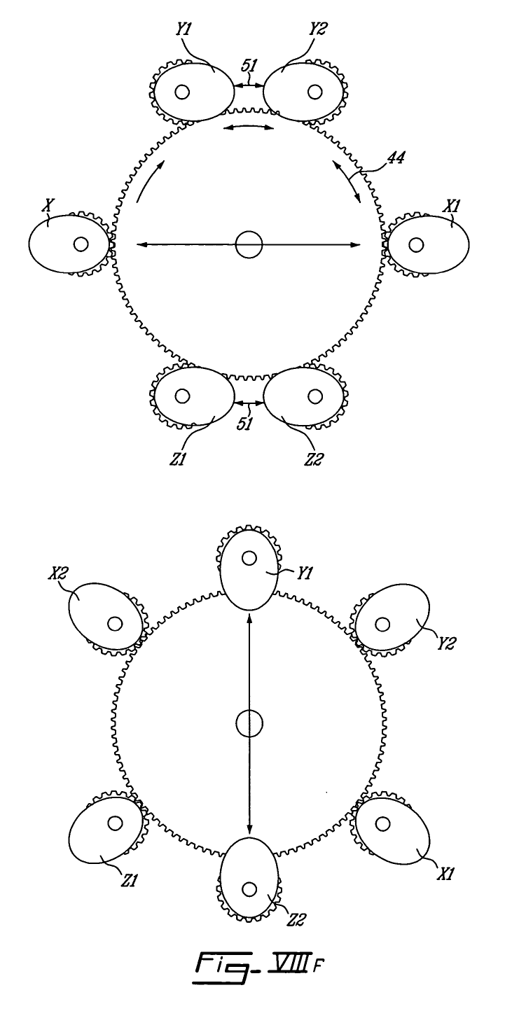

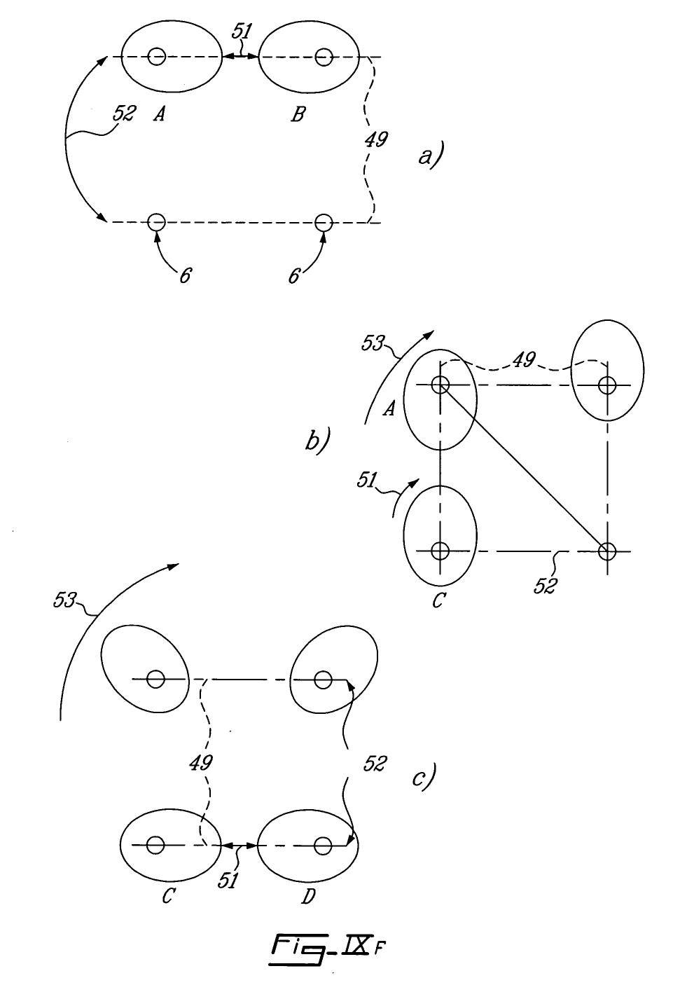

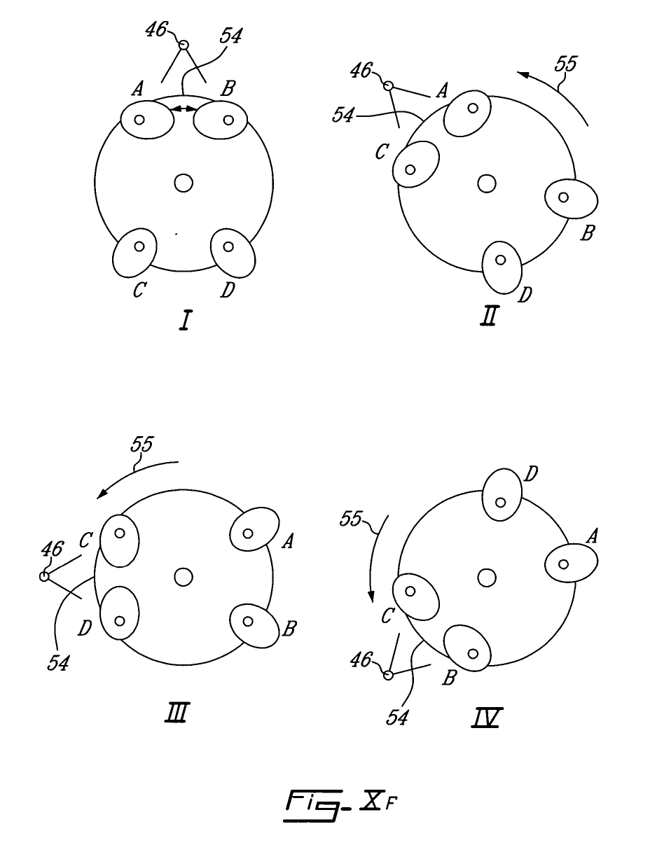

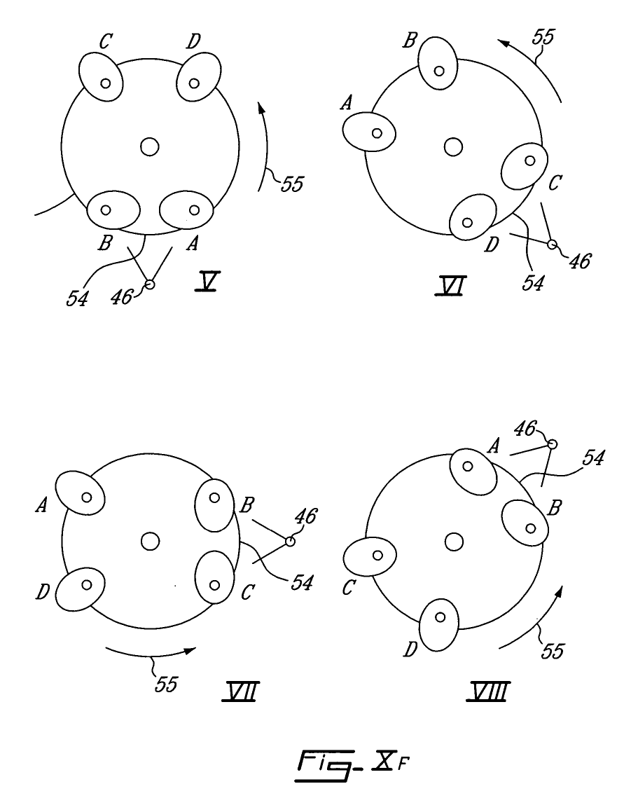

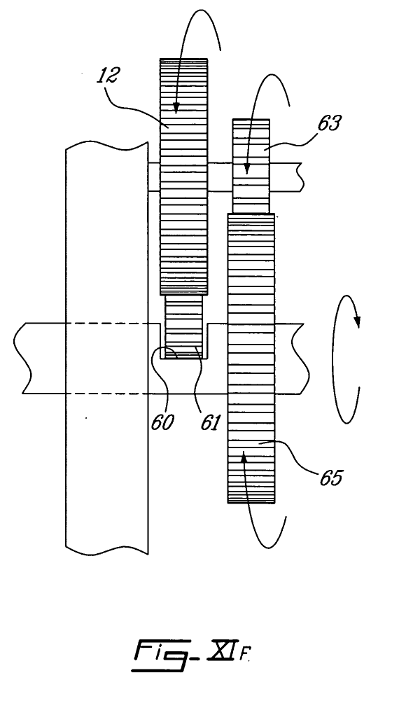

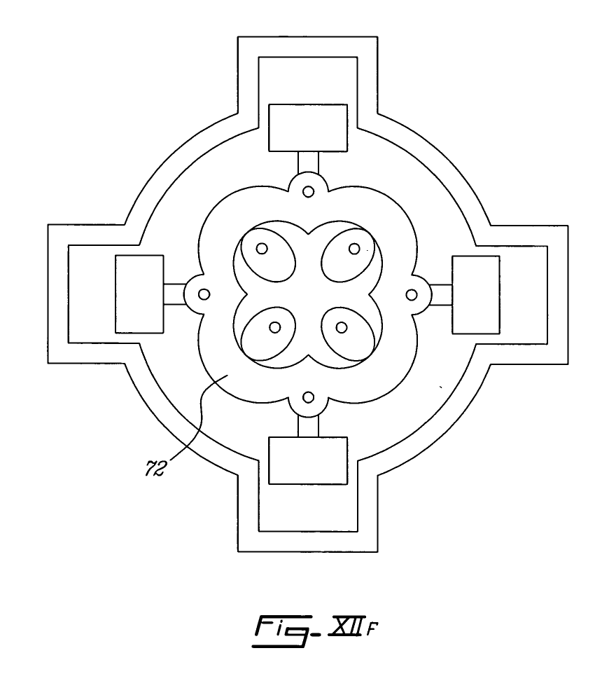

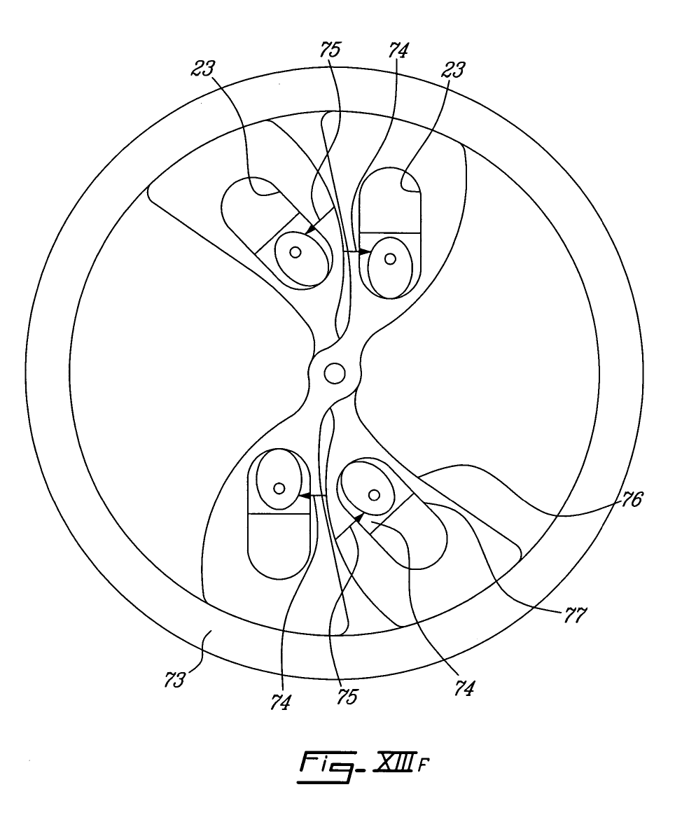

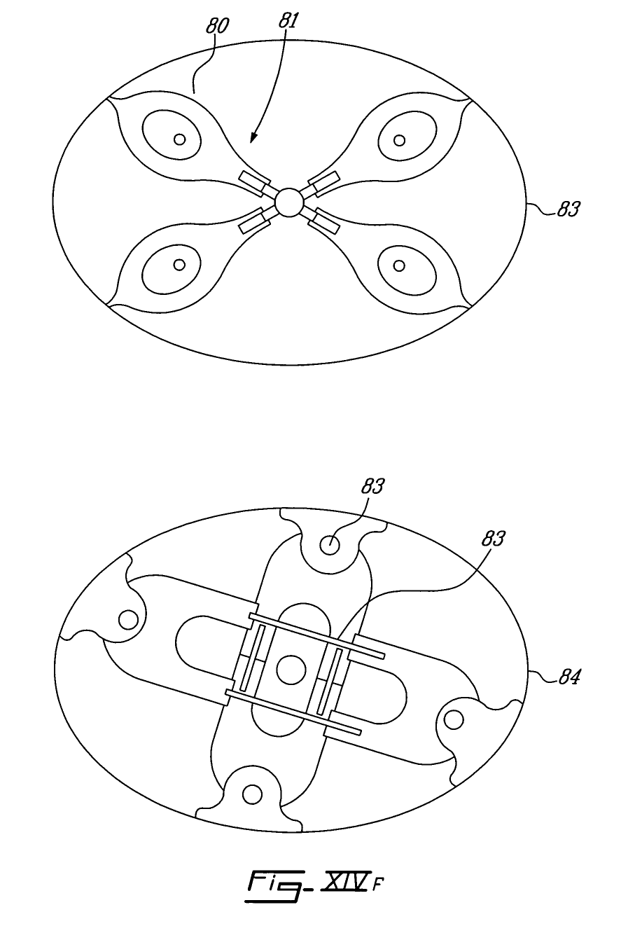

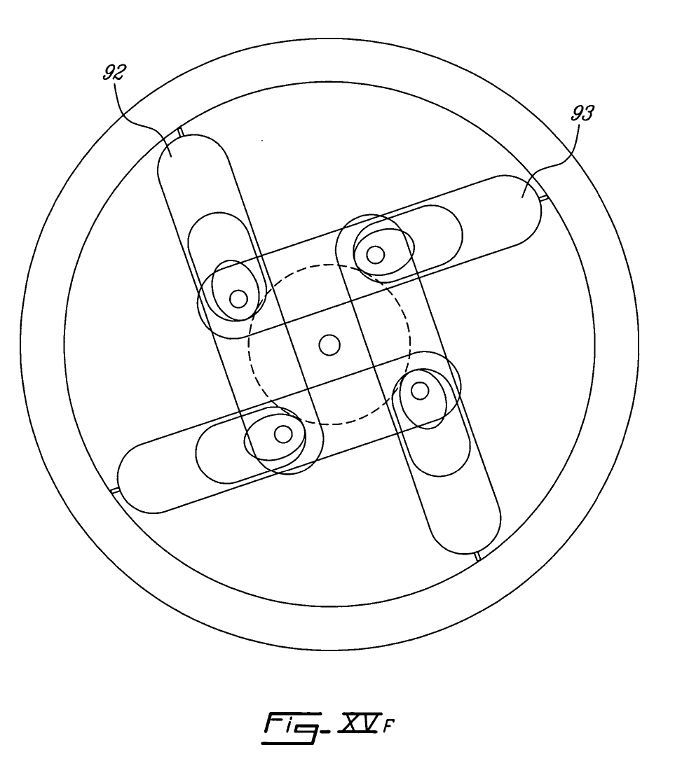

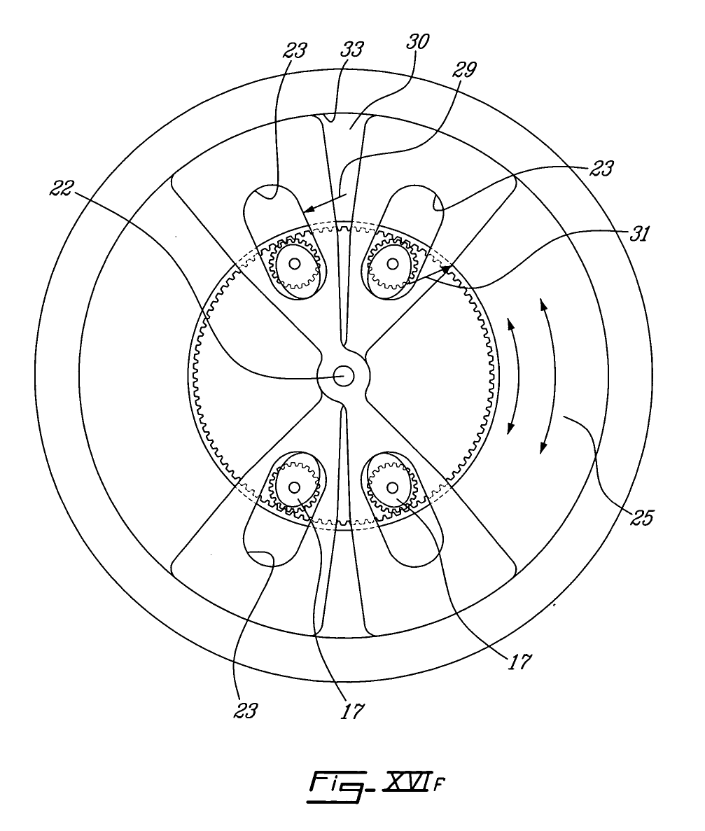

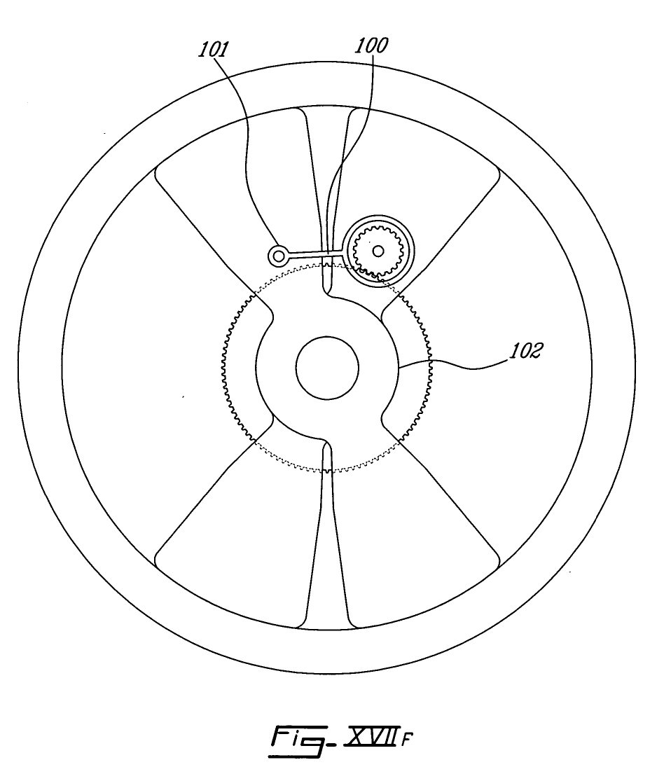

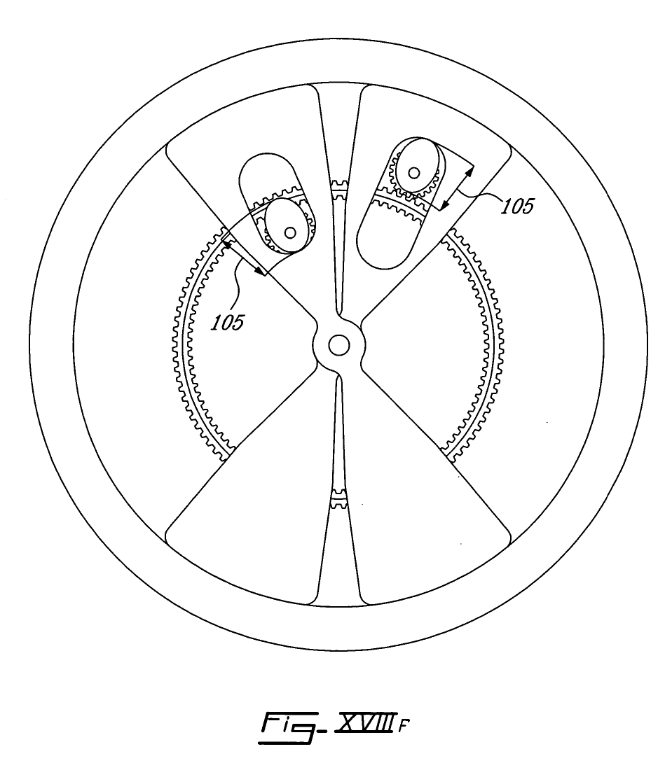

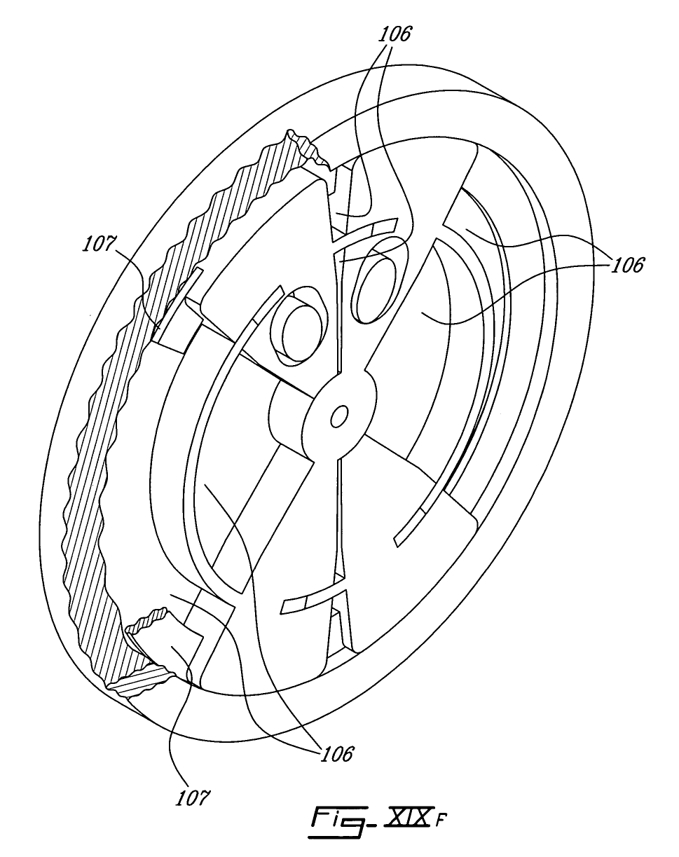

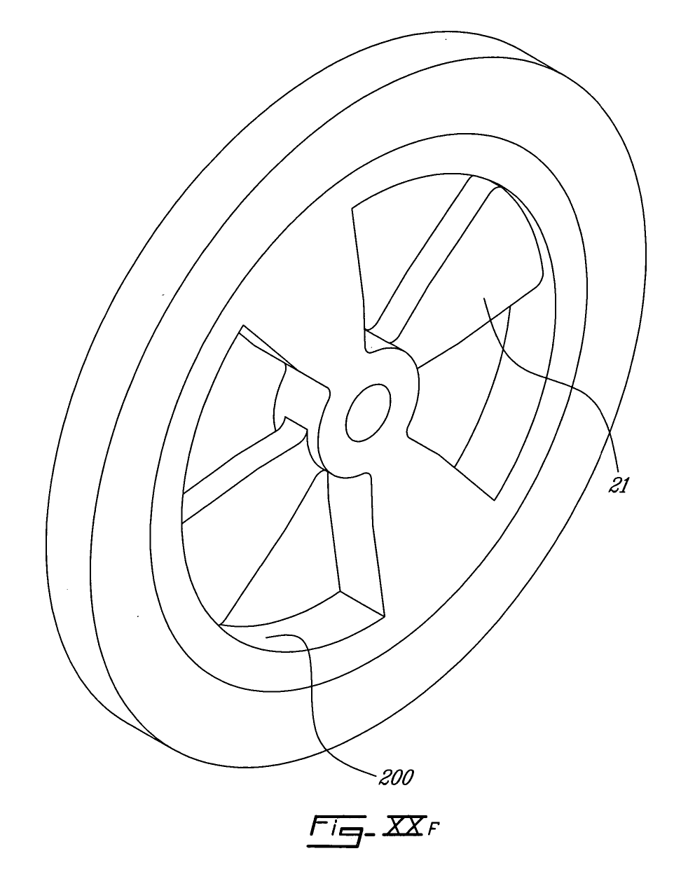

### PART A

Support Systems for Poly-Induction Engines

In the first part, we shall provide improvements to poly-induction methods for supporting elements of an engine by providing a mechanical structure able to advantageously equilibrate the span of gear means and bearing means, thereby allowing a structure with limited unbalanced friction between the poly-induction pieces, and thus a longer lifespan of the poly-induction machines.

Indeed, it has been shown how, in semi-transmittive and in poly-inductive engines, to obtain a mechanical assembly able to support a sophisticated and irregular movement of pieces of a engine machine, thereby allowing to build engines having a cylinder of a varied shape, such as for example a triangular engine, a square engine, polyturbines, and even engine with a rectilinear connecting rod type piston (First Part: FIG. IA).

A closer look of these semi-transmittive assemblies shows that generally the plurality of pieces aims at activating one or more connecting rod journal (maneton), which are connected to pieces of the engine such as blades, pistons, blade assembly of the polyturbines or of the differential induction engines presented hereinbelow.

Since engines are intended for large scale applications, we thought it was important to precise best methods for building poly-transmittive and semi-transmittive assemblies, not only practical but also durable.

In FIG. II A, problems occurring with some known assemblies are explained. In this example, it may be noticed that since a single semi-transmittive group supports the pieces, an irregularity in the scope of the rotation point thereof is obtained.

Obviously, a first method for solving this problem is to provide the assembly with a second semi-transmission opposite the first one, and connected therewith. In such a way, the pieces are supported in an equal way on both sides (FIG. III A).

However, such method, as far as engines are concerned, is not satisfactory because it yields a duplication of the pieces. Moreover, from a mechanical point of view, this method results in additional pieces to be necessary in order to synchronize the two semi-transmissions. Finally, it is to be noted that this method results in a heavy non-efficient mechanical assembly.

The present invention is based on a new central piece in the semi-transmission, referred to as a semi-transmission bridge, which extends across the width of the engine in such a way as to be rotatively supported on both side in equilibrium (FIG. IV A).

Upon building, a second feature of the present invention will be apparent, which consists in replacing an induction gear means fitted with a central axis and a connecting rod journal by an induction gear comprising a cam, both rotatively mounted on a connecting rod journal located on an axis of the bridge (FIG. IV A).

Rigidly connecting the induction gear to the cam allows mounting them rotatively about axis across the bridge, referred to as rigid supporting axis of the induction gears.

In FIG. V A, a general semi-transmittive assembly is shown, and it mat be seen that the pieces are perfectly supported, on the axis as on the coupling of the gears and the support of the blade. Moreover, it will be seen (FIG. VI A) that this assembly, by moving the supporting gear toward the center, may be located on the blade itself.

These axis allow to rigidly connect each side of the bridge, but other rigid means may be used independently to more specifically connect each side of the bridge. Thus the bridge may be erected as a single piece, to which supporting axis of the induction gears and cams will be added.

It is to be noted that in certain cases when pieces are to cross the center, especially in rectilinear reciprocating engines, or else in semi turbines, the central axis may not do through the center of the engine. Therefore, a second supporting means supported by a neck, located behind the supporting gear, is contemplated (FIG. VII A). In this case, a handle may be fitted to the connecting rod journal in order to redeploy mechanical energy outward if necessary. The bridge assembly may then be supported on each side with a well balance span.

In the following figures, VII A, such a method is applied to an engine with a rectilinear connecting rod.

A similar arrangement connected to a master gear, or to a supporting gear of the internal type, may provide a retroactive device, such as a triangular engine.

Part B

Semi-Transmittive Assemblies of Poly-Induction Engines

Still in relation with poly-inductive machines, this section will shows that the same cylinder shapes as those of original pol-induction machines may be obtained by applying a retroactive semi-transmittive method for supporting the pieces.

In previous patents related to poly-induction engines, as well as to extension thereof to retro-rotative and post-rotative engines, a poly-induction method with a double induction gear was mainly used to activate the mechanism of the engines (FIG. IB).

In this section, it will be shown that, especially in relation to retro-rotative engines, different induction assemblies may be used, with a semi-transmission, while the machine or the engine remains poly-inductive.

First it will be shown how to combine a central active connecting and inducting location, by using an eccentric, with an induction gear also active and centrally located and connected to an internal gear of the blade (FIG. IIB). The two dynamic points of the assembly are connected together by a semi-transmission, which, being in retro-active poly-inductive engines, reverses the movement.

Then, it will be shown that, by varying the ration of the gears, and consequently the shape of the blades, an infinity of retro-rotative engines (FIG. V B) may be obtained, in the same way as if double inductive gears were used as described in the aforementioned documents.

Then, a problem in the previous assembly will be pointed out. Indeed, since in this assembly, the blade always goes through the center during its movement between two explosions, the ratio of extension and closing of the chambers is not sufficient for a proper compression (FIG. VI B).

A new method for building such engines will be presented, which uses two different dynamical points, one of which is located on the center, I, e. on the central axis of a crankshaft (vilebrequin), and a second of which is located at the level of the connecting rod journal of the crankshaft (FIG. VIII B).

It will be shown that then the blade, since its center moves at all times along the eccentric travel path of the connecting rod journal of the crankshaft on which it is mounted, never goes through the center again, and, moreover, goes higher in the angles of the triangles, thereby allowing the sides of the cylinder to be planer. This method yields a rise in the ratio of extension and closure of the chambers, allowing a satisfactory compression and combustion, while maintaining the retro-rotative effects (FIG. VIII B).

It will be shown that such compression may even be supercharged by adapting the shape of the blades. It will be noted that all retro-rotative features, especially those related to a complete use of the surface of the blade and to the lever effect, are maintained. Lastly, it will be noted that such assembly, still by adapting the ratio of the gears and the number of sides of the blade and of the cylinder, allows to build an infinite number of retro-rotative engines (FIG. IX B).

Part III

General Synthesis of Poly-Inductive Engines with Blade

In this section, a third method will be described, using hoop gear, for supporting the blades of poly-inductive machines, and a general method for building these machines will be given, especially for building post-rotative machines in a retro-rotative fashion.

This section aims at showing how, following applications developed in relation to retro- and post-rotative poly-inductive engines, to develop a general method for combining the features of each assemblies presented, so that they may all be applied to all engines with a purpose of maximizing the power and efficiency thereof. Thus, any type of engines will benefit from features of complementary type engines. It will thus be possible to make up for weaknesses of anti-rotative engines by increasing a compression ratio, while post rotative engines will be turned into anti-rotative engines so as to fully benefit from the lift on the blade. Consequently, each type of engines will be able to be provided with inherent features of the other type of engines.

In previous inventions of the present inventor dealing with poly-induction, it was shown how, by supporting the rotative pieces of a engine at more than one location by means of a specific semi-transmission, it was possible to build two different types of engines, depending on whether the supporting gears used were of the internal type or of the external type (FIG. I C).

Then, in a generalization of such engines, it was shown that there was a geometrical relationship between these two types of engines, which on the one hand allows differentiating them, and on the second hand allows generalizing. It was indeed shown that it is possible to build an infinite number of retro-rotative engines by configuring the rotative piece, the blade with a number of sides inferior by one unit to that of the cylinder in which it moves. Moreover, it was also shown that an infinite number of post-rotative poly-inductive engines could be build, by configuring the rotative piece, the blade with a number of sides superior by one unit to that of the cylinder in which it moves. Therefore the applications described were only possible embodiments of a number of possibilities (FIG. II C).

Then, in the invention entitled “Semi-transmittive assemblies of retro-rotative poly-induction engines”, it was shown that there was a variety of poly-inductive semi-transmittive methods, either by the ends, by the center, or by external gear means (FIG. III C), for designing retro-active engines, wherein all these methods yield controlled retro-active effects.

As already discussed in length, retro-active engines have advantages compared to post-active engines in that they convert backward effect forces into forward forces, which causes the surface of the blade to be exposed to the generating energy explosion on its whole length (FIG. IV C).

The following will aim at showing how to build post-active engines and machines in such a way that they be retroactive, and that, consequently, as any retro-active machine, their explosion surface be fully used, as is the case in retro-active engines.

Before that, the forces during the way down will be described, in the case of a conventional rotative engine as well as in the case of a poly-inductive post-rotative engine, in order to assess the extent of power gain allowed by the present invention during explosion.

First, the generation of forces during the way down in a conventional rotative engine will be briefly explained (FIG. V C).

In such engine, which is of a high geometrical quality, there is a very low energy yield. Even more important, there is a poor energy use. Indeed, due to a specific supporting configuration of the triangular blade, more than a third of the energy is lost in the first half thereof to balance and cancel the effects of pressure on the back thereof.

Then, on the remaining part of the blade, which is about less a third thereof, the lift available has only a rather weak torque angle, and this torque is not direct but results from other direct forces, as will be shown hereinbelow. Lastly, the fastening of the piston, by slowing down the movement in regard with the crankshaft, causes more friction as well as an energy dissipation, since the blade has to move the crankshaft twice as fast as its own movement. Such an assembly, activated by the crankshaft, would be a better compressor than an engine.

The present post-rotative invention, which again evidences a multiplicity of possible embodiments, will be explained in relation to a triangular blade for clarity purpose. It is found however that a blade with four sides is better adapted for two-steps commercial engines.

FIG. VI C illustrates that there is a significant improvement in the forces when using such poly-inductive method for building a blade-type engine. It illustrates that using geometrical features allows a totally different technical way of obtaining the forces.

A shown, first the backward effect is completely cancelled since the rear fastening point provides a natural mechanical lock preventing the blade from receding. Thus, although the energy on this part is lost, there is no need of a counterbalancing energy. Therefore, there is no waste of more than the second third of blade surface used for compensation. Second, the second fastening point, during the way down, exits the inner circumference, thereby increasing the torque. Lastly, the blade moves faster than the piece that acts as a crankshaft thereof.

The present assembly yields much more power that the previous one. Moreover the engine behaves smoothly without frictions, due to an improved use of an improved blade.

The present invention will aim at using more extently the surface of the blade, as in the case of poly-inductive retro-rotative engines.

First of all, a brief summary concerning retro- and post-rotative engines will be given, pointing out features that need modification to convert a type of engines to another type, i.e. to mount post-rotative engines in the way of retro-rotative engines.

A main difference between these two types of engines lies in the relationship between a direction of activation of the crankshaft and a direction of activation of the blade.

In the case of retro-rotative engines, the blade and the crankshaft move in opposite directions, while in the case of post-rotative engines, they have the same direction (FIG. VII C).

In retro-rotative engines, there is therefore always inversion of the movement of the blade in relation to that of the crankshaft.

A similar arrangement applied on a post-rotative engine seems deemed to fail. If, as is the case in triangular engine, an external gear is provided on the side of the piston and connected to a supporting internal type gear in order to reverse the movement, a retro-active engine with a four-sided cylinder is obtained, and a two-sided cylinder is not realistic. (FIG. VIII C).

However, a different point of view may be contemplated, wherein the movement of the blade relative the crankshaft is considered from the movement of the crankshaft, instead as from the body of the engine, as a reference. This is equivalent to assess the relative action of the pieces not as of an outsider observer but as an observer ideally rotating together with the crankshaft. Such a point of reference will evidence a common feature shared with retro-rotative engines, wherein in both cases, from the point of view of an observer attached to the crankshaft, the blade moves in a reverse direction with regards to the crankshaft. Therefore, a certain retro-activity is thus evidence in the post-rotative engine, which the present invention will aim at exploring (FIG. XC).

A first embodiment will attempt at realizing this by a direct action on the crankshaft itself and on the blade to obtain, retroactively, the desired effect (FIG. IX C), knowing that the retroactive effects are to be assessed in relation to the crankshaft and not to the body of the engine.

It is now known that it is mechanically possible to obtain a post-rotative engine in a retro-active way. FIG. XII C shows that this is not only a geometrical achievement and that it produces the desired effects due to the use of energy by the whole surface of the blade.

By an in depth study of this embodiment, it is noted that it comprises two mechanisms inverting the rotations of the gears by means of pivots. The same result is obtained with an internal gear located on the side of the blade and an induction gear located on its axis (FIG. XIII C).

A further embodiment of the present invention will also make use of n internal gear in the semi-transmission for one of the axes. Since the inversion is caused by the internal gear, the pivot gear will not act as an inversion gear but as a reduction gear.

A next step will be to determine whether such an assembly may be simplified, since, even though it behaves smoothly, it is rather heavy. It is common when conceiving engines to go through two main steps, including the design of new, well supported configurations without friction, and a following simplification thereof to the very few necessary elements, as will be presented in the next two embodiments.

In the first one, inversion will be achieved by means of internal gears acting as inversion gears.

At a level, such as at the level of the crankshaft for example, a transverse axis provided at each end with an induction gear will be mounted, each one of the induction gear being coupled to an internal gear, one being in the side of the engine while the other is in the side of the blade.

FIG. XII C shows how such an assembly captures energy.

As in previous patents, it will now be shown that the assembly may not be further simplified.

The last embodiment of the present invention is what is believed the simpler possible assembly, since it uses only a single internal gear and two external gears (FIG. XVII C). The internal gear behaves as a hoop connecting the two external gears, and at the same time produces a reduction in speed as well as a double inversion thereof, the two external gears being located on the side of the machine and on the side of the blade respectively.

FIG. XVI C shows the energy distribution of such an assembly.

It is believed the present invention achieves interesting objects in the field of engines, by providing post-rotative engines with reduced friction effects, and increased torque angles, a totally controlled backward effect, resulting in a significant increase in forces deployed by the engine.

It is shown that, contrary to expectations based on calculus and geometry, a double inversion of a system of forces, instead of canceling them, enhances them. Here, it is to be understood that—(−5) relates to more power that 5.

Fourth Part

Poly-Inductive Engine Generalization

In this section, it is now possible to present a generalization of poly-inductive machines, by mainly showing that the two main classes of poly-inductive machines, namely the retro-rotative machines and the post-rotative machines, whatever the supporting methods for supporting the blades as described hereinabove, on the one hand are each characterized by a specific ratio between the number of sides of the blade and that of the cylinder, and, on the other hand, the figures generated by these machines may be obtained indefinitely. The present section therefore aims at giving an overview of poly-inductive engines, both retro-rotative and post-rotative, based on a relationship between a number of sides of the driving members and a number of sides of cylindrical members, depending on a retro- or post-rotative assembling of the machines. It will be shown that a so-called side rule applies to all these engines, this rule mainly stating that the number of sides of the driving part of a retro-rotative engine be equal to the number of sides of the cylinder in which it moves minus one, while in a post-rotative engine, the number of sides of the driving part is equal to the number of sides of the cylinder in which it moves plus one.

The present section aims at showing that poly-inductive engines as described in our previous patents, may be sorted as post-inductive and retro-inductive, and then may be generalized in a unified way by the side rule. The present invention therefore shows that all poly-inductive engines may be unified by considering a relationship between the number of sides of the driving part, referred to as the blade, and that of the cylinder in which this driving part moves.

More precisely, the side rule first dictates that poly-inductive engines may be divided depending on whether they are retro-rotative or post-rotative. Then, the side rule allows to build an infinity of retro-rotative and post-rotative engines easily, by considering the precise relationship between the number of sides of the blades, and that of the cylinder in which the blades moves.

Before commenting more in length on this side rule, a few specific examples of retro-rotative and post-rotative engines will be given.

Therefore, retro-active engines may first be differentiated from post-rotative engines according to a direction of rotation of the crankshaft of the machine in relation to that of the blade.

Two examples related to our patent entitled “Poly-inductive engine” will suffice to show the difference between the two types of engines (FIG. I D). In the first case, the triangular engine is taken as an example of retro-rotative engine. This engine is retro-rotative in the extent that, according to he type of arrangement selected, master gears of the internal type are used. The movement of the blade is thus caused by a retroaction of cams that support it. However, if a different type of arrangement is selected wherein a semi-transmission reverses the movement, it is noted that the crankshaft acts in a reversed direction compared with the blade and that the gas drive on the blade also contributes to the retroaction.

In the case of post-active engines, such as for example engines of the plain blade type, the master gear used is of the external type. Therefore, the blade rotates in the same direction as the semi-transmission. When using a different type of semi0-transmission as done hereinabove, by selecting either the blade or the semi-transmission as central, the blade may be mounted on a crankshaft and the action of the blade may be slowed down by means of an induction gear coupled to an internal gear of the blade. A reduction gear instead of an inversion gear is then used in the side of the engine. The blade thus rotates in the same direction as the crankshaft, although at a different rate, which defines a post-rotative machine.

The present invention enunciates the so-called side rule. This rule, while allowing to differentiate and to unify two main types of machines, also opens the way to an infinity of engines.

This geometrical rule reads as follows: any retro-active engine comprises a number of sides of a driving part thereof equal to that of the cylinder in which this part rotates plus one (FIG. II D). From that, an infinity of retro-active engines may be built, as shown in the figure, wherein the blade always has a number of sides inferior by one unit to the number of sides of thew cylinder in which it is located. For example, a blade with two sides behaves retroactively in a three-sided cylinder, in a so-called triangular engine A. In B a blade having three sides rotates in a four-sided cylinder. In C a blade having four sides rotates in a five-sided cylinder. And so on, a six-sided blade may be used in a seven-sided cylinder, or a seven-sided blade in an eight-sided blade.

A second aspect of the side rule allows characterizing the post-rotative engines as having a driving part of a number of sides equal to that of the cylinder in which it rotates plus one (FIG. III D).

Obviously, since sides are obtained as a result of groups of gears, it is to be understood that when referring to sides, curved sides folded to connect are envisioned.

As shown in the figure, a infinite variety of retro-rotative engine may thus be build by using a blade with a number of sides always greater by one unit to that of the cylinder in which it rotates. For example, a blade with two sides will be selected in a one-sided cylinder, a four-sided blade in a three-sided cylinder, and so on, a six-sided blade in a five-sided cylinder, a seven-sided blade in a six-sided cylinder.

In FIG. IV D, the application of the side rule is illustrated in relation to tw0 different shapes of three-sided blades. In a retro-rotative configuration, the cylinder will be four-sided, whereas in a post-rotative configuration, it will be two-sided.

In FIG. V D, two types of engines having a three-sided cylinder are illustrated. In this example, the blade of the retro-rotative engine is two-sided, whereas in the post-rotative engine it is four-sided. As an important practical tool, the side rule therefore allows, for example in the present example of a four-sided blade, to design a post-rotative engine very easily with a two-step circulation of the gases, the blade acting as a valve, the same sides able to be used only for gas inlet and the complementary sides only for explosion.

Obviously, the gears are to be calibrated correspondingly. In a post-rotative engine, the master gear will be larger than the induction gear in the same ratio as the number of sides of the cylinder. In a retro-rotative engine, the number of sides of the cylinder will correspond to the size of the internal gear divided by that of the induction gear (FIG. VI D).

Therefore, a machine provided with a two-sided blade works in an environment comprising a single arc. A machine which blade is three-sided works in an environment having two arcs. A machine which blade is four-sided is matched with a cylinder having three sides, and so on. It may eve be extrapolated that a blade with no side creates an environment with a single side, i.e. a lie. Such a limit will give way to the rectilinear reciprocating engine.

First, a retroactive two-sided blade or a post-active four-sided blade is enclosed in a three-sided cylinder, therefore in a triangular engine. Similarly, two machines, one of which is retro-active and the other one is post-active, which have for example three-sided blades, both operate in totally different environment, namely a four-sided cylinder in the retro-active case, and a two side cylinder in the post-active case.

Limit cases are to be noted, wherein ideally the blade reduces to a retroactive line in a one-sided cylinder, or a two-sided blade rotating in a sphere having a single arc in the post-active machine (FIG. IVD).

Obviously, since the blades are connected to a number of gears, the movement therefor is not rectilinear. Therefore, the term “side really refers to arcs, which may be more or less curved, from one arc to a circle in the extreme limit cases.

As a summary, two main types of machines are identified by using the side rule, as being retro- or post-rotative.

From a mechanical point of view, it is to be noted that gears are selected in order to correspond to these actions. Generally, for retro-active machines, the ration of the size of the induction gears by that of the master gear will correspond to one divided by the number of sides of the cylinder. For example, in a retro-active triangular engine, where therefore the cylinder has three sides, the induction gears size versus the master gear size is in a ration of one over 3.

Part V

Complementary Poly-Inductive Supporting Means Applicable to Poly-Turbines

In this section, new poly-inductive mechanical assemblies will be presented, which allow an improved support of the pieces of poly-inductive machines of the poly-turbine type. As for machine of the simple blade type, the retro-rotative aspect of these machines will be developed, in order not only to increase the torque but also to invert the angle of attack of the lift of the blades on the assembly, thereby achieving a desirable object in so far as engines are concerned, namely to cancel a between cycle time thereof by allowing a maximal compression time for explosion, allowing simultaneously a mechanical angle providing an efficient torque.

As already mentioned hereinabove, and also s already demonstrated, achieving a new engine assembly usually takes several steps before a final achievement. First, a primary operating way of the pieces is to be determined, which make an engine assembly. Then, the more adequate mechanical pieces and arrangement thereof are to be determined for a smooth operation of the engine and a proper lubrication thereof.

Thereafter, when possible, a further step is to try and simplify this assembly while maintaining its power as expected from the beginning with the primary geometrical considerations.

Significant examples of such a process are our conversion of two step engines into anti-discharge engines, thereby providing simple gas engines able to replace four step engines. A second example is post-rotative engines built in a retro-rotative way, which, while maintaining the geometrical shape of the movement, allows an increased power.

The present invention will therefore present a similar process for achieving even more reliable anti-discharge poly-turbines.

Before that, and with purpose of better explaining the invention, the basic shape of the turbines will be first described, together with comments on fabrication thereof, which will make clearer the path of work.

FIG. I E illustrates the basic shape of the turbines, as well as a couple of basic mechanical configurations allowing supporting the pieces according to either they are connected by side points of the blades or by their extremities.

As will be shown hereinafter (FIG. II E), these assemblies would be improved by using flexible blades, as described in a patent application related thereto. Indeed, as illustrated in this figure, the rhomboid shape described by the blades must go through the shape of a square before returning to a rhomboid and so on.

However, in the present example, gears used do not allow such a transition between rectangle shapes and rhomboid shapes, if non-no-locking fastening points are used.

As far as the second assembly is concerned, it allows to reproduce the square shape drawn by the extremities of the blade over time, which does not look like a square from the outside but like a series of arcs of circle accelerating and decelerating.

This assembly therefore also needs improving before being simplified.

A first method for solving the problem related to using post-rotative semi-transmissions and for correcting, without resorting to flexible blades, the support of the blade structure, involves a different set up of the blade support. Here, the fastening location of the blades will be selected as a function of their angle and not of their shape. The blades will be fastened to two idler connecting rods in such a way that when the gear structure describes a rectangle the blade structure is a rhomboid, and when the gear structure is in a rhomboid, an angle of 90° thereof allows connecting to the square shape of the blade structure.

In another method IV E, the shape described by the extremities of the blades is considered more that of a rhomboid, and consequently the poly-induction to be generated is to be able to create a rhomboid instead of a square.

FIG. V E shows that from the point of view of an exterior observer rotating at a rate of 0.5 that of the blade structure, instead of from the point of view of an exterior stationary observer, the steady formation of a rhomboid corresponds to the formation of a square as time goes. Indeed, the squared described by the extremities of the blades only appears as such to an observer, which, looking at the rotating blade structure, is himself rotating at a speed twice as low as that of the blade structure, as illustrated in FIG. V.

Knowing that, it will be easier to set up poly-inductive assemblies able to describe a rhomboid as seen from the exterior stationary observer. As seen in FIG. VII E, it suffices to se the induction gear in action in a supporting gear of the internal type, this supporting gear being rotating as wanted as seen from the exterior observer's view point. Thus the rhomboid required will be described and the poly-turbine will be fully operative.

In this way, a valuable deconstructing force will be obtained for each solution (FIG. VIII E).

Therefore, until now, the mechanical suspension system of the blade structure has been improved by providing configurations corresponding to the successive figures the blades describe.

It is to be noted that in both cases, the blades are supported by their center, which causes that during the explosion, as in the majority of engines, a so-called between cycle time occurs, during which the engine has no steady torque.

The advantage of the blade arrangement of the poly-turbine is significant, whereby the structure is mechanically controlled as far as its flexibility is concerned, since it is possible to support at least two of the complementary fastening points thereof (FIG. IX E).

In these two alternatives, the negative torque will be compensated by the flattening mechanical tendency of the structure that acts in tension, which results in a positive torque. In the second case, a great torque is created since, it is created by the tensile forces, and moreover at least for 45% thereof after the between cycle time, right at the time of the maximal compression.

The following methods to be described thereafter will then aim at optimizing such procedure by providing supporting structures that activate the blade structure in such a fashion.

A first method uses a corner supporting means for the blade by way of a connecting rod submitted to a combined action of a crankshaft and of a directional-supporting member of the blade rotating in a reverse direction.

A following method will yield the same results as above by using gears of the external type in order to cancel the directional supporting member of the blade, which is submitted to useless friction.

A further method will take advantage of this geometry by providing a supporting member for the blade comprising a connecting rod rigidly connected to an induction gear nested into a supporting gear of the internal type (FIG. XIV). Such a method interestingly allows to reduce the number f pieces to a minimum, as well as to yield a desirable torque as mentioned hereinabove, to activate the crankshaft with a lever effect due to the fact that the structure is retro-rotative (FIG. XVI E).

FIG. XVII E illustrates how to sue the machine as a conventional two-step type, or else, providing two structures, as an anti-discharge type.

Part VI

Poly-Inductive Machines of the Differential Semi-Turbines Type

This last section will show how to use a plurality of coordinated poly-inductive systems to take advantage of the differences in torque ratios thus created for producing specific poly-inductive machines, referred to hereinafter as differential semi-turbines. More precisely, this section will show it is possible to build a engine which, instead of harnessing energy produced between the blades and the cylinder thereof, generates energy by using one of them as a support blade on which the second blade will acquire its dynamic thrust. Since these two pieces re rotating with non-constant speed, during their rotation, closest approach positions and spacing positions occur between them, which generate expansions and compressions of gases necessary to explosions. The blades will be fitted with driving means such as connecting rod journals or induction cams, so as to yield differential fluctuations in torque and counter torque. The blades will be mounted in such a way as to harness the differential energy of these systems so as to activate the rotation. This action is all the more efficient as the thrust is generated in the direction of rotation of the engine, which ensures a maximal torque.

In the field of internal engines, two main types of engines are identified according to a rectilinear action thereof, as in reciprocating engines, or a semi-rotative action thereof, as in rotative engines or in triangle engines as described hereinabove or quasi turbine engines.

In both types, the decrease and increase of the combustion chambers always result from a geometrical irregularity of the movement of the driving pieces across cylinders of a variety of shapes. These geometrical variations cause not only the expansions, but they also create a support for the thrust for the driving pieces. For example, the piston, through the gases, activates the crankshaft while being supported by the cylinder head.

Similarly, in triangle engines, either anti- or post-rotative, as well as in the present semi-turbines, the action of the blades takes place by means of the support provided by the surface of the cylinder, which entails that there would not be any driving force without an irregular-shaped cylinder.

The present invention aims at showing how to obtain such thrust effects, mainly, and even strictly, through the movement of the driving pieces one against the other, while the cylinder may contribute, in a passive way, to the building of the compression without taking part to the generation of the torque due to the thrust. It may even be contemplated that the engine be operated without the need of a cylinder.

Therefore, it will be possible to build a turbine in a perfectly circular cylinder, which is currently impossible in the field of engines as conceived nowadays. Moreover, it will be possible to generate a thrust in the direction of the system, which is of a great interest. Hence, a number of features will be achieved, which will be discussed more precisely hereinafter, such as, for example, a significant reduction of energy losses due to accelerations/decelerations outside the rotating system. The unbalance resulting usually from the movement of the pieces in the engines as already described hereinabove will thus be almost completely avoided. Finally, the turbine will be able to be mounted without a need for usually required valves, and will even be able to be mounted in a two-step manner, or in an anti-discharge manner.

More precisely, in the present invention, the expansion and reduction of the combustion chambers will be caused by the closest approach positions and spacing positions of the blades occurring during time in a cylinder having a cylindrical shape. The movement of these blades is a combination of a proper alternating movement thereof with a circular movement of the overall system. That is the reason why, without regard to time, the resulting movement of the blades may be seen as quasi-circular.

In the present invention, the use of a poly-inductive system is implied, as in the previous inventions of the same inventors dealing with semi-transmittive engines or to poly-induction or to the quasi-turbine type. Indeed, it is believed that there is a infinite number of random shapes possible for the cylinders, and that among them only a few, rather limited in number, allow supporting the pieces without a support provided by the cylinder itself. As mentioned hereinabove, engines whose supporting pieces are supported by the cylinder tend to. suffer engine burnouts. This method presented, which may suffice to non-ideal shapes is, as already mentioned, also satisfactory in commercial applications since it generates too such friction and detonation in non-lubricated strategic locations of the engine. Introducing poly-induction not only allows favoring ideal cylinder shapes but also, in a second step, to generalize these shapes.

Before showing more precisely how to build such poly-inductive system in such a way as to yield the effects described above, how to create a mechanical dynamical supporting means for the second blade during the thrust in such system will be explained.

Before that, it is to be precised that since the present invention comprises specific embodiments, but that embodiments of previous inventions are partly used, the same terminology as previously used in relation to these previous invention will be used herein so as to avoid unnecessary new technical jargon.

In a preliminary set up (FIG. I F), a gear, referred to hereinafter as a supporting gear, which is perforated in its center so as to accommodate a central axis of a crankshaft, is rigidly mounted in the side of the machine.

The crankshaft is rotately mounted in the supporting gear, which is perforated in its center for that purpose as mentioned above, in the body of the machine. On the connecting rod of this crankshaft, a gear, referred to as the induction gear, is rotataly mounted so as to be coupled to the supporting gear. Therefore, the rotation of the crankshaft about its axis causes rotation of the induction gear in the same direction. A connecting rod or a cam, rigidly mounted on the induction gear, is also assumed.

Such a set up will be commented on more precisely later. As for now, it is to be noted hat the pieces have been purposely illustrated in order to demonstrate that the dynamical support, which will later allow to generate an autonomous thrust without any active contribution from the surface of the cylinder, is obtained.

It will be apparent that a thrust on the connecting rod or on the cam of the induction gear causes the rotation thereof. It will be further apparent that this rotation automatically causes, seeing the set up of the pieces, a movement and a thrust of the connecting rod of the crankshaft in an opposite direction, which results in a mechanical contradiction. Indeed, it is then noted that the higher the thrust gets on the connecting rod of the induction gear, the higher the thrust on the connecting rod of the main crankshaft automatically gets in an opposite direction. The initial thrust force therefore automatically creates a superior counteracting force that uses the crankshaft as a lever.

Such a contradiction may become a nuisance. Certain engines only partly display this type of contradiction, which causes them to slow down.

On the contrary, in the present method, such mechanical locking effects are not an inconvenience, but re used as a dynamical support.

In the present invention, these types of gears will therefore be connected to blades, which, under the action of the explosion, will be able to act directly one against the other since one will be temporarily in a dynamic position while the other will be simultaneously temporarily in a locked position (FIG. III F).

The coming close and getting apart movements of these pieces will be driven by the variable speeds of the semi-transmission or of the poly-inductive mechanisms to which they will be connected. Indeed, the action of the blade on the cam B, by forcing it to open, will be stronger even if the blade exerts a superior lever force on the cam A since, as already explained, this latter force is cancelled. Therefore the engine will be activated by the differential resulting forces on the crankshaft, hence the designation as a differential engine (FIG. VII).

It is to be noted that the movement toward the spacing position of the blades will automatically induce a movement towards the closest approach positions on the opposite reciprocal sides thereof.

In summary, the pieces will be rotating in a perfectly circular cylinder, their movements toward the spacing position and toward the closest approach position will be induces by the difference in their irregular rotation speeds and by the respective torque that generate these. The force will be the result of a first system in a dynamic position supported by a second system temporarily in a locked position, which is referred to as a dynamical contradiction.

In a first embodiment of the present invention (FIG. IV F), two complementary pieces are nested one in the other by their center, and one of which is fitted with or mounted on a central axis of rotation located rotataly in the body of the machine. Both pieces, referred to as the blades of the machine, will be positioned at the same time in the circular-shaped cylinder of the machine. Since they are nested one in the other and directly or indirectly rotataly mounted about a central axis, these pieces will have, when discarding the time factor and considering only the geometrical aspect, a circular movement and will rotate in the same direction.

However, such nesting of the pieces will also allow them to oscillate, in addition to their rotating movement, thereby allowing the successive push out, pull in actions of one versus the other. While rotating, the blades, by means of an auxiliary mechanical mechanism, will be in turn contrarily submitted to accelerations and decelerations. Such opposite alternating movements will induce an alternating push out and pull in of the blades, thereby creating, together with the surface of the cylinder, efficient combustion chambers.

Assuming that one of the blades decelerates while the complementary blade accelerates, and that, in a second part of the rotation, inversely the first blade accelerates and the complementary blade decelerates, then, during the rotation, there will be a push in push out actions between the blades, which will trigger expansions and reductions of the combustion chambers necessary to the explosion in an engine.

Nonetheless, to achieve such a result, the above mechanical system is to be completed with a semi-transmission of the poly-inductive type.

Each blade will therefore be fitted with preferably a pair of sliding joints, one on each side of a center thereof. It is to be noted that the system would be also efficient with a single sliding joint as a fastening means. Each one of these sliding joints will be engaged in an induction cam of the poly-inductive semi-transmission. A poly-inductive semi-transmission of the bridge type will be advantageously selected. To achieve the foregoing, a master gear will be rigidly mounted on the side of the engine. A supporting membrane rigidly related to the central axis, will be rigidly fitted with four rods supporting the induction gears.

An induction gear fitted with a cam will be rotataly mounted one each one of the rods supporting the induction gears. Then the blades, still pulled on the central axis and nested one in the other, will be coupled to their respective cams by means of their respective sliding joint. An extra wall, well supported by a bush located behind the master or the supporting gear, may then be fastened to the rods supporting the induction gears. Dedicated bushes, provided with a flat surface, may be used to lessen wearout of the sliding joints of the blades.

Under the effect of the explosion, the thrust of the blades one against the other will cause a thrust on the cams. As the cams get in an opposite action whereby one opens itself towards the outside of the system while the other turns inward of the system, the torque obtained are different, which allow to differentially produce a favorable torque, by making use, even while in a dynamical state, of one of the two systems as a supporting means.

In this first embodiment, the gears are initially mounted on the master gear in such a way that the blades always come to a maximum reduction when passing in front of the igniter plug (FIG. V F).

However, such a set up results in a loss of part of the explosion strength before the supporting gear efficiently gets into a locking position.

Three solutions may be thought of then. First, using three blades (FIG. VII F), nested one to the other and connected to the crankshaft and the cams as previously, will improve the angle of attack, providing the point of minimal distance between the blades is kept at a constant location.

A second solution (FIG. XIX F) will maintain only two blades. However, in this case, the gears will be mounted as follows: first, two gears will be positioned at their more remote (or closest) distance, parallel to two complementary gears. Then the system will be set to rotate until the next position of the gear and so on for the last gear.

Hence, in this case with a strong initial torque, the consecutive coming close of the blades will occur at one height of a cycle (FIG. X F), against the rotation of the engine. Such a solution will allow firing the gases of the next explosion from the spark of the previous one, provided the system rotates fast enough. Moreover such a set up allow improved obtaining locking and thrust angle, while maintaining a limited number of pieces.

A third solution uses an internal gear connected to the system and engaged into a restoring gear. This solution allows that the closing of the blades always occurs at the same location, which enables to use only a single igniter plug (FIG. XI F).

It is to be noted that the previous description is valid even with an unlimited number of blades. Similarly, for a given blade, the ratios of the diameter of the induction gears to that of the supporting gear may be adapted so that the blades are submitted to a plurality of alternating movements per cycle. Whereas this would be much more complicated in irregular cylinders, even perhaps impossible, this is easily achieved due to the fact that the blades move in a circular-shaped cylinder.

In that respect, it is to be noted that, as will be shown hereinafter, if a different type of master gear is used for each blade system, then, the differentiality ratio will be increased. The force generated by the thrust may thus be increased while that required for the anti-slip decreased. Indeed, it is possible to take advantage of the mechanical contradiction effect, which creates a dynamical anti-slip that may support the advance of the other pieces.

It will be possible to control the distance between the blades using other more mechanical methods, for example, by using a cross-shaped central cam, or else by using an external cam submitted to a vertical thrust (FIG. XII F).

An optional embodiment, wherein the cylinder is not circular, may also benefit from the dynamical contradiction effect already described. As shown in FIG. XIV F, the sliding joint is then located at the level of the connection to the center, and the cam is rotataly connected. Therefore, the extremity of the blade describes the figure of eight. It will be shown later on that a pad may be attached to the blade in order to provide gas inlets different from the gas burning points. Similarly, it will be shown that the blades may have a non-crossed configuration, thereby creating combustion chambers separate from burning chambers.

In FIG. XV F, the blade is related to two successive cams instead of being connected to two opposite cams. The blade is rotataly connected to a cam, the sliding joint thereof corresponding to the second cam, thereby creating a similar effect with a sizable lever strength. However the shape of the cylinder thus generated by the connecting rod is more complicated.

FIG. XVI F illustrates an embodiment wherein a internal type supporting gear is used instead to achieve the locking effect, the other blade then activated by a lever effect, which results in an increased power if the engine by an increase of the force required by the dynamic and a decrease of the force required for the locking.

FIG. XVIII F interestingly shows how to obtain a differential force while connecting both blades together, the respective cams of each blade being of a different size. For an equal thrust on both blades, even when neglecting the locking effects already discussed, a differential torque will be produced, which will drive the system in a determined direction. The force produced between both blades will be higher on one of them than on the other, which will cause a deconstruction of the system mainly on one side.

The gas inlet (FIG. XX F) in an engine of the standard two-steps type may be achieved by the blades in the region or the closest position thereof where there is a torque loss, the other parts thereof being improved.

In the construction of anti-discharge engines (FIG. XIX F), a three-blade system, a couple of complementary systems or a two-blade system may be used, but in the case of a two-blade system the blades are transversally partitioned or partitioned in a step-like manner, since the suction chambers must be dilated to a maximum thereof, at the same time as the combustion chambers. The gases may also be suctioned from pad chambers, or else from desinjectors. An alternative solution of a perennial depression chamber may also be applied. Moreover, the partitioning of the blades, transversally or in a step-like manner, which is possible due to the circular shape of the system, may allow to start only given parts of the engine when a higher yield is not desired. A passive system may be turned into such a mechanism providing reduced energy.

Such machines may be used as pumps, engines, etc. In the cases of pumps, the power of the crankshaft on the blades may be increased by using internal type supporting gear.

Last, it will be noted that the coming close-getting apart may be produced a several during one cycle for each blade by modifying the gear ratios, which will yield a plurality of explosions by rotation of a blade. However, each coming close-getting apart will have a weaker amplitude. It may be possible, for example, to conceive an engine comprising a dozen blades, each one producing a number of push ins push outs, and thereby an engine with 500 explosions by cycle, almost a turbine. Such an engine, smoothly mounted as shown hereinbefore, would very powerful compared to its energy losses and would be of great interest on boats, helicopters, non-supersonic planes.

The machine may further be built in such a way as to benefit even more efficiently from the mechanical locking and attack points ,by modifying the angle of the sliding joint (FIG. XII F). It is to be noted that excess in such a modification will orient the thrust of the explosion outward from the system. Therefore, a balance of the system is to be sought to achieve a compromise.

Lastly, it is to be noted that the machine may be built in such a way as to provide steps of different height between the blades in the step-like partitioning thereof (FIG. XIX F).

Hence, standard two-steps or anti-discharge engines may be produced, for each part of the blade.

The differential engine distinguishes itself mainly by the fact that due to the contradiction and the dynamical and mechanical anti-sliding, the support may be provided, even in a rotating system, between a piece and a second piece, namely between an active piece and a piece located in a stop position. Such a feature makes possible the use of a perfectly circular cylinder, since the cylinder in this case only acts passively to maintain the compression of the gases.

The present turbine is therefore believed to be an achievement in the field of engines, since it successfully provides a thrust in the very direction of rotation of the engine, by dividing and reducing by two the between cycle time of the engine, and by allowing a movement caused by internal gears, which when correctly activated, produce lever forces. This turbine also achieves an ideal of reduction of accelerations and decelerations out of systems requiring energy. Moreover, it may be built in. an anti-discharge manner, therefore in a clean manner. Such a turbine also achieves an ideal ration weight/power, by delivering a huge amount of power while being of a reduced size. Lastly, the complementary double action of the crankshafts, which describes a figure of the infinite symbol, which has been sought for a long time in the field of engines, embodies an almost philosophical achievement.

Also, the present turbine achieves both smoothness and speed. Although its speed will be lower than that of an open turbine, it will be far higher than that of conventional engines, either reciprocating engines or anti- or post-rotative engines.

### BRIEF DESCRIPTION OF THE FIGURES

Part A

FIG. I A illustrates a number of examples of poly-induction engines. The unbalance due to the fact that the gear means are located only on one side of the blade may be seen;

FIG. II A is a transverse view of a semi-transmission, showing the location lacking supporting means and therefore subject to wearout;

FIG. III A illustrates a first embodiment, rather difficult to achieve, using two interconnected complementary systems;

FIG. IV A illustrates an incomplete embodiment of a bridge-type semi-transmission, comprising only the bridge; a central axis is going across the bridge, which is well supported on each side thereof by means of pads. Moreover, an additional pad may be provided on the side of the bridge supported by the side of the motor;

FIG. V A illustrates improvements of the induction gears, which will yield same power and geometrical effects;

FIG. VI A illustrates a more complete embodiment of the bridge-type semi-transmission, with the first gears shown, namely the central gear and the induction gears. The induction gears are rigidly connected to cams that drive connecting rods, blades or parts of the core of the semi-turbines or else other driving parts selected according to whether a reciprocating engine, or an anti- or a post-rotative engine, or a quasi-turbine or a differential induction turbine is being built.

FIG. VII A illustrates a design of the semi-transmission nested in the blade itself;

FIG. XVIII A illustrates a semi-transmission that leaves the axis disengaged. The central axis stopping at this point, a second supporting means is provided on a neck located behind the supporting gear. An additional arm may be indirectly connected, through a neck of a blade, to a connecting rod journal of a crankshaft mechanically delivering the energy outwards;

FIG. XIX A illustrates a first use of this type of bridge semi-transmission in a rectilinear reciprocating engine; here, the stroke of the cam is defined so as to be exactly of the same length as that of the master crankshaft. The cam is connected to a connecting rod fitted at each end thereof with a piston. Therefore, as shown previously, a semi-transmittive reciprocating engine is obtained, which is properly supported;

FIG. X A illustrates the same features in a retro-rotative semi-transmission, which allow building, in a very balanced way, a triangular engine. The master gear is of the internal type.

The blade is rigidly connected to the induction gear, and at the same time mounted about the supporting axis of the bridge. The induction gear is coupled to an internal type supporting gear located in the side of the engine.

Part B

FIG. I B illustrates a first embodiment of a poly-inductive triangular engine, using two induction gears working together to activate the blade. Such an embodiment has already been used and discussed in previous works related to poly-induction.

FIG. II B shows that by using an inversion semi-transmission, retro-rotative engines may be built with two inductions, here induced by their center, namely an eccentric member and a central internal gear. The Figure also shows that the retro-rotative characteristics are achieved, including the complete use of the blade surface and the lever effect due to the support on the induction gear.

FIG. III B is a flowchart of the forces occurring during the rotative way down of the blade.

FIG. IV B is a three-dimensional view of the previous embodiment.

FIG. V B illustrates this embodiment, showing that it is fully endowed with characteristics of retro-rotative engines, since from this, an infinity of engines may be built, providing a gauging of the gears corresponding to the number of sides of the blades and to the sides of the desired cylinder.

FIG. VI B illustrates a second embodiment wherein the semi-transmission modifies both the direction of rotation of the axis and a speed thereof.

FIG. VII B shows the main drawback of the previous embodiment, which results in a deficient compression.

FIG. VIII B illustrates a new embodiment of the invention, wherein the semi-transmission elements are canceled and a differently laid up poly-induction is provided. The two dynamical points of the engine are now in the center operating the crankshaft, and the internal type induction gear, which is located on the center of the connecting rod about the connecting rod journal, is engaged with the internal supporting gear located in the side if the part. The figure also shows the desired objective of such an assembly, namely the improvement of compression. As before, it is to be noted that this embodiment maintains all the retro-active characteristics.

FIG. IX B comments on a schematic view of the forces occurring during the rotating way down of the blade.

FIG. X B shows that it is even possible to supercharge the system by using an improved design of the blades.

FIG. XI B shows that an infinite number of such engines may be built and gives an idea of the gears ratios, blade sides versus cylinder sides ratios to consider.

Part C

FIG. I C illustrates examples of poly-inductive engine, the first one being of the retro-rotative type, and the second one of the post-rotative type. In particular, it is shown that in each case, induction gears, which are inversion gears in relation to acceleration induction gears, are used.

FIG. II C shows a generalization of these engines and points out geometrical similarities and differences of each type thereof.

FIG. III C illustrates three specific embodiments of retro-rotative engines as described in a patent application dealing with the matter by the present inventor.

FIG. IV C illustrates how the forces act on the blade, and also shows that the retro-active forces may be used to participate in the positive deconstruction of the system, without energy loss, and even contribute a lever effect.

FIG. V C shows advantages of mounting a post-rotative engine in a poly-rotative way, hence its name.

FIG. VI C illustrates a current set up of mono-inductive rotative engines, which yields a very unsatisfactory use of the explosion forces having regard to the embodiment using three poly-inductive blades already commented.

FIG. VII C explains the main differences existing between retro-and post-rotative engines concerning the direction of rotation of the crankshaft in relation to that of the blade, depending on whether these are connected to inversion gears or to acceleration gears of the poly-inductive machine.

FIG. VII C shows that the retro-rotative effect may not be directly achieved in a post-rotative engine.

FIG. IX C illustrates a different way of analyzing the movement of the blade with regard to that of the crankshaft, wherein the blade movement is not considered from the point of view of an external observer but from that of an observer positioned on the crankshaft itself, and comments on consequences of such point of view.

FIG. XI C illustrates a first embodiment of a retro-rotataly mounted post-rotative engine.

FIG. XII C shows, in such an engine, there is a complete control of all thrust forces on the blade and of the deconstruction of the system.

FIG. XIII C is a perspective view of the engine of FIG. XI.

FIG. XIV C is an alternative embodiment of the present invention, using two different types of inversion in a combination, namely a semi-transmission on the one hand and a coupling between an internal gear and an external gear on the other hand.

FIG. XV C illustrates a use of an internal gear in the semi-transmission.

FIG. XVI C illustrates a combination allowing canceling the semi-transmission by using a couple of internal gears engaged on the same pivot axis located on the fitting of the crankshaft.

FIG. XVII C is a perspective view of the combination of FIG. XVI C.

FIG. XVIII C shows the energy harnessed by such a combination, which also achieves retro-rotation features.

FIG. XIX C illustrates an off-center embodiment of the present invention, which allows supercharging the system.

FIG. XX C illustrates a blade structure in the previous embodiment.

FIG. XXI C illustrates a simplified embodiment of the present invention making use of a single internal gear positioned in a single-axis manner in the system.

FIG. XXII C shows the energy distribution during expansion of such a system.

FIG. XXIII C is a perspective view of the last embodiment.

Part D

FIG. I D illustrates two embodiments of poly-inductive vane-type engines, wherein the first one is retroactive with a triangular cylinder, and the other one is rotative with a square blade. Two different poly-inductive mechanisms are used, which evidence the difference between the retro-active effect and the post-active effect.

FIG. II D shows a series of drawings illustrating the side rule applied to retro-rotative engines. In each one, the number of sides of the blade is inferior by one to that of the cylinder.

FIG. III D shows a series of drawings illustrating the side rule applied to post-rotative engines. In each one, the number of sides of the cylinder inferior by one to that of the blade.

FIG. IV D is a comparison of two types of engines for a blade with a given number of sides.

FIG. V D is a comparison of these two types of machines or engines for a cylinder having a number of sides equal to three.

FIG. VI D gives an overview of the gear ratios to be observed. Obviously, other possible embodiments for these machines are not taken into account.

FIG. VI D shows borderline cases of convergence of these two rules when, in particular, the blade, or the cylinder itself, is a line.

Part E

FIG. I E gives two schematic views of poly-turbines, comprising the two main mechanical supporting means already described herein.

FIG. II E shows the main drawbacks of these two supporting means.

FIG. III E illustrates a first embodiment avoiding the previous drawbacks by a different layout of the angles of the supporting structures in relation to the angles of the blade structure, and. moreover, by an indirect connection thereof by means of blades mounted for that purpose. As may be seen, such an embodiment allows the se of only two supporting locations.

FIG. IV E shows the geometrical difficulty to be solved for providing a support when connecting the blade structure by the angles of the triangle thereof, i. e. the difficulty involved in producing a rectangle in an already built square.

FIG. V E shows how, by changing the observation point, a rhomboid seen in steady way may be seen as a dynamical expression of a square.

FIG. VI E shows how to transfer this formal realization into a technical solution by making the supporting gear dynamical.

FIG. VII E shows schematically the forces obtained by the two present solutions.

FIG. VIII E shows that the forces produced when the pieces are supported by the edges of the blades would be weaker every second time, but much higher every second time. By dedicating the pumping function necessary to two-steps engines to the weakest way up, provided it is possible to build a poly-turbine reliably supported by these points, a very strong torque is may be obtained, with an angle of attack of 45° at the time of the maximum compression, which obviously makes this poly-turbine compared with any engines.

FIG. IX E shows a first method for building such poly-turbine. Two driving rods of the blade structure are each connected to the connecting rod journal of a crankshaft, while simultaneously being submitted to a directional support rotating in the opposite direction.

FIG. X E is a perspective view of the poly-turbine of FIG. IX.

FIG. XI E shows a first way to simplify this structure by canceling the pieces that tend more to be submitted to friction and instead using only gears means, which are in the present case of the external type.

FIG. XII E shows a geometrical way to obtain a rhomboid or a flattened oval shape, using internal gears.

FIG. XIII E shows how to further simplify this structure, based on these geometrical teachings, by building an equivalent of FIG. XII E using internal type supporting gears. Drive rods will then be rigidly mounted on induction gears coupled to an internal type gear.

FIG. XIV E is a perspective view of this last embodiment.

FIG. XV E shows the high forces generated by such an assembly.

FIG. XVI E illustrates the use of such a machine as a two-step engine, standard or anti-discharge.

FIG. XVII E illustrates three different embodiments realizing a support of the blade structure by the center or by the corners. It s understood that a rectangle may also be obtained assuming a rectilinear alternating movement, performing on a mobile base, as shown in a). b) shows a structure wherein the support of the pieces is achieved by means of different gears.

FIG. XII E shows how to complete both gears systems (with internal type supporting gear) located on each side of the turbine, by a continuous crankshaft, the centre connecting rod journal thereof providing a support for complementary positions of the blade structure.

FIG. XIX E shows how to complete both gear systems (with external type supporting gear) located on each side of the turbine, by a continuous crankshaft, the centre connecting rod journal thereof providing a support for complementary positions of the blade structure.

Part F

FIG. I F illustrates a first embodiment of a mechanical lock, this lock in turn providing a supporting point on which the dynamical blade will build its thrust.

FIG. II F shows how a connecting rod journal may be located in a stop position, by using an internal type induction gear. It will be shown hereinafter that such a method increases the power of the turbine.

FIG. III F shows a first arrangement of a group of induction gears and cams about a same supporting gear.

FIG. IV F shows how this support is achieved, between two blades provided with driving sliding joints, each one being rotataly mounted about the center, in such a way that the sliding joint be engaged in the induction cam.

FIG. V F is a perspective view of FIG. IV F.

FIG. VI F shows how the time to achieve the locking is delayed versus the time when the closest approach position of the blades occurs, which will be alleviated on the embodiments of the following figures.

FIG. VII F shows a first method for correcting this delay, by considering a three-blade assembly.

FIG. VIII F is a schematic view of the two main positions of the cams in function of the time, in a three-blade assembly.

FIG. IX F shows an assembly method allowing locating gears in a two-blade system in stop positions at the earliest possible stage.

FIG. X F is a schematic view of the positions of the gears and cams during a one cycle of the machine or engine. It may be seen that the ignition is delayed by one eight of cycle at each closest position of the blades.

FIG. XI F shows the rotation of the previous system may be cancelled by using an internal gear. This will allow, if desired, to maintain the igniter plugs and the valves at the same place.

FIG. XII F shows the cams may be mechanically forced to separate, either by means of an internal or an external cam. Such a way of doing would be of use in an application of the machine as a pump.

FIG. XIII F shows different ways of providing the blades with a sliding joint. Here, instead of being rotataly mounted in the centre and in a sliding way on the cam, they are mounted in a sliding way at he centre and rotataly on the cam. The cylinder may not be circular shaped anymore, and an eight figure is achieved in this example.

The action of the blades one on the other remains differential.

The figure obtained is that of an eight. This figure may be turned into a rectangle by adding a pad at each extremity of the blades, the pad increasing the curves in the corners.

FIG. XIV F shows a displacement of the point rotataly connecting the blade to one of the two cams. Here again, the differential action is maintained, but the dynamical point of the blade will be enhanced by a lever effect.

FIG. XVI F shows an embodiment assuming the blades are attached to two gears that are not reciprocal but consecutive, the blades being rotataly connected to a first one thereof and slidingly connected t the second one thereof.

FIG. XVII F shows that similar locks may be achieved by using supporting gears of the internal type. Here again, The force generated by the system is higher since the forces needed for locking are weaker while those required by the dynamics are increase.

FIG. XVIII F illustrates a simplified embodiment of the present invention, wherein only one of the blades is active, the other one being rigidly connected to the crankshaft. In this case, one of the blades is connected to the induction gear by a cam thereof, and connected to the other blade by a connecting rod, which is also mounted on the cam.

FIG. XVIII F shows a way to increase the differential feature of the previous embodiments. As previously, each blade is fitted with an induction gear and a cam, but here the cams are of different size. Therefore the action of the gear is increased on one of the two blades, which causes an increased differential effect. However such a method reduces the number of explosions, since the blades may only use one of their sides as an explosion surface.

FIG. XIX F shows how to partition the blades to allow an anti-discharge version of the engine. Such a partitioning may also be used to allow, in a given engine, an increment in the power. Anti-discharge engines may also be built by transversally partitioning the chambers by means of a wall.

FIG. XX F shows how the gases circulate in a standard two-step version of the engine.

FIG. XXI F shows, considering that in such an engine the passive cylinder may be substituted y a first folded blade containing a second blade, how to build an engine with a mechanical wheel. Given the almost non-limited speed of such an engine, only a clutch would be required.

### DETAILED DESCRIPTION OF THE FIGURES

Part A

FIG. I A illustrates a number of examples of poly-induction engines using poly-inductive semi-transmissions. The first example shows a triangular retroactive engine 1, a post-rotative octagonal engine 2, a rectilinear reciprocating engine 3, or a quasi-turbine. All these engines use the previously mentioned type of semi-transmission.

FIG. II A is a transverse view of the semi-transmission 4, wherein defective supporting points may be seen. It is to be noted that the thrust on the blade generates an unbalance of the support.

FIG. III A shows a first solution, which proves difficult to operate, using two interconnected complementary system.

In the present solution, a semi-transmission 4 s provided on each side, which allows a straighter support of the central connecting rod journal and if the other pieces. However, care must be taken to ensure an equal work of the two semi-transmissions by inter connecting them by means such as gears 6, by means of an axis 7 also fitted with gears.

FIG. IV A illustrates a first incomplete embodiment of a bridge-type semi-transmission, comprising only the bridge 8; a central axis 9 goes across the bridge, which is well supported on each side thereof by means of pads 10 themselves well supported on the body of the motor.

FIG. V A illustrates improvements of the induction gears, which will yield same power and geometrical effects. Here, instead of being provided with a central gear axis mounted on the fitting of the crankshaft 12 and fitted with induction gears 11. mounted on the connecting rod journal of the crankshaft 12 and fitted with a connecting rod journal 14, the induction gears 11 will be fitted with a cam 15 rotataly mounted on one of the axis 17 of the bridge.

FIG. VI A illustrates a more complete embodiment of the bridge-type semi-transmission, with the first gears added, namely the induction gear 11 and the supporting gear 17. The induction gears are rigidly connected to the cams that drive the connecting rods, blades or other parts of the core of the semi-turbine, or else other driving parts selected according to whether a reciprocating engine, or an anti- or a post-rotative engine, or a quasi-turbine or a differential induction turbine is being built; the cams will be connected to the blade 18, which will be inserted into the cylinder 19 of the engine 20.

FIG. VII A illustrates a design of the semi-transmission inserted in the blade itself. To that purpose, the support 17 has been indirectly connected by means of a rigid neck 21.

FIG. XVIII A illustrates a semi-transmission that leaves the center clear. The central axis stopping at this level, a second supporting means is provided on a neck located behind the supporting gear. For that purpose, the supporting arm 22 may be moved along the gear neck 23, before positioning the center gear. Then the supporting gear 17 may be rigidly mounted. A reverse method may be used, by mounted this arm about the neck instead. Then the same procedure applies for the second span, where the blade is to be partitioned in order to be connected. An additional arm 30 may be indirectly connected to the connecting rod journal of the crankshaft, so that by means thereof 31 the energy may be delivered outwards 32 again.

FIG. XIX A illustrates a first use of this type of bridge semi-transmission in an engine of the type wane engine with a rounded cylinder. Here, the race of the blade would prevent the central axis from going across the engine. Therefore, the type of semi-transmission as described herein s required. The blade 18 and its induction gear 11 are rotataly mounted on the connecting rod journal of the bridge in such a way as to couple the induction gear to the supporting gear 17. In so far as it is desired to transfer the energy from both sides outbound, a neck may be provided between the induction gear and the connecting rod, at what is refereed to as the neck of the connecting rod 33, to which a second crankshaft 34 may be related by a connecting rod 35.

FIG. X A illustrates the same features in a retro-rotative semi-transmission, which allow, once again, to build, in a very balanced way, a triangular engine. Here, the master gear is of the internal type. It will be noted that since no supporting gear of the external type is used herein, the center being clear, the crankshaft may extend on this side 36 without the need of the additional of the previous figure.

The blade is now rigidly connected to the induction gear, and simultaneously mounted about the supporting axis of the bridge. The induction gear is coupled to the master gear or to a supporting gear of the internal type placed in the side of the engine.

Part B

FIG. I B illustrates a first way of building a triangular engine in a poly-inductive fashion, by using two induction gears working together to activate the blade. Such an embodiment has already been used and discussed in previous works related to poly-induction.

First of all, a crankshaft 2 fitted with two connecting rods 3 related rotataly at each end thereof to gears, referred to as induction gears 4, is rotataly positioned in the side of the engine 1. These gears 4 are mounted in such a way as that each one is coupled to the supporting gear 6, which is of the internal type and rigidly positioned in the side of the engine.

Connecting rods journals 7 or cams are then rigidly fitted on these induction gears. The blade 13 is then connected to these connecting rods and also semi-rotataly mounted in the cylinder 8 of the machine. The clockwise action 9 of the crankshaft, causes the retro-action of the induction gears 10 supporting the blade 13 through their respective connecting rods, since they are also engaged to the supporting gear 6.

The size ratio of the gears being here of one over three, the blade 13 will rotate in the opposite direction 11 related to the crankshaft and will described the triangular shape of the cylinder, which is characteristic of the triangle cylinder 12.

FIG. II B shows that by using an inversion semi-transmission 14, retro-rotative engines may be built. Indeed, by using two induction gears, here induced by their center, namely an eccentric member and a central induction gear, the same shapes described by the movement of the blades may be achieved than in retro-rotative engines. This Figure also shows that the retro-rotative characteristics are achieved, including the complete use of the blade surface and the lever effect due to the support on the induction gear.

Indeed, in the present embodiment, which is illustrated herein by means of two main cross sections a and b, it is assumed that a cylinder 8 of a quasi-triangular shape 12 is provided in the body of the machine 1. Then, a free crankshaft 15, meaning that it does not directly contribute to deliver energy outwards, fitted with an eccentric member 12, is rotataly positioned in this machine. A blade 13 provided on its side with a gear of the internal type 17 is rotataly mounted on the eccentric member of this crankshaft and inserted into the cylinder. A semi-transmission 18 is then added to the engine, with the purpose of perform a similar work as that played by the induction gears in the first version, i. e. for inversion of the movement of the crankshaft. A first gear 19 of the semi-transmission will then be fastened to the part of the crankshaft extending into the semi-transmission 20.

An inversion pivot gear 21 will then be rotataly mounted in the side of the semi-transmission in such a way as to be coupled with the semi-transmittive gear of the crankshaft 19. A third semi-transmission fear 22 is also rigidly connected to an axis going across the machine and to the central axis of the crankshaft 19 along a full width thereof, thereby making the main axis 23. On the opposite side, an induction gear 24 of the blade will be rigidly fastened to this main axis.

For each gear specific size rations will be applied to yield a triangular engine. In the present case, the logic of the assembly lies in the fact that the blade is to rotate at the same rate, but in the opposite direction, than the eccentric member.

The induction gear, since it is nested into an internal gear two times larger in size, is made to rotate in the opposite direction twice as fast as the free crankshaft in order to activate the gear of the blade at the rate of that of the crankshaft. This explains why the semi-transmission not only inverses the rotation, but also multiplies the rotation rate. The machine operates as follows. When the main axis 25 of the engine rotates, it automatically drives along the induction gears 22 and the semi-transmission gears 22 to which it is rigidly connected.

The induction gear in turn drives the blade 13 in the same direction 28. Meanwhile, the pivot gear 21 inverses the rotation of the gear of the axis and causes the gear of the semi-transmission of the free crankshaft and its eccentric member to rotate in a direction opposite that of the blade 29.

The blade, which is submitted to these varied actions, will have described, after a rotation of the crankshaft, the desired triangular shape.

FIG. III B illustrates the above-described system while in a way down phase. On the one hand, it can be seen how the thrust on the blade will be all transferred to the main axis directly through a pressure on the induction gear 30 to which it is rigidly connected. On the other hand, the free crankshaft being submitted to an opposite thrust, and besides from the opposite part of the blade 31, will drive the gears of the semi-transmission in such a way that this force will be reestablished in the right direction, which is the direction of the initial rotation of the central axis 3. The retro-rotative forces will thus be controlled into contributing, even in a larger part, to the rotative forces.

FIG. IV B is a perspective view of the previous embodiment, showing the features already discussed.

FIG. V B shows that this embodiment fully achieves the properties of retro-rotative engines since an infinity of engines may be built based therefrom, providing off course that the gear ratios are observed in connection to the number of sides of the blades and to that desired the cylinder. However the gears are to be modified to allow the free crankshaft to finalize the action of the blade. In an embodiment comprising a triangular blade for example, the free crankshaft is to complete a quarter active rotation 33 while the blade completes ⅛th of a retroactive rotation. In an embodiment wherein the blade is four-sided, the free crankshaft is to complete a 60° active rotation 35 for the blade 30. 36

FIG. VI B illustrates a second way of achieving an inversion, multiplying semi-transmission. The two examples displayed herein are believed to be sufficient to illustrate the requirements to be met to build retro-rotative engine.

It will here be assumed that the axis of the free crankshaft ends with a gear of the internal semi-transmission type 100, which rotates clockwise 101 for example, while the semi-transmission gear of the central axis will end by an external type gear 103. Both semi-transmission gears will be indirectly interconnected since both will be coupled to an inversion-multiplication pivot gear 107. Hence, the pivot gear will be made to rotate in the same direction as the axis of the crankshaft 105 and will invert the direction of the central axis 106 while simultaneously multiplying it.

FIG. VII B shows the main drawback of the previous embodiment, which results in a deficient compression. Indeed, a yield ratio of 1 for 3.5 is observed 37.

In order to correct the shape of the cylinder, a target would be on the one hand that the blade reach deeper into the side of the cylinder during the compression 38, and on the other hand that the side of the cylinder be less doming 38b, i. e. maintained in a closer contact with the blade.

FIG. VIII B illustrates a new embodiment of the invention, wherein the semi-transmission elements are canceled and a poly-induction is provided with the aim of achieving the previously mentioned objectives.

In this embodiment, a crankshaft 40 is fitted with a standard connecting rod journal instead of an eccentric member. The blade 13 is rotataly positioned on this connecting rod journal 40b, together with the induction gear 14 that is fitted thereto. The type of assembly for connecting either the crankshaft or the blade and its gear is not considered here. The induction gear is then coupled to a supporting gear of the internal type 6, which is here 3 times larger in size, and located in the side of the machine 1.

As shown in FIG. IX B this machine operates as an engine as follows. During the explosion, as in almost any engine, a between cycle time occurs. Indeed, since the induction gear 14 and the crankshaft 40 are centered, the thrust is equally distributed on the blade. However an important aspect to investigate is what happens during the deconstruction of the system.

In this assembly, since it s a retro-rotative engine, even the back effect of the blade is, as may be seen, dynamical. The front effect, here on the crankshaft, drives the crankshaft into a direct rotation 41. The back effect is enhance by a lever effect, since the blade 13 is connected to the internal supporting gear 6 through the induction gear 11, which is rigidly connected to the blade, and pushes like a lever on the connecting rod journal 7 of the crankshaft, thereby forcing it also, in an additive way, to move down.

This makes the engine very powerful. Compared to rotative engines for example, there is an added energy and added thrust instead of a decrease. Obviously, as previously, depending on the selected gear ratio, the number of sides of the blade and of the cylinder will have to be adjusted.

In the case of a gear ratio of one over four, a triangular blade acting in a four-sided cylinder will be selected. In the case of a gear ratio of one over five, a square blade will be selected for a five-sided cylinder, and so on.

Finally, it will be noted that the target of obtaining an increase in the compression ratio is achieved since the blade still has an eccentric member connected to the connecting rod journal of a crankshaft. Therefore, the blade, as previously mentioned, is allowed to move further from the flat regions during the explosion and deeper in the corners between two explosions.

This figure therefore illustrates the desired result of such an embodiment, namely the improved compression. As previously, it will be shown that the retroactive characteristics are maintained in such an embodiment.

FIG. X B shows that it is even possible to supercharge this system by using an improved design 200 of the blades. Indeed, in a limit case of the last method, the blades will be allowed to move so far into the cylinder that they will have to be shaped in a manner more adapted to the curvature of the cylinder, which is itself a result of the path of the extremities of the blade.

FIG. XI B shows that an infinite number of such engines may be built.

Part C

FIG. I C illustrates examples of poly-inductive engines, the first one being of the retro-rotative type, and the second one of the post-rotative type. In particular, it is shown that in each case, induction gears, which are inversion gears in relation to acceleration induction gears, are used.

In these figures, a crankshaft 1 provided with two opposite fittings 2 is rotataly mounted in the body of the machine 3. A gear referred to as a supporting gear is positioned in the side of the machine. The first supporting gear 4a is of the internal type, while the second 4b is of the external type. Gears referred to as induction gears 5 are connected to each end of the fittings of the crankshaft in such a way as to be coupled to the supporting gears.

The induction gears 5 are provided with connecting rods 6 or cams, to which the blade 7 is connected.

In FIG. II C is illustrated a generalization of these engines, which points out geometrical similarities and differences of these two categories. As previously described in a patent application dealing with the matter by the present inventor, two infinite series of engines may be built following the side rule, which states that in any retro-rotative poly-rotative engine, the number of sides of the blades is inferior by one to that of the cylinder 7, while in post-rotative engines, the number of sides of the blades is greater by one to that of the cylinder 8.

FIG. III C illustrates three specific ways of building retro-rotative engines as described in a patent application dealing with the matter by the present inventor entitled “Semi-transmittive assembly of semi-transmittive induction engine”. One of these 9 is equivalent to what has been previously described. The other solutions use a semi-transmission 10, and a retroactive direct off-center assembly 11 respectively.

FIG. IV C illustrates how the forces act on the entire blade, for example in the second figure above, since the retroactive forces are successfully monitored into contributing to the positive deconstruction of the system, without energy loss, and even with a lever effect. Indeed, it may be seen hat the forces on the blade directly cause on the left handside 12 the crankshaft 1 to move downward 13, while these same forces simultaneously act on the induction gear coupled to the blade gear 14 and make it rotate to the right 15, in a direction opposite that of the crankshaft. This movement in turn is inverted by the semi-transmission, as is well understood by now, and further transferred in the right direction to the crankshaft 1. Therefore, the crankshaft is submitted to an addition of the forces 16.

FIG. V C shows advantages of mounting a post-rotative engine in a poly-rotative way, hence its name. Although not as powerful as retro-rotative engines, the resulting engine has however the ability to cancel the retro-rotation effects, even without controlling these effects.

Indeed, during the way down, the thrust 17 on the connecting rod of the induction gear 5 is automatically compensated by a counter-thrust 18 of the connecting rod journal of the crankshaft 1. The entire thrust 19 on the back part of the blade oaf the blade. Moreover, the thrust of this part acts on a connecting rod journal which torque is increase due to its off-center position and its outbound acceleration 21. Consequently, this engine is more powerful than a rotative, simple dynamical induction engine for example, as will be apparent in the following figure.

FIG. VI C shows that the current set up of rotative engines yields a very unsatisfactory use of the explosion forces having regard to the embodiment using three poly-inductive blades already commented.

Indeed, a first drawback of this type of engine is that the thrust on the back part of the triangle blade of the engine 22 generates a counter-thrust on the, which opposes the rotation of the engine. Thus, not only almost one third of the energy is lost, but more than the second third and a half of the central part of the blade 24 is wasted, seeing the additional lever effect that has to be compensated in order to cancel the back pressure. Therefore, only as little as 25% of the energy remains positively available from an initial energy, which is, as will be shown later, already reduced. For this remaining quarter, there is only a weak torque 25, since the side of the blade tends to follow, although at a reduced rate, the movement of the crankshaft. In a reciprocating engine for example, a way down of the connecting rod journal of the crankshaft at 60° as in the present case already causes an angle with the connecting rod of about 90° (27). Here, for a similar down angle of the crankshaft 28, the angle is of only 30°. It is to be noted however that the blade has to force the crankshaft into moving down faster that it does itself, which automatically deconstruct [?] the engine, but in a bad way. Finally, it must be noted that the crankshaft moves in a wedging like manner 31, which very remotely causes a friction at the back thereof 32. Considering all these features, it is easily understood that not more than 20% of the explosion force is recovered in such type of engines, and that the efforts spent on the turbo-compressor are also simultaneous efforts to slow it down, since an explosive power is created which needs unfortunately be dissipated in the most part thereof.

FIG. VII C explains the main differences existing between retro- and post-rotative engines concerning the direction of rotation of the crankshaft in relation to that of the blade, depending on whether these are connected to the inversion gears or to the acceleration gears of the poly-inductive machine. In this figure the main difference between retro- and post-rotative engines shown is that, in both cases driven by gears, in the former ones the blade 7 rotates in an opposite direction from its crankshaft 1, 32, while in the latter the blade moves in the same direction 33.

FIG. VIII C shows that the retro-rotative effect may not be directly achieved in a post-rotative engine, by using a retroactive assembly comprising a three-sided blade. It is seen that, following the side rule, presented in the present inventor's application dealing with a generalization of poly-inductive engines, a square-shaped cylinder a) is obtained, and that the blade would dig into the cylinder otherwise.

FIG. IX C illustrates a different way of analyzing the movement of the blade with regard to that of the crankshaft, wherein the blade movement is not considered from the point of view of an external observer but from that of an observer positioned on the crankshaft itself, and comments on consequences of such point of view. Interestingly, from the point of view of an observer positioned on the crankshaft instead of from that of an external observer, one can see, after a quarter rotation of the crankshaft, that the reference point located on the side of the engine has moved to the left by 90 degrees 35, and, even more important for the present matter, that the blade has moved to the left thereof, i. e. backwards, by 45 degrees 36. This means that the blade is active in relation to the body of the machine. but also retroactive having regard to the crankshaft.

Another way of figuring this is to realize that if the blade did not move backwards, it would remain at a constant angle of 90 degrees with respect to the crankshaft 37, which is not, since its position is 38.

FIG. XI C illustrates a first embodiment of a retro-rotataly mounted post-rotative engine. The principal is as follows. It is a known fact that the blade is retroactive, not in relation to the engine, but in relation to the crankshaft. Then, it will be assumed first of all that the crankshaft is rotataly mounted in the engine without any eccentric member, this crankshaft also being used as a central axis of the engine. Moreover, this crankshaft is designed so as to be provided with a rotataly mounted pivot gear 40. A secondary crankshaft 41 fitted with an eccentric member as well as, on a side thereof, with a corner gear 42, is placed about the axis so that its gear is coupled to the pivot gear 40. On the central axis, a second gar 43 is then rotataly mounted in such a way as to be also connected to the pivot gear 44. This induction gear is rigidly connected to a straight gear 45, which is in turn coupled to the internal gear of the blade. Thereby, in a simpler way, a first inversion semi-transmission is then built inside the blade, which allows invert the blade in relation to the crankshaft. A blade 7, provided in a side thereof with an internal crankshaft, is rotataly mounted on the eccentric member of the crankshaft in such a way that the internal gear of the blade be engaged to the induction gear of the inverter.

So far, there is thus provided a system, which allows inverting the movement of the blade with respect to that of the crankshaft. But now it is known that in a post-rotative engine, even when it is known to act in an opposite direction in relation to the crankshaft from the point of view of the crankshaft, the blade may be considered as acting in the same direction if seen from an external point.

Therefore, certain elements of he engine have to be connected in such a way as to keep one of them, for example the crankshaft, in a given direction, while inverting again the other so as to reestablish the same direction.

In fact, this means that a semi-transmission must be added, which, together with a pivot, will inverse again one of the two elements, i.e. either the blade or the crankshaft.

That is the reason why a second gear 47 is added to the crankshaft, this second gear being coupled to the inversion gear of the semi-transmission 48. This latter gear is rotataly positioned in the semi-transmission body 49. A third gear of the semi-transmission 50 is rigidly mounted on the central axis in such a way as to be coupled to the inversion gear.

By operating the assembly, the blade, with respect to the eccentric member of the crankshaft, will be submitted to the differential of the movements induced by the pivot of the crankshaft on the eccentric member as well as on the internal gear provided on the blade.

A first consideration of such a double-inversion system will doubtless be that, by inverting twice the system, since—(−5) is equivalent to 5, is that it only consists of a more complicated manner of achieving an obvious result. A further analysis will show that that is not the case.

FIG. XII C shows that, in such an engine, a complete control of the thrust forces of the blade and of the deconstruction of the system is achieved.

During the “way-down rotation” of the blade, the backward thrust, in retroaction 51, drives the free gear mounted on the axis 52, which in turn drives the internal picot gear of the crankshaft 53, which consequently activates the gear of the crankshaft 54. On an opposite side, the blade acts on the crankshaft 55, making it rotate in the same direction as previously. Then the rotation is transferred to the external semi-transmission gear of the crankshaft, and then further transferred to and inverted by the pivot gear of the semi-transmission 56, which in turn drives the transmission gear of the axis, thereby delivering, as a single energy, the accumulated thrust outbound, but, in this case, in a direction opposite that of the crankshaft.

Therefore, this engine is effectively retro-rotative, with a blade thereof acting so as to be receptive all the thrusts and the counter-thrusts, and an output axis thereof being in a reverse direction from this blade. Such an assembly definitely allows more power than conventionally used ones, and this mainly because it provides a cancellation of the power losses as already discussed, besides generating positive lever effects that multiply he power.

The above is an evidence of the difference between double inversion of numbers and double inversion in the field of mechanics.

FIG. XII C is a perspective view of the engine of FIG. XI.

FIG. XIV C is an alternative embodiment of the present invention, using two different types of inversion in a combination, namely a semi-transmission on the one hand and a coupling between an internal gear and an external gear on the other hand. It will be appreciated that when falsificating the gear ratios, the rather heavy differential mechanism that has just been described is nor required anymore, to simultaneously reduce and invert.

By using a semi-transmission that simultaneously inverts and multiplies by two the rotation speed of the induction gear, an by reducing by half the size, the equilibrium is maintained, but now in a double-inversion mechanism comprising a double dynamical support, which is what is needed.

Therefore, in the present case, a crankshaft 1 fitted with a connecting rod is inserted in a part. As previously, this is a free crankshaft, in that it will not draw the energy outbound. One end of this crankshaft stops in the semi-transmission where it is rigidly connected to a semi-transmission gear 60. A blade 7, provided with an internal gear on a side thereof, is positioned into the cylinder of the machine 61 in such a way as to be rotataly mounted on the eccentric member of the crankshaft and so that at the same time its gear be coupled to the induction gear of the central axis 48. An inversion pivot gear 49 is rotataly mounted in the side of the semi-transmission so as to be coupled to the gears of the crankshaft and of the central axis of the engine. A central axis of the engine going across the crankshaft and fitted at each end thereof with a transmission gear 5 and a blade induction gear 5 respectively, is rotataly inserted into the engine, in such a way that its transmission gear be coupled to the transmission pivot gear and that its induction gear be coupled to the blade internal gear.

For each gear, the size ratio thereof with respect to the other gears is indicated. Different gauging may be possible. Here, the gauging was made to allow the induction gear, instead of being still, to rotate twice as fast. However, the induction gear is twice as small in size than if it had been still. A post-rotative shape is then allowed, although provided with a retro-rotative power, which is what was sought.

As previously, although in a simplified way, the present machine, during its expansion, makes an efficient use of all the thrust forces. Post active forces are diverted onto the eccentric member of the crankshaft 70, which in turn leads them to the pivot gear of the semi-transmission 71. This pivot inverts these forces 72 and transfer them, once inverted, to the central axis of the machine 73, which, since it is. rigidly connected thereto, passes them on to the induction gear 74. Meanwhile, the induction gear supports the retroactive downward force of the blade 75, and these two sets of forces instead of canceling, add together in a retroactive way, which is what was intended.

FIG. XV C illustrates a use of an internal gear in the semi-transmission. Instead of using a gear which simultaneously inverts and reduces as previously, these functions are now separated by using a pivot gear dedicated to balancing, inversion being produced by an internal gear. Therefore, the end of the crankshaft is assumed to be coupled to a transmission gear of the internal type 48. This gear is coupled to the pivot gear 49, which, receiving the inverted movement from the internal gear, passes it on to the gear of the central axis 50. Such an assembly is then associated with a structure as shown in FIG. XV to achieve a similar result.

FIG. XVIII C illustrates a combination allowing canceling the semi-transmission, by using two internal gears engaged on a same pivot axis mounted on the fitting of the crankshaft. The previous structures have proved that inversion by means of internal gears requires fewer pieces. The present figure shows that even the semi-transmission. Could be removed. Here, an axis 80 fitted at each end thereof with an induction gear 81, 82, is rotataly mounted on the eccentric member of the crankshaft of the machine, at a height for example. The gear ratios will be carefully selected to yield a smoother incidence of the induction gear on the connecting rod by a desired angle, depending on the engine to be built, i.e. a square engine or an octagonal engine etc.

One of the gears is coupled to an internal gear placed in the side of the bloc 83, while the second one is so positioned as to be coupled to the internal gear of the connecting rod 84.

The operation of the machine will be such that during the rotation/way down, the post active force 85 will drive the crankshaft forward 86. As for the retroactive forces, they will act into tipping backwards the induction gear 87, which, transferring this force to the induction gear on the side 88, will lock onto the stationary internal gear 89 and will act as a lever on the crankshaft. This crankshaft will thus be submitted again not only to the addition of the forces but also to added lever forces 91.

FIG. XXI C illustrates an off-center embodiment of the present invention, which allows supercharging the system. In this embodiment, the internal gears are differently coupled to the axis of the connecting rod journal.

There is still here an axis going across the eccentric member of the crankshaft and, at each end or on a given side, induction gears. In contrast with the previous figure, the internal gears are superimposed 100, thereby allowing an enhanced off-centering 101.

FIG. XXII C a set up of the blade in the previous embodiment 102.

FIG. XXIII C shows a simplified way to perform the present invention by using one single internal gear loosely positioned in the machine. As is well known in the field of engines, a most important step following the finding of a new way to tackle and to solve a problem is to obtain the most simplified solution thereto.

Here the two inversion semi-transmissions used hereinbefore, one of which was located inside the piston and the other in the semi-transmission, are embodied by a specific layout of three gears.

A supporting neck 110 is rigidly positioned in the side of the machine. Then, a first part of the crankshaft 111 is mounted on this neck. A supporting gear of the external type 112 s also mounted on this neck. This gear is then coupled to a second gear of the internal type 113, which rotates thereabout as a hoop. Since this latter gear is not rigidly related to any element of the machine, an anti-sliding means 114 may be provided thereabout and on each side thereof so that it adequately rotates about itself. Then a blade 116 is rotately mounted on the connecting rod journal 115 of the crankshaft, this blade being fitted with an induction gear rigidly mounted thereto 117 in such a way that this gear is coupled to the opposite part of the internal gear 119. Finally, the crankshaft may be further maintained by connecting the complementary part 120 thereof. Obviously, a different assembly procedure may be selected, for example by first separating and then assembling the blade and its induction gear so as thus maintaining the crankshaft as a single piece. The present only aims at showing an alternative, which may then be varied. It will lastly be noted that a neck may be located between the connecting rod and its gear, which allows connecting the arm of a tracking crankshaft 30. Such a method provides an output to the outside for the fire for example. A number of other methods are possible, which is why this will not be discussed further herein.

FIG. XIV C shows the energy distribution during expansion of such a system. Given a three-sided blade, the external gears will have to be of a same size, which is twice as smaller as that of the internal gear.

On the one hand, the post active thrust 121 on the blade then will first be transferred on the eccentric member of the crankshaft 122. On the other hand, the retroactive thrust on the blade 123 locking onto the internal gear 124, this gear itself locked onto the supporting gear 125, will act as a lever effect 126 into the connecting rod journal of the crankshaft, thereby driving it in the same direction as that of the post active thrust. Once again, instead of canceling one another, the forces not only add but also multiply.

This retroactive embodiment is about 400 times more powerful that mono-inductive version.

FIG. XV C is a perspective view of the last embodiment.

Part D

FIG. I D illustrates two different embodiments of poly-induction engines, wherein the first one is retroactive with a triangle cylinder, and the other one is post-rotative with a square blade. Since the assembly of these engines has been previously described in detail, only a brief overview of the differences between them will now be given.

In the triangle engine 1, two induction gears 2 are coupled to a supporting gear of the internal type 3 and thereby drive the blade 5 through respective connecting rod journals thereof, as well as the crankshaft 6 although in an opposite direction.

In the second machine, the induction gears 2 are instead coupled to a supporting gear of the external type. Through respective connecting rod journals thereof, they drive the blade 7 and, at the same time the crankshaft and its connecting rod journal, this time in the same direction as that of the blade 8.

FIG. II D shows a series of retro-rotative machines, which all satisfy the side rule. Indeed, as may be seen, a blade with two sides 9 is associated with a three-sided cylinder. A three-sided blade 10 is associated with a four-sided cylinder. A four-sided 11 is associated with a five-sided cylinder, and so on.

FIG. III D is a series of figures corroborating the side rule when applied to post-rotative machines.

In this series, the first illustrates a post-rotative machine which blade has a number of sides superior by one to that of the cylinder. A two-sided blade is therefore associated with a one-sided cylinder 12. In the following, a three-sided blades is associated with a two-sided cylinder 14. Then, a four-sided blade 15 is associated with a three-sided cylinder, and so on.

FIG. IV D compares these two types of engines assuming that each is provided with a two-sided blade. It may be seen that, in the case of the retro-rotative engine, the cylinder has three sides 15 while, for the same blade, the cylinder of the post-rotative engine has one side, which obviously ahs to be understood in the context, since here in such a limit case, the cylinder is fully folded upon itself 16.

FIG. V D is a comparison of these two types of engines assuming that they both comprise a same triangle cylinder. In the case of the retro-rotative engine, it may be seen that the blade has two sides 17, whereas in the post-rotative engine, it has four sides 18.

FIG. VI D shows, in the simplest poly-inductive embodiment, the gear ratios to be observed between the induction gears and the supporting gear in order to achieve the desired number of sides of the cylinder.

In retro-rotative engines, the size of the supporting gear 19 (here 3) divided by the size of the induction gear 20 (here 1) equals the number of sides of the cylinder, which is here 3 (21).

In the case of post-rotative engines, The size of the supporting gear 22 (here 2) divided by that of the induction gear 23 (here 1) equals the number of sides of the blade 24 (here 2).

FIG. V D shows borderline cases of the side rule. In the case of retro-rotative engines for example, when the blade ideally reduces to a point, the cylinder reduces to a line 25, which is what occurs in engines with rectilinear connecting rods.

In a second example of a borderline case, there is s a quasi similarity between retro- and post-rotative machines. Indeed, a retro-inductive machine provided with a one-sided blade yields a cylinder having a double arc shape 26, very similar to that of a post-rotative machine comprising a two-sided blade associated with a cylinder having an arc side 27.

Part E

FIG. I E gives two schematic views of poly-turbines, comprising the two main mechanical supporting means already described in the present application. Briefly stated, a blade structure 1, comprising four lades 2 interconnected by their extremities 3, is inserted into a cylinder 4 of the machine 5.

In the first case, a supporting structure comprising two induction gears 6 provided with connecting rod journals or cams 9 are each rotataly mounted on a fitting of a crankshaft 7 and coupled to a supporting gear of the external type 8. Connecting rods 10 connects the cams to a complementary connecting point of the blades 11.

In part B of the Figure, the induction gears 6 are this tine connected to a supporting gear of the internal type 13. Moreover, the connecting rods here connect the cams 9 to a center of the blades.

FIG. II E shows the main drawbacks of these two supporting means. In relation to the first structure, it may be seen that the gear structure varies in time in shape between a rhomboid and a rectangle 14. This structure is unsatisfactory since it generates two rotations of the blade structure, which differ based on whether the square is supported on the right or on the left (15 B).

In the structure supported by means of an internal gear, the main drawback stems form the fact that the shape described by the cam of the gears is that of a square 16, when the needed shape is of the rhomboid type or that of a flattened oval (17 A).

FIG. III E illustrates a first way of setting up a structure avoiding the previous drawbacks by a different layout of the angles of the supporting structures in relation to the angles of the blade structure, and moreover, by an indirect interconnection thereof by means of blades mounted for that purpose. As may be seen, such an embodiment allows the use of only two supporting points.

In this case, two intermediary supporting connecting rods of the blade structure are provided with driving sliding joints 19 are rotataly mounted on the axis of the machine 18 in such a way that their sliding joints are engaged on the induction gears 6. Each end of these connecting rods is in turn connected to a centered position of the blades 21. The machine will then operates as follows. Since the sliding joints cancel. the vertical aspect of the movement of the cams, a. right angle is formed between the cams when the cams are complementarily positioned by two, respectively at their most closed position and at their more opened position 22. Hence, the blade structure will be in a square configuration 23.

A quarter rotation alter, the induction cams will found themselves, successively, each at a closest 24 and at the more remote 25 position from the preceding cam and the following cam respectively. Hence, the blade structure will be in the desired rhomboid configuration 26.

FIG. IV E shows the geometrical difficulty to be solved for providing a support when connecting the blade structure by the angles of the triangle thereof, i. e. the difficulty involved in producing a rectangle inside an already built square. It is to be admitted that an efficient structure for supporting the pieces by using a gear of the internal type must describe the shape of a rectangle 100.

FIG. V E shows how, by changing the observation point, a rhomboid seen in a steady way may be seen as a dynamical expression of a square. Provided it is possible to look at the movement of the pieces from a reference point located in the center of the system, and rotating about itself at a rate twice lower than that of the system, it is seen that the formation of a rhomboid corresponds to the delayed dynamical formation of a square.

From the first point of view i, the point a I is a given point of the chamber of the cylinder and the point b 1 is a give point on one of the blades of the blade structure. The following illustrations show the movement of the blade structure and of the predetermined point from the point of view of a moving observer, which yields, from the point of view of the observer, to the formation of the desired square 102.

FIG. VI E shows how to transfer this formal realization into a technical solution by making the supporting gear dynamical. An inversion semi-transmission 300. As for example the ones used previously in the retro and post rotative engines, will be sufficient to drive the supporting gear into a direction opposite that of the induction gear, in a ratio of one height of rotation for the supporting gear versus one half rotation of the induction gear, in the present example. The supporting gear 8, which now ends by a semi-transmission gear 60, may be rotataly mounted in the machine 61, in such a way as to be coupled to a pivot reducer gear 62.his gear 62 in turn is coupled to a semi-transmission gear positioned on the crankshaft 63, which supports, on an opposite end hereof, the induction gears 6 having cams 9 supporting the blades 2. It will be appreciated that four cams 9 are used so that the structure blade is devoid of any autonomy.

FIG. VII E shows schematically that the forces obtained by the two present solutions are retroactive. The forces 65 on the blade act on the crankshaft of the induction gears 66. On an opposite side, forces submitted to the induction gears themselves will them into an action 67, which, inverted by the semi-transmission, will be positively transformed on the crankshaft where it will be added 68.

FIG. VIII E shows that, as previously mentioned, as few as two connecting points 200 may be sufficient to support the pieces, which would allow to reduce the number of pieces necessary in the assembly of the machine.

The advantage and weak point of such a method would be that the forces generated in the case of a support of the pieces provided by the corners of the blade would be weaker every second time, but much larger every second time b. Indeed, every second time, during the explosion, the cam would not rise completely, but then the following time, since the way down would then be already started, a very high torque would be created. By dedicating the weaker rise to a pumping aspect required in two-step engines, provided a reliable poly-turbine could be built based on these supporting points, a very high torque would be achieved, with an angle of attack of 45 degrees during the maximal compression, which obviously makes such a poly-turbine advantageous compared with any engine. As previously mentioned, supporting the blades by their extremities might be satisfactorily achieved by as few as two connecting points, which would allow to reduce the number of pieces necessary in the assembly of the machine.

FIG. IX E shows a first method for building such poly-turbine. Two driving rods of the blade structure are each connected to the connecting rod journal of a crankshaft, while simultaneously being submitted to a directional supporting means which rotates in the opposite direction. In such structure, two connecting rods 10 connect the connecting rod journals 7 of a crankshaft and the opposite connecting points of the blade structure 70. A rotative piece inducing the orientation of the connecting rods 201 is rotataly positioned in the body of the machine, in such a way that a movement thereof 72 is opposite that of the crankshaft 73. Such inversion may, as previously, be performed once per rotation by a semi-transmission connecting, through a pivot gear, the gears of the crankshaft and the rotative pieces inducing the orientation of the connecting rods.

Hence, these pieces being activated, the blade structure will be totally submitted to a movement of the connecting rods and will have the desired motion.

FIG. X E is a perspective view of the previous one.

FIG. XI E shows a first way to simplify this structure, by discarding the pieces more liable to be submitted to friction and instead using only gears means, which are in the present case strictly of the external type. It will be here assumed that the connecting rods, connected to the blade structure, are rigidly mounted on one of the induction gears 6.

Then these induction gears are mounted on a supporting gear of the external type 8, which is itself dynamical. By means of a semi-transmission 400, this dynamical gear will be set to rotate in a direction opposite that of the supporting gear in a ratio, given the same size, of about three over one. Such inversions may once again be achieved by different layouts of inversion semi-transmissions.

FIG. b shows the movement of the pieces during one rotation of the machine a), b), c).

FIG. XII E shows a geometrical way to obtain a rhomboid or a flattened oval shape, using internal gears. When considering a point outside of the circumference of the external gear 410, it will be noted that, after two complete rotations of the external gear inside the internal gear, the shape described by this point positioned point outside of the circumference of the external gear is a rhomboid, which is what is desired with the purpose of involving the external surfaces of the polyturbine.

FIG. XIII E shows how to further simplify this structure, based on these geometrical teachings, by building an equivalent of FIG. XII E using now supporting gears of the internal type. In the previous figure, the supporting gear was active and beside in a direction opposite that of the crankshaft that supports the induction gears. Here, the friction observed in the previous figure is cancelled. However, the number of pieces remains quite high, since a semi-transmission is used.

In the present figure, it is shown how to achieve a similar motion of the pieces, by using instead induction gears, also rigidly provided by connecting rods, but this time connected to supporting gears of the internal type.

FIG. b shows schematicaly the motion of the pieces during a quarter rotation. This time, diving rods are rigidly mounted on induction gears coupled to a gear of the internal type.

FIG. XIV E is a perspective view of this last embodiment.

FIG. XV E shows the very high forces generated by such an assembly. First, it may be seen that at the time of explosion, when the compression is the strongest, the attack angle of the crankshaft is of 45 degrees 90 instead of being of zero as in conventional engines. Then, it may e noted that a same explosion connects the chambers 91, or else two simultaneous explosions flatten 92 the square of the blade structure, which will not result in a thrust on the connecting rods but in a much greater pulling force, which will draw then outwards 92. Lastly, it will be noted that these forces are not direct forces, but rather generated under a lever effect, which drives the crankshaft into a supported position onto the internal supporting gear 93.

It is here believed that a greater torque is difficult to achieve with such a machine. Indeed, while certain engines, such as rotative engines, only deliver one fifth of the power generated by explosion, the present turbine delivers this power in its entirety, multiplied by the torque and even more increased by the lever effect as well as by the pulling effect. This turbine therefore might be several times more powerful than conventional engines as far as a ration gas used versus created power is concerned.

FIG. XVI E illustrates the use of such a machine as a two-step engine, standard or anti-discharge.

The gas inlet is in charge of the part of the blade submitted to a counter-torque during its more compressed phase 100, to inject the clean gases into the following chamber 110 before backblasting the burnt gas 111. A quarter rotation later, new clean gas will be compressed and processed, by he blades having an improved torque, while the complementary blades will be receiving in turn clean gas. In the case of anti-discharge machines, two blades or partitioned blades may be used.

FIG. XVII E illustrates three different embodiments realizing a support of the blade structure by the center or by the sides. In a) it is shown to use a master crankshaft 700 both for receiving the direction connecting rods 701 and for supporting the induction connecting rod journals 250, in such a way that it is activated by the induction gears 703 and the supporting gears 704 and controls the opening connecting rods 705 of the blade structure.

In b) it is shown how to achieve such a structure using internal gears located in the blades. The idea of such an embodiment is to trigger the alternating motion 11 of the connecting rod journals of the induction gears of the blade structure, during the circumferential movement of a wall of the crankshaft 110 provided with two supporting gears 250, this alternating motion making successively the connecting rod journals get in and get out from the gears, thereby performing the desired rectangular shape 113.

The induction gears and cams are rotataly mounted on subsidiary crankshafts 115, which are coupled to master induction gears 116 coupled to a main supporting gear 117.

FIG. XIII E shows how to complete both gears systems (with internal type supporting gear) located on each side of the turbine, by a continuous crankshaft 500, the centre connecting rod journal 501 thereof providing a support for complementary positions of complementary connecting rods of the blade structure.

Here, the crankshaft connecting both semi-transmittive structures is provided with additional connecting rods journals 500 connected with connecting rods 10, which are related by an end thereof to the complementary connecting points of the blade structure. Such a layout allows to multiply the strength f the explosion, b) the induction gear still working as rotation pivot, although the induction is now rather located in the front and alternatively in the back thereof.

FIG. XIX E shows how to complete both gear systems (with external type supporting gear) 8 located on each side of the turbine, by a continuous crankshaft 500, the centre connecting rod journal 501 thereof providing a support for complementary positions of the blade structure. Such an embodiment yield a much increased explosion, the induction gear still working as rotation pivot, although the induction is now more effective in the front and alternatively in the back thereof.

Part F

FIG. I F illustrates a first literal embodiment of a mechanical dynamical lock. The same embodiment will be described in relation two transverse versions thereof, for a better understanding. In this figure, gear referred to as a supporting gear 2 is assumed to be rigidly fastened to the solid part 1. This gear is provided with a passageway 3 in its centre for accommodating the central axis of a crankshaft 4. A central axis of a crankshaft 5 is rotataly inserted in this centre of the machine, across the supporting gear. This fitting of the crankshaft is itself provided with a passageway 6 for accommodating in turn the central axis of a gear 7, referred to as an induction gear 8.

A length of the arm of the crankshaft is determined and adjusted so that the induction gear is coupled o the main gear. The central axis of the induction gear is also provided with an arm and a connecting rod journal 10.

The structure may also be assembled with a cam, as generally described in the present inventor's application dealing with the matter, but it is believed that the use of a connecting rod as described here makes the demonstration clear and more obvious.

From a dynamical viewpoint, it is observed that when the crankshaft rotates in a clockwise direction, the induction gear is submitted to the effect of this rotation and is set to rotate itself in the same direction as the crankshaft.

Inversely, when the connecting rod journal of the induction gear is acted upon rotataly, the rotation of the gears is triggered and consequently that of the main crankshaft.

It should be repeated here that the rotation of the crankshaft happens only when action rotataly upon the induction gear. Such being the case, it is to be noticed that the thrust of the gases on the pieces is not rotative but rectilinear.

Therefore, if the pieces are acted upon by way of a thrust, as compared to the action of the gases, it will be appreciated that things will occur differently. In given phases of deployment of the system, a resulting locking effect may even be generated by the thrust on the induction connecting rod journal.

Elements B of the figure intentionally shown in a different position to better illustrates such locking effects.

In such position, a thrust produced backwards 14 on the induction connecting rod journal 10 of the induction gear will drive or tend to drive the induction gear into a clockwise direction 11. Since the centre of this gear is related to the arm of the crankshaft, this rotation will trigger the rotation of the crankshaft, this time towards the front 12. Such a thrust toward the front of the crankshaft will in turn also drive the connecting rod journal of the crankshaft and the axis of the centre of the induction gear towards the front. Such a move forward is exactly opposite that of the initial thrust. The greater the initial thrust, the greater the counter-thrust, i.e. the resulting thrust occurring in a reverse direction. It may be even said that the counter-thrust, due to the lever effect created by the induction gear, will be superior to the initial thrust.

FIG. II F shows how to obtain a similar kind of locking effect by using this time a supporting gear of the internal type. However, as a particularity, it will be noticed that the connecting rod journal now stands in the upper part of its rotation when in a locking position 10.

In the previous figure, it was observed that, s in I, when a thrust 14 is produced on the induction connecting rod journal, in a given position of the system, the pivoting action of the induction gear results in a thrust on the main crankshaft, which turns into a counter-thrust 16, which is either of the same order or greater that the initial thrust. The system may therefore be operated this way. Such a way yields a power of the engine greater than in 1.

FIG. III F is a schematic view of the initial set up of the gear means of the engine. In order to be able to connect the blade, cams 17 are here substituted for the connecting rod journals of the induction gears. In future embodiments, these cams will be connected two by two to the blades. The gears will be positioned so that two among them have their cams located in their more remote position 18 while the two cams of the opposite complementary gears will be set in their closest position 19.

When in their locking position, the cams will be said to be locking, as opposed to the complementary cams, which will be referred to as dynamical.

The deployment of the system will cause, after a quarter rotation, the cams to be in a position described in B, which reminds the shape of a rectangle. The two following quarter rotations will successively repeat these positions of the cams.

FIG. IV F shows a similar more achieved semi-transmittive configuration, wherein blades 21 have been added.

These blades, which are provided with induction sliding joints 23, are semi-rotataly mounted about the central axis of the crankshaft 4, in such a way that the induction sliding joints 23 are engaged in the induction cams 17. The cams will act on the blades so that they will alternatingly come close together 30 and drift out one from the other 33, 35. Such a mounting of the cams may be preferably performed by means of pads that are innerly round and externally flat, thereby allowing a good match with the sliding joint as well as will the connecting rod journal.

The figure shows the effect of the thrust of the blades. It may be observed that the thrust, through the blade, results in a locking effect on the gear similar to that of FIGS. I and II, 14. The thrust on the complementary blade 31 will instead have a dynamical effect thereon, through the cam gear in a dynamical position, which will result in a dynamical urge of the engine as a whole.

The differential action of this dynamical thrust and the locking effect will provide the energy require to activate the engine. That is the reason why this engine is called an energetic engine with a differential action. Obviously, each cam and blade will play alternatingly the role of locking cam, locking blade and dynamical cam or blade.

The blade will extend to a maximum, thereby closing the spaces located in their complementary sides.

FIG. V F. is a perspective view of the machine, which was previously explained wherein the two blades act one against the other, the first one working as a dynamical lock allowing the thrust on the second one to have a dynamical incidence.

The selected structure is here similar to that of FIG. I. The supporting gear 2 is mounted by a rigid neck in a side of the machine 1. The central axis 4 of the crankshaft 5 is rotataly inserted into the central passageway of the gear. This crankshaft is provided with four crankshaft fittings. Each fitting (dotted line) is in turn provided with a connecting rod journal on which an induction gear provided with an induction cam is rotataly mounted. The resulting structure is mounted in such a way that the induction gears 8 are coupled to the supporting gear 8 in the way previously described, the opposite gears being either completely out or completely in.

Two blades 21 each provided with a an induction sliding joint 23 are then assembled together on such a way that they are at the same time engaged on the induction cams 17 by their induction sliding joints and semi-rotataly engaged by their centre with the central axis of he crankshaft.

The present system is displayed in an expansion phase. It will be noticed that the opposition of the blades 28 causes the differential induction of the system.

FIG. VI F shows the main drawbacks of the previous embodiments. It is shown that the time when the locking effect becomes effective is rather late after the ideal time of explosion, which is the time of minimum distance between the pieces as shown by a dot line. It must be waited until the system has its cam pass the perpendicular level 39 where the two contrary forces start to oppose before causing the explosion. Such a delay causes an early opening of the dynamical 41 and consequently a loss of compression since the blades have already started to get apart 40. If the explosion is anticipated, a harmless backward effect is produced, and the differential force is then considerably reduced.

FIG. VII F shows a first method for correcting this, by using more blades in order to reduce the angles 43 between the cams and allows that the dynamical cam has not yet started getting out when the locking cam enters its locking phase. In the present figure, there are a total of six induction gears 8 and cams 17 and there are three blades 21. It is to be noted that not only more blades may be used, but that a plurality of alternating movements may also be determined for each one of them, which may allow a continuous ignition.

FIG. VIII F illustrates the starting position of the six gears, the gears y1, y2 and z1, z2 being the closest, in pairs, one from the other 51, while the gears x1, x2 are at their outmost position in the system in relation to the centre 52.

In such a configuration, the centres of all gears are positioned at an equal distance in such a way that for each of them, a cam thereof founds itself in a closed state at the same position in the system, which will be referred to as the point A). For each gear, the system will therefore be made to rotate in such a way that the central axis of the gear be in front of this point A). Then, the gear will be inserted so as to remain always in the same state, either closed or more opened. Then the system will be rotated to the next gear, and it will be coupled to the supporting gear, so that the cam is in the very position selected before. The six gears will be acted on in this same way. This done, the position of the gears should be that of the following illustration.

Each gear and cam will found itself in he position of the next on in row at every one ⅙ of rotation. Two gears will always found themselves facing each other while the complementary gears will be either in an output phase or in an input phase. Between these positions, two gears will be inversely in their most outbound position while the complementary gears will be going out and going in by twos.

In the second illustration, the gears are shown at a time between two explosions, the system having rotated by 1/12 rotation since the first illustration.

Once again, it should be noted that in this embodiment, the specific position of the cams allows an improved angle of attack on the dynamical blade since the stopping blade will have arrived earlier into its blocking position. Therefore, no compression loss due to a delay or a distance between the blades may decrease the energy of such a system.

This differentiation of the speeds allows the alternating getting apart and coming close of the pieces. Moreover, this differentiation in the torque ratios of the two complementary cams generates is here responsible for the differential force of the engine.

FIG. IX F shows how to draw inspiration from the latter data to apply these teachings to a system comprising two blades and four gears. By a method involving an initial layout of the gears, an effect similar to the previous one will be achieved using as few as four gears. Such a way of doing may prove very convenient especially in cases when room is too scarce for accommodating a high number of blades, and if it is desired to reduce the number of explosions.

Instead of aiming at placing opposite cams in their closest or more remote position, the method aims at placing the consecutive cams, successively in a closest position and in a more remote position, as selected.

Therefore, in a first step, a cam number b is placed in its closest position 51 relative a cam number a, the cams being thus positioned parallel 49 in relation to two complementary induction rods.

Then the system will be moved by ⅛ 53 towards the right until the cam c gets aligned in a horizontal position. Then the gear d will be introduced by placing, as previously, the cam into its closest position 51 from the preceding cam.

In so far as the speed of the engine is high enough, it may be assumed, as in real turbines, that such a technique will allow a continuous ignition. By using two assemblies, the system nay be supercharged into behaving like a turbine, but in this case in a closed way, thereby more economically.

FIG. X F shows eight main phases of this system. It will be noticed that for each coming close 45, the blocking and the dynamical thrust are maximum, and that the coming close of the cams always occurs ⅛ cycle 46 before the next one, in direction opposite that of the movement of the pieces. Igniter plugs may be positioned at each places of closest approach of the blades.

FIG. XI F that the overall rotation of the system may be cancelled in such a way that the closest positions of the blades always occur at the same locations.

Indeed, the passageway of the crankshaft may be Y-cutted 60 so that the crankshaft may act on the supporting gear by means of a reduction gear 62 rotataly located in the body. Obviously, this is made possible by rotataly mounting 65 the supporting gear inside the side of the machine 1.

Due to its speed 63, this gear will make up for the recoil of the system and will allow that the cams always close at the same place.

FIG. XII F shows how the induction cams may be forced to separate and get apart from one another, by using specific cross-shaped or cloverleaf-shaped cams 72.

FIG. XIII F shows how to improve the stop angle 75 and the dynamical angle 74 by tilting the sliding joint of the blades by a few degrees 73. Moreover, this Figure shows that the use of a specific pad 76 having a flat external shape 77, may be used to cushion the detonation force on the blade.

FIG. XIV F shows a how the sliding joints may be differently provided on each blade. This time, instead of being rotataly mounted at the centre and slidingly mounted to the cam, they are slidindly mounted at the centre 81, and rotataly mounted to the cam 81. The cylinder may not be round-shaped anymore 83, and an eight shape is, for example here, is recovered. The interaction between the blades is still differential. The resulting shape reminds that of an eight. The shape of the cylinder may be made rectangular. So to speak, by adding on each blade extremity a pad, which will accentuate the turning movement in the corners. Here, shapes that are more fluid are preferred.

In part B of the present figure, the blades rather stand towards the centre, engaged slidingly one to the other, which slightly modifies the shape of an eight that will be obtained.

It will be noticed that by fastening the right hand loose piece to the end of the blade, the cylinder will have a shaped of an eight more pronounced, which tends to that of a rectangle.

In FIG. XV F, the connecting points of the blade are modified and now involve one of the two cams. Here, each blade will be rotataly connected to one of the two cams 72 AND in a sliding way to the complementary cam 93. The force generated in such a configuration will also be differential in nature, but the shape of the cylinder will be doomed differently. Once again, the differential action will be maintained, but the dynamical point of the blade will be increased by a lever effect.

FIG. XVI F shows more precisely a thrust obtained due to complementary stops 29 and dynamical actions 30, this time by using internal gears as supporting gears. Once again, the force generated by the system is increased since forces necessary for blocking are reduced while dynamical forces are increased. Indeed, the blocking forces are decreased whereas dynamical ones are increased by a lever effect.

FIG. XVII F illustrates a simplified embodiment of the invention, wherein only one of the blades is active, the other one being rigidly related to a crankshaft 102. In this case, one of the blades is connected to the induction gear by a cam thereof and related to the other blade by a connecting rod 11, at a point either below or above the first connecting point 101, in such a way as to generate a differential force.

FIG. XVIII F shows a way to increase the differential feature of the previous one. As previously, the two blades are directly connected by a cam mechanism. However, here each blade 21 is fitted with an induction gear and a cam 17, but here the cams are of different size 105. Therefore the action of the gear is increased on one of the two blades, which creates an increased differential effect. However it is to be noted that what is generated on the side of one blade is lost on the opposite side that will waste energy instead of gaining some. These chambers will be maintained only for the purpose of admission or suction of the gases. The used gases, assuming an anti-discharge engine, will be suctioned by the joining blade instead of by the opposite blade, which allows to build a clean engine, even with two blades. It may also be contemplated, in more elaborate embodiments, to use pairs of induction gears of different sizes to drive blades into an alternating movement twice as fast as their complementary blades, and therefore able to act as stop blades every second cycle since they require more energy, while otherwise only serving as spilling means. Even in this case, the turbine will operate due to the differential thrust in a very smooth way, while being well supported on its centre.

FIG. XIX F shows how to partition the blades to allow an anti-discharge version of the engine, this time produced by partitions 107 or step-like design 105. Such a step-like design may also be used to allow, in a given engine, an increment in the power. Indeed, each step may be provided with its own carburetion and ignition, and depending on the requirements of the engine, only the smaller ones may be sued, or only the larger ones, or otherwise both at the same time. Anti-discharge engines may also be built by assembling together two assemblies They may also be built by transversally separating and partitioning the blades, each blade being able, at a given time, to be in conjunction with the other.

FIG. XX F shows how the gases circulate in a standard two-step version of the engine having two blades. The admission, compression of new gases, and spilling, filling up and compression to combustion, may be seen.

FIG. XXI F shows how one blade may be used at the same time as a cylinder 200. One of the two blades is contained into the other blade. Such a method allows to reduce the segmentation, and it is possible due to the fact, as already mentioned, that the dynamical support is not provided by a support on the body of the cylinder. Thus, the engine may be built as an engine with a mechanical wheel.

1. A semi-transmission for a poly-inductive machine, comprising:
a central axis, rotataly positioned in the machine;
a supporting membrane, referred to as a bridge, rigidly fastened to the central axis and provided with supporting rods for induction gears and cams;
supporting rods for induction gears and cams, rigidly mounted on the bridge of the semi-transmission;
induction gears fitted with induction cams and rotataly mounted on each supporting rod in such a way as to be coupled with the supporting gear;
driving pieces of the machine; and
a supporting gear, positioned in the side of the engine.

2. A machine as defined in I, wherein the supporting gear of an internal type.

3. A machine as defined in I, wherein the supporting gear of an external type.

4. A semi-transmission for a poly-inductive machine, comprising:
a central axis, rotataly positioned in a side of the machine;
a supporting membrane, referred to as a bridge, rigidly fastened to the central axis and provided with supporting rods for induction gears and cams, said structure being complementarily provided with a second supporting means rotataly positioned about a neck of the supporting gear;
supporting rods for induction gears and cams, rigidly mounted on the bridge of the semi-transmission;
induction gears fitted with induction cams and rotataly mounted on each supporting rod in such a way as to be coupled with the supporting gear;
driving pieces of the machine; and
a supporting gear, indirectly positioned by means of a neck in the side of the engine.

5. A semi-transmission as defined in V, comprising a connecting rod journal, to which, by means of the neck of the driving part, a subsidiary crankshaft is connected.

6. For a simplified poly-inductive machine, a crankshaft, rotataly positioned in the machine, and on a connecting rod journal of which a rotative piece is mounted, whose external gear is coupled to the internal supporting gear of the machine.
Claims for Part B

7. A machine comprising:
a part of the machine in which a cylinder is placed;
a free crankshaft, rotataly placed in this part, a passageway for accommodating a central axis going across said crankshaft , said crankshaft being fitted at a first end thereof with a means such as an eccentric member for supporting the blade, and at a second end thereof with a semi-transmittive gear;
a blade, provided on a side thereof with a gear of an internal type, said blade being rotataly mounted on the eccentric member of the crankshaft, and semi-rotataly in the cylinder of the machine;
a central axis, rotataly positioned in the machine and going across the machine and across the axis of the free crankshaft, said central axis being fitted on a first hand with an induction gear and on a second hand with a semi-transmission gear, in such a way that the induction gear be coupled to the blade gear and that the semi-transmission gear be coupled to the pivot inversion gear of the semi-transmission;
a the pivot inversion gear, rotataly positioned in the side of the semi-transmission, said gear being simultaneously coupled to the semi-transmission gear of the crankshaft and to the semi-transmission gear of the central axis.

8. A machine comprising:
a part of the machine in which a cylinder is placed;
a free crankshaft, rotataly placed in this part, a passageway for accommodating a central axis going across said crankshaft , said crankshaft being fitted at a first end thereof with a means such as an eccentric member for supporting the blade, and at a second end thereof with a semi-transmittive gear;
a blade, provided on a side thereof with a gear of an internal type, said blade being rotataly mounted on the eccentric member of the crankshaft, and semi-rotataly in the cylinder of the machine;
a central axis, rotataly positioned in the machine and going across the machine and across the axis of the free crankshaft, said central axis being fitted on a first hand with an induction gear and on a second hand with a semi-transmission gear, in such a way that the induction gear be coupled to the blade gear and that the semi-transmission gear be coupled to the pivot inversion gear of the semi-transmission;
a the pivot inversion gear, rotataly positioned in the side of the semi-transmission, said gear being simultaneously coupled to the semi-transmission gear of the crankshaft and to the semi-transmission gear of the central axis.

9. A machine as defined in VIII, wherein all the semi-transmission gears are gears at 45 degrees (miter and bevel gears).

10. A machine as defined in i, wherein the semi-transmission gears are of an internal type for the gear of the crankshaft and of an external type for the pivot gear and the axis gear.

11. A machine as defined in VII and VIII, used as an engine, a pump, a compressor.

12. A machine as defined in VII, wherein the gears are calibrated to build a retro-rotative engine.

13. A machine as defined in VII, VIII, IX, comprising a plurality of assemblies of cylinder, blades, crankshafts, gears.

14. A machine, comprising:
a body of the machine provided with a cylinder;
a crankshaft rotataly inserted into the body of the machine;
a blade, provided on its side with a gear of an external type, and rotataly mounted in the connecting rod journal of the crankshaft in such a way as to be semi-rotataly inserted into the cylinder of the machine, and moreover in such a way that its external gear be coupled to the internal gear of the machine;
a gear of an internal type, mounted in the side of the machine, in such a way as to be coupled to the gear of the blade.

15. A machine as define in XIV, wherein the ration of a size of the internal gear by that of the blade equals a number of sides of the cylinder of the machine.

16. A machine as defined in XIII, used as an engine, a pump, a compressor.

17. A machine as defined in XIV, XV, XVI, comprising a plurality of assemblies of a cylinder, blades, crankshafts, gears.
Claims for section c)

18. A machine, comprising:
a part of the machine, in which a cylinder is placed;
a pivot crankshaft, rotataly positioned in the body of the machine, and on which a pivot gear is mounted;
an eccentric crankshaft, provided, at each end thereof, with a gear, and rotataly mounted on the pivot crankshaft in such a way that its inner gear is coupled to the pivot gear of the pivot crankshaft and whose transmission gear is connected in to the transmission pivot gear;
a blade, inserted in the cylinder, provided in a side thereof with a gear of an internal type rotataly mounted on the eccentric member of the crankshaft in such a way that its gear is engaged with the right gear of the pivot gear of the central axis;
a pivot gar of the central axis, comprising twice a corner gear and a right gear, rotataly mounted on the central axis, in such a way as to indirectly couple the gear of the connecting rod and the pivot gear of the crankshaft;
a body of semi-transmission related to the body of the machine;
a pivot gear of semi-transmission, connecting the pivot gear of the centre of the engine and of the crankshaft;
a pivot gear of the axis of the engine, rigidly mounted thereon, and coupled to the pivot axis of the semi-transmission.

19. A machine comprising:
a body of the machine in which a cylinder is placed;
a crankshaft, perforated in a centre thereof, fitted at an end thereof with an eccentric member and at another end thereof with a transmission gear, and rotataly positioned in the machine;
a blade, provided in a side thereof with a gear of an internal type and, rotataly positioned on the eccentric member of the crankshaft, in the cylinder;
a semi-transmission related to the machine;
a pivot gear, rotataly mounted in the body of the semi-transmission in such a way as to be couplet both to the transmission gear of the crankshaft and to the central axis;
a central axis, provided with a transmission gear and an induction blade gear, and rotataly positioned in the machine in such a way as to go across the crankshaft, and in such a way that its transmission gear be coupled to the pivot gear of the semi-transmission and that its induction gear be coupled to the internal gear of the blade, to draw the energy outward.

20. A machine as defined in XVIII and XIX, wherein the semi-transmission gears comprises a pivot gear of an external gear, two other of an external type, and a further inversion gear, i. e of an internal type.

21. A machine as defined in XVIII, XIX, XX, comprising a plurality of assemblies of blades, cylinder etc.

22. A machine as defined in XVIII, XIX, XXI, used as a pump, as en engine of conventional feed, of anti-discharge feed, compressor.

23. A machine, comprising:
a body of the machine, provided with a cylinder, and with an internal gear in a side thereof;
a crankshaft, provided with an eccentric member, said eccentric member allowing positioning a means such as a rod, rotataly mounted in that eccentric member, said crankshaft being itself rotataly mounted in the machine;
a rod, provided with two induction gears and rotataly and transversally mounted on the eccentric member of the crankshaft, in such a way that its two induction gears be coupled to the internal gear of the part and the internal gear of the blade respectively.

24. A machine as described in IV. Wherein the centre of the eccentric member of the blade is mounted so that its internal gear of blade be coupled to the induction gear at its lower level, so as to enhance the off-centring of the blade.

25. A machine, comprising:
a part of the machine, in which a cylinder is placed, and in a side of which a gear of an external type is positioned;
a crankshaft, rotataly mounted in the part, and having one section connected behind the supporting gear;
a blade, provided with a gear of an external type in a side thereof, said blade and its gear being rotataly mounted on the connecting rod journal of the crankshaft;
a gear of an internal type, mounted in the machine as a hoop so as to connect the gear of the side of the part and the induction gear of the blade.

26. A machine as defined in XXIV, comprising between the blade and its gear a neck to which a knob may be related connecting by an arm to a following of the crankshaft.

27. A machine as defined in XXIV, XXV, XXVI, comprising a plurality of assemblies of blades, cylinder, etc.

28. A machine as defined in XXIV, XXV, used as a conventional engine, an anti-discharge machine, a pump, and a compressor.

29. A machine using a direct induction, combined induction twice inverted.

30. A poly-inductive machine, taming the retro-active force into coupling and addition to the post-rotative force.

31. A machine as defined in XXIX and XXX, comprising a plurality of assemblies.

32. A machine as defined in XXIX, XXX, XXXI, used as a conventional engine, an anti-discharge machine, a pump, and a compressor.
Claims for section d

33. A machine of the poly-inductive retro-active type, whose number of sides of the blade is inferior by one to that of its cylinder.

34. A machine of the poly-inductive post-rotative type, whose number of sides of the blade is superior by one to that of a number of sides of the cylinder in which it moves.

35. A machine as described in XXXIII and XXXIV, comprising a plurality of assemblies of blades and cylinders.

36. A machine as described in XXXIII, XXXIV, XXXV, used as a pump, an engine, a compressor, etc.

37. A machine as described in XXXIII, XXXIV, XXXV, used as a continuous ignition quasi-turbine.
Claims for section e)

38. A machine, comprising:
a body of the machine, in which is placed a cylinder;
a crankshaft rotataly positioned in the machine, said crankshaft being fitted with connecting rod journals on which induction gears provided with induction cams are rotataly mounted;
induction gears provided with induction cams, rotataly mounted on the connecting rod journals of the crankshaft in such a way as to be coupled to the supporting gear;
a supporting gear, rigidly positioned on the side of the machine;
induction connecting rods, provided with sliding joints and connecting points to the blade structure rotataly mounted on the central axis of the machine, and moreover mounted in the machine in such a way that the induction sliding joints be coupled to the induction cams and that the connecting points be related to central positions of the blades of the blade structure;
a blade structure comprising blades interconnected by their extremities and placed in the cylinder of the machine.

39. A machine comprising:
a body of the machine in which a cylinder is placed;
a crankshaft rotataly positioned in the machine, and whose connecting rod journals receive the induction gears and cams, and provided with a semi-transmission gear coupled to the pivot gear of the semi-transmission;
induction gears and cams, rotataly mounted on the connecting rod journals of the crankshaft in such a way that the cams be coupled to the blades of the blade structure and that the induction gears be coupled to the induction gear;
a dynamical induction gear, rotataly mounted in the side of the machine, and connected to the crankshaft by means of an inversion semi-transmission, therefore fitted with, at its extremity, a semi-transmission gear coupled to the pivot gear of the semi-transmission;
a pivot gear of the semi-transmission, coupling and inverting the crankshaft and the induction gear.

40. A machine comprising:
a body of the machine in which a cylinder is placed;
a crankshaft rotataly mounted in the body of the machine, said crankshaft being provided with a gear coupled to a pivot gear;
two connecting rods, said connecting rods being each connected at a first extremity to opposite connection positions of the blades, and a second extremity to the connecting rod journal of the crankshaft, said blades being further engaged in the orienting sliding joints of the orientating wall;
an orientating wall rotataly positioned in the machine, and provided with a gear coupled to the pivot gear, said wall being further provided with sliding engaging means to secure and orient the correct movement of the connecting rods;
pivot gears, coupled to the gears of the crankshaft and of the wall.

41. A machine, as claimed in XXXVIII, XXXIX, XC, comprising a plurality of assemblies of blade structures, semi-transmissions etc.

42. A machine, as claimed in XXXVIII, XXXIX, XC, used as an engine, a pump, a compressor, etc.

43. A machine, as claimed in XXXIV, devoid of means for securing the connecting rods.

44. A machine, comprising:.
a body of the machine, provided with a cylinder;
a crankshaft mounted in each side of the machine, said crankshaft being provided with an induction gear and a semi-transmission gear coupled to the pivot gear thereof;
an induction gear mounted on each crankshaft, said induction gears being connected to their respective supporting gear and being fitted with rigidly connected connecting rods;
two supporting gears coupled to the induction gears, said supporting gears being rotataly mounted on an axis provided with a semi-transmission gear;
two pivot semi-transmission gears;
a blade structure related to blade connecting points, at extremities of the connecting rods.

45. A machine, comprising:
a body of the machine, in which a cylinder is placed;
a crankshaft rotataly mounted in the body of the machine, and on the connecting rod journals of which induction gears rigidly provided with connecting rods are mounted;
induction gears provided with connecting rods, said gears each being coupled to a supporting gear of an internal type positioned in the side of the machine;
two supporting gears, each being rigidly positioned in the opposite side of the machine;
a blade structure, located in the cylinder, and related by two connecting points thereof to opposite blades, at extremities of the connecting rods.

46. A machine as defined in XCIII, XCIV, XCV, comprising a plurality of blade structures and semi-transmission.

47. A machine as defined in XCIII, XCIV, XCV, used as an engine, a pump, and a compressor.

48. A machine, comprising:
a body of the machine, in which a cylinder is placed;
a first crankshaft structure, rotataly mounted in the part of the machine, said structure being provided with two supporting gears of a internal type and rigidly mounted on each side thereof, said structure further supporting secondary crankshafts rotataly mounted thereto;
two secondary crankshafts, rotataly mounted to the first crankshaft structure, said two secondary crankshafts being fitted with master induction gears, coupled to the main induction gear of the machine, and provided with connecting rod journals on which secondary induction gears are rotataly mounted;
secondary induction gears, fitted with induction cams and coupled to the internal secondary supporting gears;
a blade structure, mounted in the cylinder of the machine, and having two opposite connecting points of the blade coupled to the induction cams by a means;
a main induction gear, rigidly positioned in the side of the machine and coupled to the main induction gear.

49. A machine, as defined in XCVIII, comprising a plurality of blade structures and semi-transmission.

50. A machine, as described in XCVIII, XCIX, used as an engine, a pump, and a compressor.

51. A machine, as described in XC, XCVI, XCIX, the crankshaft of which going across the machine, and is fitted with supplementary connecting rod journals indirectly related to the complementary connecting points of the blades of the blade structure by a means such as a connecting rod, said machine being able to be used as a pump, an engine, a compressor, and being able to comprise a plurality of combined assemblies.
